(19) United States
(12) Patent Application Publication
(10) Pub. No.: US 2019/0100623 A1
(43) Pub. Date: Apr. 4, 2019

(54) COMPOSITE ARTICLE FROM REACTIVE PRECURSOR MATERIAL

(71) Applicant: SABIC Global Technologies B.V., Bergen op Zoom (NL)

(72) Inventors: Eddie Kebin Geng, Solon, OH (US); Peter James Zuber, Pittsfield, MA (US); Viswanathan Kalyanaraman, Newburgh, IN (US); Erich otto Teutsch, Pittsfield, MA (US)

(21) Appl. No.: 16/086,979

(22) PCT Filed: Mar. 24, 2017
(86) PCT No.: PCT/US2017/024080

§ 371 Date: Sep. 20, 2018

Related U.S. Application Data
(60) Provisional application No. 62/313,424, filed on Mar. 25, 2016.

(51) Int. Cl. C08G 73/10; C08J 5/04

(52) U.S. Cl. CPC C08G 73/1032; C08G 73/1053; C08J 5/042; C08J 5/043; C08J 2379/08; C08G 73/1071

(57) ABSTRACT

A method comprises preparing or receiving a polyetherimide precursor solution including (i) a solvent comprising water, aliphatic alcohol, or a mixture thereof; (ii) an amine additive comprising a secondary or tertiary amine; and (iii) a polyetherimide precursor dissolved and dissociated in the solvent. The method further comprises at least partially coating or impregnating one or more reinforcement structures with the polyetherimide precursor solution and polymerizing the one or more polyetherimide precursor reagents to form a polyetherimide matrix such that the one or more reinforcement structures are at least partially embedded in the polyetherimide matrix to provide a composite article.

### CROSS-REFERENCE TO RELATED APPLICATION

This application claims priority to U.S. Provisional Patent Application Ser. No. 62/313,424, entitled “COMPOSITE ARTICLE FROM REACTIVE PRECURSOR MATERIAL,” filed on Mar. 25, 2016, the disclosure of which is incorporated herein by reference in its entirety.

### BACKGROUND

Reinforcing structures, such as reinforcing fibers, can be impregnated with a polymeric material to form a polymer composite comprising the reinforcing fibers embedded in a matrix of the polymeric material. One challenge that has been associated with polymer composites, particularly with those with a thermoplastic polymer matrix, has been adequate wetting out and impregnation of the reinforcing structures with the polymer material, which can have a deleterious effect on mechanical properties of the resulting composite article.

### SUMMARY

The present disclosure describes a system and method for manufacturing a composite article made from reinforcement structures, such as fibrous reinforcing structures, coated, impregnated, or otherwise substantially covered by a polyetherimide matrix formed from a polyetherimide precursor comprising one or more polyetherimide precursor reagents, such as a polyetherimide precursor solution or a polyetherimide precursor powder comprising the one or more polyetherimide precursor reagents.

The present inventors have recognized, among other things, that a problem to be solved can include difficulty in fully wetting or impregnating reinforcement structures with fully-polymerized polyetherimide resin, resulting in polyetherimide composite articles with higher porosity and diminished mechanical properties. The present subject matter described herein can provide a solution to this problem, such as by providing a polyetherimide precursor solution with a relatively low viscosity that can much more easily wet a reinforcement structure for a composite than already-polymerized polyetherimide resin.

The present inventors have recognized, among other things, that a problem to be solved includes that the formation of polyetherimide composite articles with dissolved polyetherimide have previously required the use of aggressive organic solvents or molten polyetherimide. The present subject matter described herein can provide a solution to this problem, such as by providing for preparation of a composite article using solutions of one or more polyetherimide precursor reagents in relatively mild solvents, such as water or an aliphatic alcohol such as methanol or ethanol.

The present inventors have recognized, among other things, that a problem to be solved includes that even with polyetherimide composites made using aggressive organic solvents, the polyetherimide solutions tend to have high viscosities (typically over 10,000 centipoise (cP) at 25° C. for a commercially-viable solid concentration), making proper wetting of reinforcement structures very difficult or impossible. The present subject matter described herein can provide a solution to this problem, such as by providing for one or more polyetherimide precursor solutions with a low solution viscosity, e.g., at or below 500 cP at 25° C., and in some examples at or below 200 cP at 25° C., that can more fully and rapidly wet the reinforcement structures.

The present inventors have recognized, among other things, that a problem to be solved includes that solutions of polyetherimide materials in aggressive organic solvents or in a molten form can require large amounts of energy to maintain the solution or the polyetherimide melt. For example, the process can require a large amount of energy to provide a temperature that is sufficiently high to keep the polyetherimide in solution or to maintain the molten phase of the polyetherimide. The present subject matter described herein can provide a solution to this problem, such as by providing for one or more polyetherimide precursor solutions that can be prepared and maintained at relatively low temperatures, e.g., at a temperature of no more than 100° C., and in some examples as low as room temperature (25° C.), resulting in a process for fabricating a polyetherimide composite that uses much less energy.

The present inventors have recognized, among other things, that a problem to be solved can include a limited ability to control the final properties of a polyetherimide material used to produce a polyetherimide composite article, such as the molecular weight, molecular structure, branching and cross-linking, and final properties such as tensile strength, impact strength, heat resistance, glass transition temperature (Tg), chemical resistance, and other physical and chemical properties of the polyetherimide. The present subject matter described herein can provide a solution to this problem, such as by providing for control over physical and chemical properties of a final polyetherimide material by controlling initial properties of the polyetherimide precursor that is reacted to form the final polyetherimide. In an example, control over these physical and chemical properties can be achieved by controlling the polyetherimide precursor molecular structure by selecting the backbone structure, functionality, and molar ratio of reactive end groups like anhydride or amine end groups, or both. For example, the one or more anhydride precursor reagents and the one or more amine precursor reagents that are used to form the polymer chains can be selected and controlled, or the relative concentrations of each of the one or more polyetherimide precursor reagents in the polyetherimide precursor can be controlled, or both.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a conceptual cross-sectional view of an example composite article comprising fibrous reinforcement structures impregnated with a polyetherimide matrix.

FIG. 2 is a conceptual cross-sectional view of another example composite article comprising a thin polyetherimide coating layer deposited on a thicker substrate layer.

FIG. 3 is a flow diagram of an example method of fabricating a composite article from a polyetherimide precursor.

FIG. 4 is a conceptual schematic diagram of a system for casting a polyetherimide precursor solution in order to form a polyetherimide sheet.

FIG. 5 is a conceptual schematic diagram of a system for fabricating a polyetherimide precursor impregnated prepreg.

FIG. 6 is a conceptual schematic diagram of a system for fabricating a composite article comprising a wound polyetherimide-impregnated filament.

FIG. 7 is a conceptual schematic diagram of a system for applying a polyetherimide-impregnated fiber structure to a layup mold.

FIG. 8 is a conceptual schematic diagram of a system for reinforcing a pipe with a polyetherimide impregnated reinforcing structure.

FIG. 9 is a graph showing the weight-average molecular weight evolution over time for the polymerization of a polyetherimide prepolymer in a methanol-based solution in a nitrogen environment at 250° C. to form a polyetherimide polymer.

FIG. 10 is a graph showing the weight-average molecular weight evolution over time for the polymerization of a polyetherimide prepolymer in a methanol-based solution in air at 250° C. to form a polyetherimide polymer.

FIG. 11 is a graph showing the weight-average molecular weight when heated at different temperature for polymerization of a polyetherimide prepolymer in a water-based solution in air for 60 minutes to form a polyetherimide polymer.

FIG. 12 is a graph showing a temperature and pressure profile for a long-cycle compression molding cycle with a total cycle time of 150 minutes to consolidate a plurality of composite sheets to form a multi-layered composite laminate.

FIG. 13 is a graph showing a temperature and pressure profile for a short-cycle compression molding cycle with a total cycle time of 40 minutes to consolidate a plurality of composite sheets to form a multi-layered composite laminate.

FIG. 14 is a bar graph of the results of tensile strength testing of several examples of composite laminate structures in accordance with the present disclosure and comparative composite laminates.

FIG. 15 is a bar graph of the results of flexural modulus testing of several examples of composite laminate structures in accordance with the present disclosure and comparative composite laminates.

FIG. 16 is a graph of the results of dynamic mechanical analysis testing of several examples of composite laminate structures in accordance with the present disclosure and one comparative composite laminate.

### DETAILED DESCRIPTION

Reinforced polymer composites are becoming more and more widely used, such as in the manufacture of making load-bearing structural parts, for example in aircraft structures, automotive, and industrial applications. Reinforced polymer composite articles comprise one or more reinforcement structures in intimate intermixed contact with a polymer matrix. The phrase “one or more reinforcement structures” will be referred to simply as “a reinforcement structure” or “reinforcement structures” for brevity. However, it will be understood that both the singular form “reinforcement structure” and the plural form “reinforcement structures” can refer to one structure or a plurality of structures. In many examples, the reinforcement structures comprise one or more fibrous reinforcement structures (or simply “fibrous reinforcement structure” or “fibrous reinforcement structures”), such as one or more reinforcing fibers (or simply “reinforcing fiber” or “reinforcing fibers”). Reinforcing fibers in polymer composite articles are arranged in discontinuous forms, e.g., non-associated discontinuous reinforcing fibers (also known as staple reinforcing fibers or chopped reinforcing fibers), and continuous forms. Examples of continuous forms include, but are not limited to, woven fabrics, nonwoven fabrics, unidirectional tapes, automatic tape laying structures, wound filaments, tailored fiber preforms, fiber layup structures, and shaped-fiber members.

When designed properly, a polymer composite article can exhibit beneficial properties of both the reinforcement structures and the polymer matrix, or one or both of the reinforcement structures or the polymer matrix can diminish or lessen undesired properties of the other component, or both. For example, a polymer composite article can have ductility benefits provided by the polymer matrix and improved tensile or compressive strength, or both, from reinforcing fibers embedded in or impregnated with the polymer matrix.

Polymer composites are typically either thermoset-polymer based, e.g., where the final polymer matrix is a thermosetting polymer, or thermoplastic-polymer based, e.g., where the final polymer matrix is a thermoplastic polymer. Each type of composite have typically been manufactured by its own process.

Thermoset-polymer based composites, in particular those with fiber or fabric reinforcement, have been used in successful applications for decades. The manufacture of a thermoset-fiber composites usually starts with making pre-impregnated laminates, often referred to as “prepreg laminates” or simply “prepregs,” using monomer or precursor solutions, which are then cured to form the finished composite. The prepreg laminates have a limited shelf-life, however, which limits their usefulness and can lead to unnecessary waste during high-volume manufacturing. Also, composites made from thermoset polymers typically cannot be reprocessed once the shape of the polymer is formed, such as if a defect is found in the prepreg laminates. When this occurs, the article has to be completely scraped and typically cannot be reused or repaired. Therefore, productivity of thermoset-based composites can be low and processes can be expensive and inflexible.

In recent years, production of thermoplastic-based composites has increased, and new technologies in thermoplastic-based composites are being developed rapidly due to the advantages of recyclability and reprocessing of thermoset polymers and composites made with them. Some processes have been successfully developed, for example, pultrusion of unidirectional tape using a pultrusion extrusion process.

There are still technical challenges that are frequently encountered with thermoplastic-based composites, however, especially when making woven or non-woven fabric composites. One challenge is the high viscosity that is typical with thermoplastic resins, which can make wetting reinforcement structures difficult. This is particularly true with highly-loaded reinforcing fibers, which often result in small and tortuous pathways into which the thermoplastic polymer must follow in order to impregnate the reinforcement structure. Another challenge is the high processing temperature that is typically required to ensure that the thermoplastic material is in a liquid form that can sufficiently flow in order to impregnate the reinforcement structures. For example, high-performance engineered thermoplastics, such as high-molecular weight polyetherimides (e.g., those sold under the trade name ULTEM), in general, have high melting temperatures, and even after melting have high viscosities.

During impregnation, a thermoplastic polymer melt often contacts much cooler fabrics or other reinforcing structures. Even if the reinforcement structure is preheated in an attempt to prevent the reinforcement structure from being too cool, it is not uncommon for the heating to be non-uniform such that interior portions of the reinforcement structure are still much cooler than the molten polymer. As the thermoplastic polymer melt comes into contact with the cooler portions of the reinforcement structure, the thermoplastic polymer melt cools down rapidly, leading to even higher viscosity. In some cases, portions of the polymer solidifies, which can block a portion of the pathways into the reinforcement structure. The increased viscosity and blocked pathways often leads to poor penetration of thermoplastic polymers into reinforcement structures and poor wetting of the reinforcement structures. This, in turn, can result in undesirably high porosities in the final composite article made with thermoplastic polymer matrices.

The systems and methods described herein combine some advantages of thermoset-based composite manufacture, e.g., low viscosity of precursor solutions, with advantages of thermoplastic composites, e.g., recyclability and reprocessing, in the production of composites that include a polymer matrix made from a polyetherimide, such as those sold under the trade name ULTEM by Saudi Basic Industries Corp. (SABIC), Pittsfield, Mass., USA. The systems and methods described herein use a polyetherimide precursor (or simply “precursor”) comprising one or more polyetherimide precursor reagents. The concept of “one or more polyetherimide precursor reagents” will be referred to hereinafter as “precursor reagents” or and/or “precursor reagent” for brevity, however it will be understood that, unless expressly stated otherwise, both the singular form “precursor reagent” and the plural form “precursor reagents” can refer to a singular precursor reagent (such as a precursor comprising a reaction product of one or more anhydride precursor reagents and one or more amine precursor reagents, described in more detail below) or to a plurality of precursor reagents (such as a precursor comprising both one or more anhydride precursor reagents and one or more amine precursor reagents). In an example, the precursor can be a polyetherimide precursor solution (or simply “precursor solution”) that includes the one or more precursor reagents or a polyetherimide precursor powder (or simply “precursor powder”) that includes the one or more precursor reagents.

The inventors have found that the use of the one or more precursors described herein can result in much better coating and wettability of reinforcement structures, such as fibrous reinforcement structures, as compared to comparable polymerized polyetherimide resins either in a solution or molten form. In particular, the precursor comprising one or more precursor reagents described herein have much lower molecular weights than the polymerized polyetherimides, which were found to provide for a substantially lower viscosity of the precursor solutions or melts of precursor powders described here.

The inventors have also found that the one or more precursor reagents that make up the precursor solution or the precursor powder can be dissolved in much less aggressive solvents compared to those that are typically required for fully polymerized polyetherimide resins. For this reason, composite articles made by the systems and methods described herein can be manufactured in a safe and more environmentally-friendly manner. In some examples, the precursor solution has a relatively low viscosity, even at a high loading, e.g., no more than about 500 cP at 25° C., such as no more than about 200 cP at 25° C., even when the dissolved solids concentration of the precursor reagents in the precursor solution of at least 10 wt %, such as at least 30 wt %, for example at least 50 wt %. The relatively low viscosity of the precursor solution can allow for relatively large loading of the reinforcement structures, such as fibrous reinforcement structures, relative to the weight of the resulting polyetherimide matrix. For example, reinforcing structures, such as fibrous reinforcing structures, can be loading to at least about 20 wt % of the polyetherimide matrix, such as at least about 30 wt % of the polyetherimide matrix, for example at least about 40 wt % of the polyetherimide matrix, such as at least about 50 wt % of the polyetherimide matrix.

In examples where a precursor solution is used, the reinforcement structures can be coated or impregnated with the precursor solution using similar methods to those used to make prepreg laminates for thermoset-based composites, such as dip-coating or spray coating and the like. In examples where the precursor comprises a precursor powder, powder coating or other common methods of applying a powder to a laminate or other support structure can be used to coat the precursor powder onto the reinforcement structures.

The precursor reagents in the precursor solution or precursor powder coated on or impregnated in the reinforcement structures can be partially polymerized to an intermediate molecular weight to partially set the precursor. The partially-polymerized precursor reagents can remain chemically reactive until a later time, when the reagents are polymerized to a larger, final molecular weight, for example by polymerizing and imidizing the precursor reagents to be a high molecular weight polyetherimide by further heating the precursor solution.

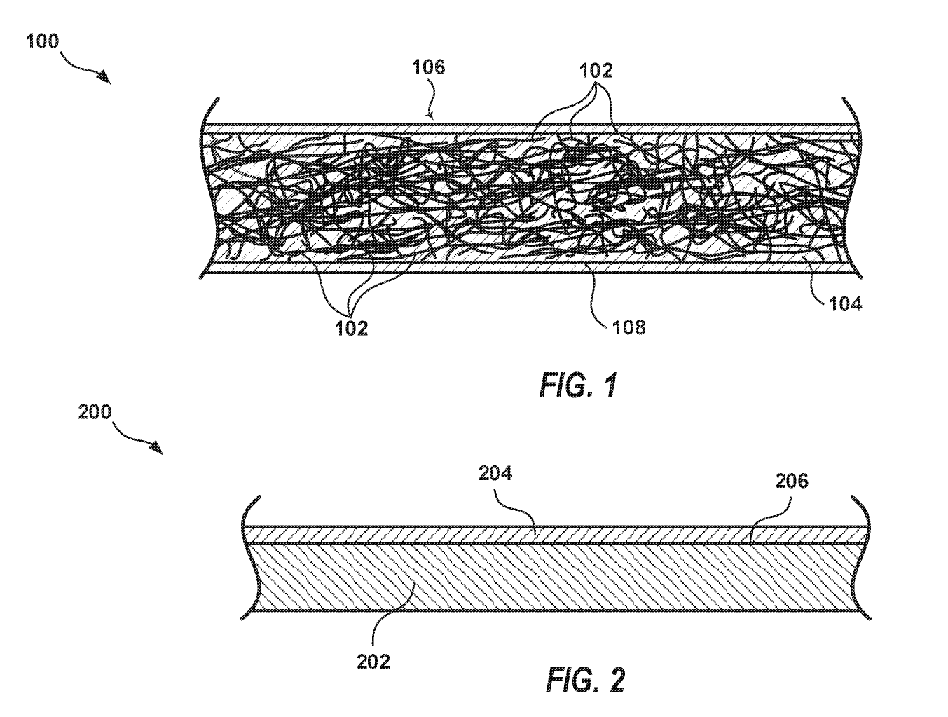

FIG. 1 shows a generic example of a composite article 100. The representation of the composite article 100 is exaggerated so that details of certain aspects of the composite article 100 can be seen.

In an example, the composite article 100 includes reinforcement structures 102 in the form of a plurality of reinforcing fibers 102. The reinforcing fibers 102 are coated or impregnated by a polymer matrix 104, such as a polyetherimide matrix 104. The polyetherimide matrix 104 can be formed into a matrix shape 106, such as a sheet, laminate, or other shaped geometry, however, the polyetherimide matrix 104 need not be formed or shaped. The matrix shape 106 can provide the main physical geometry of at least a portion of the composite article 100. As described in more detail below, the matrix shape 106 can be dictated by the application in which the composite article 100 is being used. The method of forming the physical matrix shape 106 can be dictated by the application in which the composite article 100 will be used. In some examples, the method of forming the physical matrix shape 106 not only shapes the polyetherimide matrix 104, but also positions or shapes the reinforcing fibers 102 as desired for the particular application of the composite article 100. Examples of methods used to form the physical matrix shape 106 include, but are not limited to, casting, extrusion, pultrusion, layup, coating (e.g., dip coating, spray coating, or powder coating) onto the reinforcing fibers 102, and molding.

In an example, the reinforcing fibers 102 are in the form of discontinuous fibers, e.g., chopped fibers 102, dispersed within the matrix shape 106 of the polyetherimide matrix 104. In an example, the polyetherimide matrix 104 can be formed from a precursor solution comprising precursor reagents by casting the precursor solution into a flat sheet and then polymerizing the precursor reagents to form the polyetherimide matrix 104.

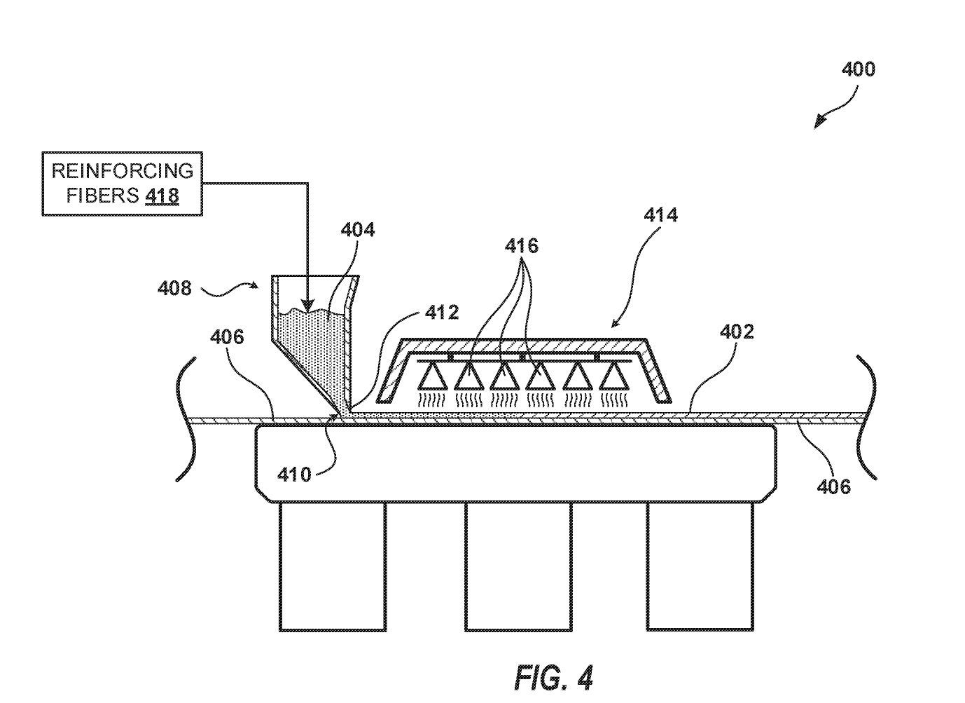

FIG. 4 shows an example system 400 for forming a polyetherimide sheet 402 by dispensing a precursor 404 onto a support substrate 406 and initiating polymerization of the precursor reagents present in the precursor 404 to form a polyetherimide polymer matrix in the form of the polyetherimide sheet 402. As noted above, the precursor 404 can be a precursor solution or a precursor powder that includes precursor reagents. For example, the precursor 404 can be dispensed onto the support substrate 406 by casting a film of a precursor solution onto or by dispensing a layer of a precursor powder onto the support substrate 406.

In some examples, chopped reinforcing fibers 418, which can be similar to a discontinuous form of the reinforcing fibers 102 in the composite article 100, are mixed into the precursor 404 so that when the precursor 404 is dispensed to form the polyetherimide sheet 402, it forms a composite sheet that includes the chopped reinforcing fibers 418 at least partially embedded in the polyetherimide matrix that forms the polyetherimide sheet 402. Further details regarding the example system 400 are provided below. A composite article 100 with a polyetherimide matrix 104 in the form of a sheet and discontinuous reinforcing fibers 102 need not be formed by casting, such as is primarily described with respect to the system 400. A person of skill in the art will recognize that methods or systems for forming polymer sheets other than casting can be used, such as spray coating, dip coating, spin coating, powder coating and the like. In some examples, after forming the sheet, one or more of the sheet articles can be further consolidated by methods including, but not limited to, static compression molding, calendaring, double-belt pressing, or similar methods to improve one or more of the mechanical strength, thickness, uniformity (e.g., dimensional control), surface aesthetics, or surface decoration. The system 400 is merely described here as forming the polyetherimide sheet 402 by casting for the purposes of illustration.

In an example, the reinforcing fibers 102 are arranged or shaped into a fiber preform. In some examples, as used herein, the term “fiber preform” refers to the reinforcing fibers 102 being arranged in a specified configuration prior to the reinforcing fibers 102 being subjected to the operation or operations that will coat the reinforcing fibers 102 with the polyetherimide matrix 104, embed the reinforcing fibers 102 in the polyetherimide matrix 104, or impregnate the reinforcing fibers 102 in the polyetherimide matrix 104. Examples of fiber preforms used for the reinforcing fibers 102 include, but are not limited to, at least one of: a woven fabric, a unidirectional tape, a tailored fiber preform, a fiber layup structure, one or more wound filaments, an automatic tape laying structure, or a shaped fiber structure member.

Although the reinforcement structure of the composite article 100 is shown and described as reinforcing fibers 102, those of skill in the art will appreciate that other forms of reinforcement structures can be used without varying from the scope of composite articles contemplated herein. Other examples of reinforcement structures that can be used in addition to or in place of the reinforcing fibers 102 include, but are not limited to, one or more of: filler structures (e.g., particulate filler or short fiber filler), such as nanostructure fillers (e.g., carbon nanotubes, including single-wall and multi-walled carbon nanotubes, carbon nanoparticles, ceramic or metal oxide nanostructures, or other nanomaterials) or larger dimensional mineral filler, or pre-shaped structural inserts. Examples of mineral fillers useful in the composite article 100 include, but are not limited to: needle-like mineral filler, such as needle-like wollastonite; plate-like mineral filler, such as plate-like talc; or particulate or sphere-like mineral filler, such as sphere-like calcium carbonate or glass spheres. Examples of structural inserts include, but are not limited to, molded, machined, or otherwise shaped articles made out of a suitable structural material, e.g., a material that will provide for desired beneficial mechanical properties for the composite article 100. Examples of materials used to form structural inserts as a reinforcement structure in the composite article 100 include, but are not limited to, metal, ceramic, or polymers, including (but not limited to) a high heat-resistance polymer that includes amorphous polymers, crystalline polymers, or semi-crystalline polymers, such as polyetherimide, high-heat polycarbonate (HT-PC), high-heat polyamide (HT-PA), polyimide (PI), polyamidimide (PAI), polyphenylensulfide (PPS), polyaryletherketone (PAEK), polysulfone (PSU), polyacrylsulfone (PSU, PESU, PPSU), liquid-crystal polymer (LCP), polyether ether ketone (PEEK), polyether ketone ketone (PEKK), or polybenzimidazole (PBI).

In the case of reinforcing structures that are fibrous, such as the reinforcing fibers 102 for the example composite article 100, the reinforcing fibers 102 can be any type of fiber that can, when combined with the polyetherimide matrix 104, provide desired properties, such as one or more mechanical properties, electrical properties, or viscoelastic properties. Examples of fiber materials that can be used for the reinforcing fibers 102 include, but are not limited to, one or any combination of two or more of: carbon fibers, carbon nanofibers, single-wall carbon nanotubes, multi-wall carbon nanotubes, synthetic fibers, such as aramid fibers and the like, glass fibers, metal fibers, rubber fibers (either natural or synthetic rubber), polymer fibers (such as nylon or polyester fibers), mineral fibers (such as basalt fibers), polymer fibers, or natural fibers (e.g., cellulosic fibers or other plant-based fibers including, but not limited to, cotton, rayon, acetate, or triacetate fibers; or animal-based fibrous structures, such as wool, silk, or other animal-based fabric fibers, or biological fibrous materials, such as collagen).

As described in more detail below, the composite article 100 is made through the use of a precursor that includes precursor reagents, such as a precursor solution. The precursor can take the form of a low-viscosity precursor. e.g., a precursor solution or one or more molten precursor reagents (e.g., from a molten powder) having a relatively low viscosity, that can relatively easily flow into and around the reinforcing fibers 102 so as to relatively completely wet the reinforcing fibers 102. The high degree of wetting of the reinforcing fibers 102 with the precursor allows for one or more of: higher mechanical strength for the composite article 100 compared to a comparable composite article where the same degree of wettability was not achievable, lower porosity for the composite article 100 compared to a comparable composite article where the same degree of wettability was not achievable, and a higher density for the composite article 100 compared to a comparable composite article where the same degree of wettability was not achievable.

In an example, the precursor, described in more detail below, provides for a porosity of the composite article 100 of no more than about 5%. In an example, “porosity,” as used herein, refers to the volume percentage of non-solid void spaces within the composite article 100, as compared to the volume of the composite article 100 taken up by the solid materials of the reinforcing fibers 102 or the polyetherimide matrix 104. In an example, the porosity of the composite article 100 is no more than about 2%. In an example, the porosity of the composite article 100 is no more than about 1%. In an example, the porosity of the composite article 100 is no more than about 0.5%. In an example, the porosity of the composite article 100 is no more than about 0.1%.

In some examples, the polyetherimide matrix 104 includes a polymerization reaction product of precursor reagents. In an example, the polyetherimide matrix 104 includes a polymerization reaction product of one or more anhydride precursor reagents (referred to hereinafter as “an anhydride precursor” or “anhydride precursors,” wherein both can refer to either a single anhydride precursor reagent or a plurality of anhydride precursor reagents) and one or more amine precursor reagents (referred to hereinafter as “an amine precursor” or “amine precursors,” wherein both can refer to either a single amine precursor reagent or a plurality of amine precursor reagents). In some examples, the anhydride reagents that form the reaction product of the polyetherimide matrix 104 include at least one of: one or more monofunctional anhydride reagents, one or more difunctional anhydride reagents, or one or more multifunctional anhydride reagents. In some examples, the amine reagents that form the reaction product of the polyetherimide matrix 104 include at least one of: one or more monofunctional amine reagents, one or more difunctional amine reagents, or one or more multifunctional amine reagents.

As used herein, the term “monofunctional,” when referring to an anhydride reagent or an amine reagent, refers a precursor molecule having only a single functional reaction location that will react with another reagent or with a polyetherimide polymer chain that is growing as part of the polyetherimide matrix 104. Monofunctional reagents are sometimes referred to as chain-stopping agents because when they react with a polymer chain, they can stop that portion of the polymer chain from growing any further. Monofunctional reagents can be used, for example, to control molecular weight, such as the number average molecular weight (also referred to as “Mₙ” for brevity), of the polyetherimide matrix 104.

As used herein, the term “difunctional,” when referring to an anhydride reagent or an amine reagent, refers to a precursor molecule having two functional reaction locations to react with another reagent or with a growing polyetherimide polymer chain as part of the polyetherimide matrix 104. Difunctional anhydride reagents, also referred to as “dianhydrides,” “bisanhydrides,” or “bisanhydride reagents,” and difunctional amine reagents, also referred to as “diamines” or “diamine reagents.” are preferred when it is desired to have the polyetherimide matrix 104 be a thermoplastic or primarily thermoplastic polyetherimide.

As used herein, the term “multifunctional,” when referring to an anhydride reagent or an amine reagent, refers a precursor molecule having more than two functional reaction locations to react with another reagent or a growing polyetherimide polymer chain as part of the polyetherimide matrix 104, such as three, four, or more reactive locations. Multifunctional anhydride reagents and amine reagents can be used if it is desired to have the polyetherimide polymer chains form crosslinking within the polyetherimide matrix 104 or to have the polyetherimide matrix 104 form a more three-dimensional macromolecular structure, or both. Crosslinking and three-dimensional macromolecular structure for the polyetherimide can provide the polyetherimide matrix 104 with at least some properties typically associated with thermosetting polymers, such as improved mechanical strength, thermal stability, creep resistance, heat and chemical resistance, or other properties. In some examples, the precursor reagents selected can be primarily multifunctional precursor reagents (e.g., multifunctional anhydride reagents and multifunctional amine reagents) so that the polyetherimide matrix 104 is a thermoset polymer and the composite article 100 is a thermoset-based composite.

In some examples, the precursor can comprise a combination of two or more of: (1) one or more monofunctional precursor reagents, (2) one or more difunctional precursor reagents, and (3) one or more multifunctional precursor reagents. The combination of more than one kind of functional precursor reagent can allow for linear, branched and cross-linked polyetherimide structures. The resulting polyetherimide materials can combine the benefits of thermoplastics for ease of processing and thermosets for mechanical strength and chemical resistance properties.

In an example, the anhydride reagents that form the reaction product of the polyetherimide matrix 104 include one or more difunctional anhydride reagents, also referred to as one or more bisanhydride precursor reagents, or simply “a bisanhydride reagent” or “bisanhydride reagents” (both of which can refer to a single reagent or a plurality of reagents), such as 4,4′-bisphenol A dianhydride. In an example, the amine reagents that form the reaction product of the polyetherimide matrix 104 include one or more difunctional amine reagents, also referred to as one or more diamine precursor reagents, or simply “a diamine reagent” or “diamine reagents” (both of which refer to a single reagent or a plurality of reagents), such as a phenylene diamine. In an example, the amine reagents that form the reaction product of the polyetherimide matrix 104 includes a para-phenylene diamine or a meta-phenylene diamine.

In an example, the polyetherimide matrix 104 comprises a reaction product of anhydride reagents that includes difunctional anhydride reagents, e.g., bisanhydride reagents such as 4,4′-bisphenol A dianhydride, and amine reagents that includes difunctional amine reagents, e.g., diamine reagents. In some examples, the amine reagents includes a phenylene diamine so that the polyetherimide matrix 104 includes a phenylene diamine structural unit. In an example, the amine reagents includes a para-phenylene diamine such that the polyetherimide matrix 104 comprises one or more para-phenylene diamine structural units. In an example, the amine reagents includes a meta-phenylene diamine such that the polyetherimide matrix 104 comprises one or more meta-phenylene diamine structural units. In an example, the polyetherimide matrix 104 is a reaction product of 4,4′-bisphenol A dianhydride with meta-phenylene diamine. In an example, the polyetherimide matrix 104 is a reaction product of 4,4′-bisphenol A dianhydride with para-phenylene diamine.

The polyetherimide matrix 104 is not limited to these specific anhydride and amine reagents. Any anhydride reagent and amine reagent that can provide for advantageous properties of the resulting matrix 104 and/or the resulting composite 100 can be used. Further details of example anhydride reagents and amine reagents that can be used to form the reaction product of the polyetherimide matrix 104 are described in more detail below.

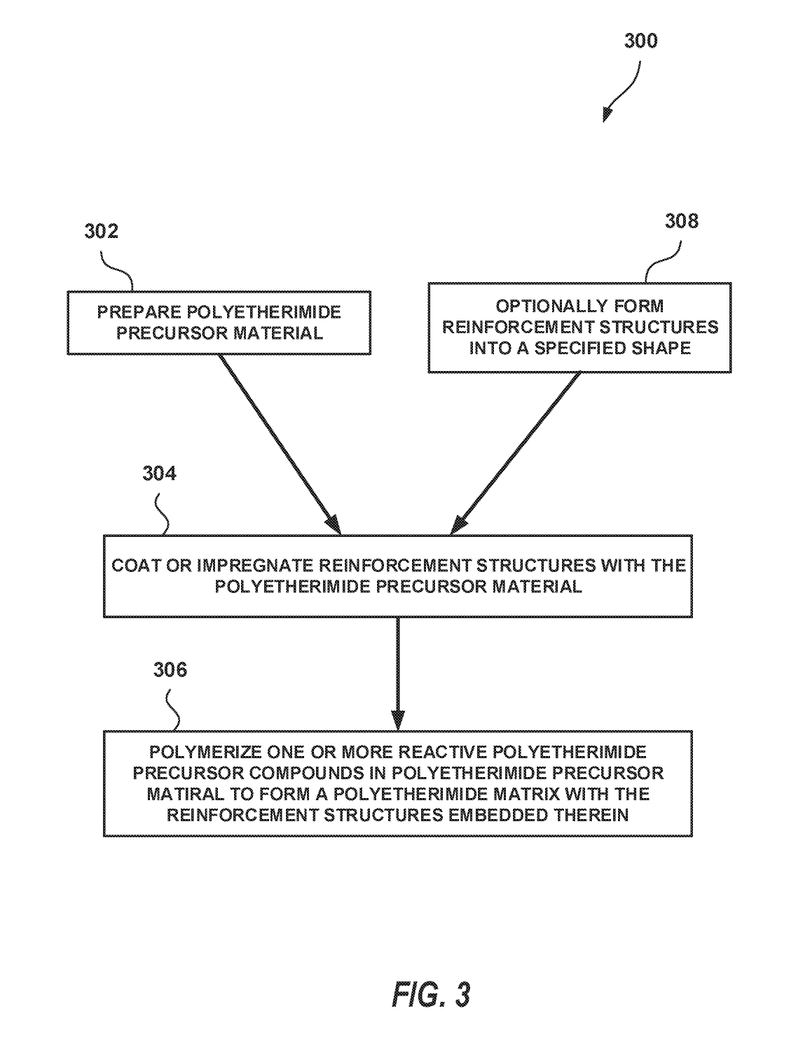

In an example, the polyetherimide matrix 104 is formed by polymerizing the anhydride reagents and the amine reagents from the precursor (e.g., a precursor solution or a precursor powder), described in more detail below with respect to the flow diagram of the method 300 shown in FIG. 3. In some examples, a precursor solution is prepared by dissolving anhydride reagents and amine reagents in one or more solvents (referred to hereinafter as “solvent” or “solvents,” which can both refer to either a single solvent material or a mixture of a plurality of solvent materials). In some examples, the precursor solution used to form the polyetherimide matrix 104 can have a relatively low viscosity, as discussed in more detail below. A relatively low precursor solution viscosity allows for relatively high loading of the reinforcement structures. e.g., the reinforcing fibers 102, in the polyetherimide matrix 104. In an example, the composite article 100 has a reinforcement loading, e.g., a loading of reinforcing fibers 102, of at least about 20 wt % of the polyetherimide matrix 104. In an example, the composite article 100 has a loading of the reinforcing fibers 102 of at least about 30 wt % of the polyetherimide matrix 104. In an example, the composite article 100 has a loading of the reinforcing fibers 102 of at least about 40 wt % of the polyetherimide matrix 104. In an example, the composite article 100 has a loading of the reinforcing fibers 102 of at least about 50 wt % of the polyetherimide matrix 104.

FIG. 2 shows a cross-sectional view of another example composite article 200. The example composite article 200 comprises a support structure that is at least partially coated with a polyetherimide structure. In an example, the composite article 200 comprises a substrate 202 and the polyetherimide structure is a polyetherimide layer 204 that has been coated onto at least a portion of a coated surface 206 of the substrate 202.

In an example, the substrate 202 can form the primary structural body of the composite 200. In such an embodiment, the polyetherimide layer 204 can be a thin surface coating or skin layer at the coated surface 206 of the substrate 202. In an example with the polyetherimide layer 204 acting as a thin coating or skin layer on the substrate 202, the substrate 202 can have a thickness that is larger than a thickness of the polyetherimide layer 204, and in some examples substantially larger. In an example, the substrate 202 can comprise a generally planar or sheet-like layer so that the resulting composite 200 also comprises a generally planar or sheet-like structure.

In some examples where the polyetherimide layer 204 is formed as a thin coating or thin skin layer on the substrate 202, the thin polyetherimide layer 204 can modify the coated surface 206 such that at least the coated surface 206 of the composite sheet 200 has one or more beneficial properties associated with polyetherimides, such as one or more of chemical resistance to a broad range of chemicals, thermal resistance (including flame resistance in some examples), or high strength, toughness, or stiffness of the composite 200 at the coated surface 206. Many beneficial properties of polyetherimides can be provided to the composite 200 even if the polyetherimide layer 204 has a very small thickness of only 0.03 mm or less. In an example, the substrate 202 can be formed from a material that is different from the polyetherimide layer 204, such as another polymer material that provides substantial structural support to the composite 200 and can even have some mechanical properties that are superior to polyetherimides such as those of the polyetherimide layer 204.

In some examples, the material of the substrate 202 can be substantially less expensive than the polyetherimide of the polyetherimide layer 204, such as a less expensive polymer, a glass, or a metal substrate. In such an example, the structural and mechanical properties of the composite 200 can be substantially provided by the less-expensive material of the substrate 202 so that the substrate 202 can make up a large percentage, and in most examples a majority, of the weight of the composite 200. Meanwhile, the thin coating or skin layer of the polyetherimide layer 204 can provide one or more of the chemical resistance, thermal resistance, and toughness or strength associated with polyetherimides, but at a fraction of the cost that would be required to make the entire sheet out of a polyetherimide or polyetherimides. In other words, the formation of a thin coating or skin layer with the polyetherimide layer 204 can have some of the benefits of the material of the substrate 202, such as being relatively inexpensive with substantial mechanical strength and stability, and also can have some of the benefits of polyetherimides, such as chemical resistance, thermal resistance, and toughness.

In some examples, a material of the substrate 202 may be unable to readily withstand the temperatures needed to process the precursor in order to form the polyetherimide layer 204, e.g., because a material of the substrate 202 may not be able to withstand the temperature applied to initiate and propagate polymerization and imidization of the precursor reagents to form the polyetherimide matrix that forms the polyetherimide layer 204. For example, as described in more detail below, the precursor reagents described herein can be polymerized and imidized at temperatures as high as 150° C. for intermediate polymerization state, or as high as 380° C. for full polymerization of the precursor reagents. In such examples, the method of forming or applying the polyetherimide layer 204 to the substrate 202 can be modified to protect the substrate 202 from the temperature for polymerization of the precursor reagents or to isolate the substrate 202 from such temperatures. In an example, to protect the substrate 202 from the high polymerization temperature, the polyetherimide layer 204 is formed by applying a very thin layer of the precursor, e.g., a thin layer of a precursor solution or a thin layer of a precursor powder, and then applying a rapid burst of heat to the thin layer to initiate polymerization of the precursor reagents. Because the layer of the precursor is thin, the rapid burst of heat can be sufficient to initiate polymerization, and in some examples to complete polymerization and imidization, but is so rapid that the temperature of the substrate 202 does not reach a level that will adversely affect the substrate 202. In another example, the polyetherimide layer 204 can be formed separate from the substrate 202, e.g., as stand-alone layer, that is subsequently bonded to the substrate 202, such as with one or more adhesive layers between the polyetherimide layer 204 and the substrate 202. The polyetherimide of the separately-formed polyetherimide layer 204 that is bonded to the substrate 202 can be partially polymerized or fully polymerized, depending on the desired application.

Like the polyetherimide matrix 104 for the composite article 100, the polyetherimide layer 204 on the coated surface 206 of the composite sheet 200 can be made using a precursor that include anhydride reagents, wherein the precursor reagents are polymerized and imidized to form a polyetherimide matrix of the polyetherimide layer 204. In some examples, the precursor is a precursor solution that is applied to a structure, such as the substrate 202, such as via one or more of casting, spray coating, dip coating, spin coating, painting, or other liquid application methods. In some examples, the precursor is a precursor powder, and the method of forming the composite sheet 200 includes applying the precursor powder onto the substrate 202 via powder coating or other powder application methods. In an example, the applied precursor powder is heated to a temperature that melts the powder to form a molten precursor and that polymerizes the precursor reagents to form the polyetherimide layer 204. In another example, the precursor powder is dissolved in a solvent, such as the one or more environmental friendly solvents described herein, to form a precursor solution that is then processed using the methods described herein.

The relatively low viscosity of the precursor solution or melted precursor powder, discussed in more detail below, can allow for relatively easy application of the precursor solution without the formation of substantial void spaces in the polyetherimide layer 204 because the low viscosity of the precursor solution can allow gas bubbles to escape before they can form void spaces in the polyetherimide layer 204. The precursor reagents in the precursor solution also can be polymerized relatively easily (e.g., via the application of heat) to form polyetherimides, and, as discussed below, the level or degree of polymerization can be controlled, at least in some examples, by controlling the temperature and time at which the precursor reagents are polymerized. In some examples, application of the precursor to the substrate 202 and polymerization of the precursor reagents in the precursor to form the polyetherimide layer 204 is performed in an inert environment, e.g., a nitrogen environment, or under vacuum conditions, or both.

FIG. 3 shows a flow diagram of an example method 300 of fabricating a composite article, such as the example composite article 100. The method 300 includes, at step 302, preparing a precursor, such as a precursor solution or a precursor powder, comprising precursor reagents, referred to as “preparing the precursor 302” for brevity. At step 304, one or more reinforcement structures are coated or impregnated with the precursor, referred to as “coating or impregnation of the precursor 304” for brevity. Next, at step 306, the precursor reagents are polymerized to form a polyetherimide matrix, referred to as “polymerization 306” for brevity. One or more intermediate steps can also be added between the coating or impregnation the precursor 304 and the polymerization 306, such as heating the precursor to drive off solvent (for a precursor solution) or to melt the precursor (for a precursor powder). After the polymerization 306, at least a portion of the one or more reinforcement structures is embedded in the resulting polyetherimide matrix to provide a polyetherimide composite article.

In examples where the precursor comprises a precursor solution, preparing the precursor 302 can include dissolving a specified amount of the precursor reagents in a solvent. In an example, dissolving the precursor reagents includes preparing or receiving a precursor powder that includes the desired precursor reagents and then dissolving the precursor powder in the solvent. In such examples, the precursor powder can be more easily and economically transported from a location where the precursor powder is prepared to where the composite article is being fabricated than a precursor solution might be. In some examples, a precursor powder can also be stored more economically and for longer periods of time than a precursor solution without premature polymerization or side reaction with contaminates by the precursor reagents during the storage, especially in a hot environment. The use of a precursor powder can also make selecting and controlling a concentration of the precursor reagents in the resulting precursor solution easier by simply adding more solvent or more precursor powder to decrease or increase, respectively, the concentration of the precursor reagents.

In an example, preparing the precursor 302 includes dissolving a specified amount of one or more anhydride reagents in solvent. In an example, preparing the precursor 302 includes dissolving a specified amount of one or more amine reagents in solvent. In an example, preparing the precursor 302 includes dissolving anhydride reagents and amine reagents in solvent. In an example, preparing the precursor 302 includes dissolving a reaction product of anhydride reagents and amine reagents in the solvent, e.g., a polyetherimide intermediate or other precursor, such as a polyetherimide oligomer made by a partial polymerization reaction of the anhydride reagents and the amine reagents. In an example, preparing the precursor 302 includes dissolving one or both of anhydride reagents or amine reagents and a reaction product of anhydride reagents and amine reagents in the same solvent.

In some examples, preparing the precursor 302 includes preparing a first precursor solution of a first precursor reagent, e.g., one or more anhydride reagents, dissolved in a first solvent or solvents, preparing a second precursor solution of a second precursor reagent, e.g., one or more amine reagents, dissolved in a second solvent or solvents (which can be the same as or different from the first solvent or solvents). At a later time, the first and second precursor solutions can be mixed together to form a mixed precursor solution. When the first and second precursor solutions are mixed, the first and second precursor reagents come into contact with one another in the newly mixed precursor solution so that the first and second precursor reagents are able to react and polymerize to form a polyetherimide that will eventually form the polyetherimide matrix. Separating the first and second precursor reagents in separate solutions can be advantageous because one or both of the first and second precursor solutions can be heated prior to mixing and coating or impregnating the reinforcement structures. As described in more detail below, the temperature of the precursor reagents can be the driving force in polymerizing the precursor reagents to form the polyetherimide. However, in some examples, if the first and second precursor reagents are in the same solution when initially heated, they will begin polymerization once the solution temperature reaches a threshold temperature. If the first and second precursor reagents are in separate solutions, heating one or both of the first or second solutions will not necessarily cause the reaction to commence even if heated well above the threshold temperature, because the first of the precursor reagents will not be in contact with the second of the precursor reagents to react, and vice versa. Therefore, preheating the separate first and second solutions can, in some examples, provide for greater control of the temperature because both the first and second solutions can be heated to and held at a desired temperature such that when the solutions are mixed, the temperature of the mixed solution (which is then coated onto or impregnated into the reinforcement structures) is predictably controlled. As described in more detail below, the temperature of the anhydride reagents during polymerization can, in some examples, dictate the extent of polymerization (e.g., the Mₙ of the resulting polyetherimide). Therefore, better control of the temperature and time of the mixed precursor solution at the time it is coated onto or impregnated into the reinforcement structures can allow for better control over the polymerization of the precursor reagents, including the resulting Mₙ of the resulting polyetherimide matrix.

In examples with a precursor powder, the precursor reagents can be in the form of solid particles, such as solid powder particles. In an example, the powder includes powder particles comprising at least one of anhydride reagents, amine reagents, or a reaction product of anhydride reagents and amine reagents. In some examples, the powder particles comprise an oligomeric reaction product of anhydride reagents and amine reagents, for example powder particles of a polyetherimide oligomer formed by a partial polymerization reaction of the anhydride reagents and the amine reagents. In an example, the powder includes a dry powder mixture of first powder particles comprising one or more anhydride reagents and second powder particles comprising one or more amine reagents, with or without the addition of third powder particles comprising one or more oligomeric reaction products of anhydride reagents and amine reagents.

High-molecular weight polymers, such as polymerized polyetherimides, are not typically amenable to melting and reflow of solid powder or particulates to coat or impregnate reinforcement structures, such as reinforcement fibers, because polymerized polyetherimide typically has a very high melt flow temperature. Even when melted, molten polyetherimide typically has such a high viscosity that it will not adequately flow to coat or impregnate a reinforcement structure, particularly dense fibrous reinforcement structures. In contrast, the precursor reagents of the precursor powder described have substantially lower molecular weights than polymerized polyetherimides, which can allow for lower viscosity and better reflow of the molten precursor powder. In some examples, reflow of the molten precursor powder can be maintained throughout most of the heating process because the molten precursor powder maintains a relatively low viscosity because the molecular weight of the polyetherimide is built primarily after melting

General examples of anhydride reagents and amine reagents that can be used while preparing the precursor 302 are described above with respect to the formation of the reaction product of the polyetherimide matrix 104 in the composite article 100. Specific details of some example anhydride reagents and amine reagents that can be used for preparing the precursor 302 are described in more detail below.

In examples where the precursor reagents include anhydride reagents and amine reagents, the relative concentrations of the anhydride reagents and the amine reagents in the precursor can dictate certain properties of the resulting polyetherimide matrix formed by polymerization of the precursor reagents 306, such as the molecular weight of the polyetherimide matrix or mechanical properties of the polyetherimide matrix and the composite article. In some examples, preparing the precursor 302 includes selecting or controlling the relative concentration of the anhydride reagents and amine reagents in the precursor in order to control one or more properties of the resulting polyetherimide matrix, of the resulting composite article, or both.

In an example, preparing the precursor 302 includes selecting or controlling the relative concentrations of the anhydride reagents and the amine reagents so that a molar ratio of reactive functional end groups of the anhydride reagents relative to the amine reagents in the precursor is from about 1:2 to about 2:1. In an example, preparing the precursor 302 includes selecting or controlling the relative concentrations of the anhydride reagents and the amine reagents so that a molar ratio of reactive functional end groups of the anhydride reagents relative to the amine reagents in the precursor is from about 1:1.3 to about 1.3:1.

In an example, preparing the precursor 302 includes selecting or controlling the relative concentrations of the anhydride reagents and the amine reagents so that the molar ratio of reactive functional end groups of the anhydride reagents relative to the amine reagents in the precursor is substantially equimolar. In an example, the reaction of the anhydride reagents and the amine reagents is a condensation reaction so that at an equimolar ratio of anhydride and amine reactive groups, the produced polyetherimide has the same number of anhydride groups (or its hydrolyzed carboxylic acid group) and amine groups on each end of the polyetherimide chains. In an example, a difunctional anhydride precursor molecule and a difunctional amine precursor molecule react to produce one precursor molecule with reactive carboxylic acid and reactive amine functional groups on each side of the molecule chain.

In some examples where the precursor comprises a precursor solution, the solvent used for preparing the precursor 302 includes one or both of a water-based solvent or an alcohol-based solvent. In an example, the solvent used for preparing the precursor 302 includes water and a secondary or tertiary amine. In an example, the solvent used for preparing the precursor 302 includes an aliphatic alcohol and optionally a secondary or tertiary amine. In an example, the solvent used for preparing the precursor 302 includes a mixture of water and an aliphatic alcohol and optionally a secondary or tertiary amine.

In some examples, the solvent used for preparing the precursor 302 primarily comprises water, one or more aliphatic alcohols, or a mixture of water and one or more aliphatic alcohols (which can include small amounts of one or more additives, such as one or more amine additives, for example a secondary or tertiary amine). As used herein “primarily comprises,” when referring to the composition of the solvent used to prepare the precursory solution, means that a majority of the solvent, i.e., more than 50%, on a weight basis, is made up of water, an aliphatic alcohol, or a combination of water and an aliphatic alcohol, such as at least 55 wt %, at least 60 wt %, at least 65 wt %, at least 70 wt %, at least 75 wt %, at least 80 wt %, or at least 85 wt % water, one or more aliphatic alcohols, or a mixture of water and one or more aliphatic alcohols (with or without amine additives, such as one or more secondary or tertiary amines). In some examples, preparing the precursor 302, and the polymerization 306, described in more detail below, is performed without or substantially without the use of a non-water or non-alcohol based solvent. In other words, in some examples, the solvent used for preparing the precursor 302 and the polymerization 306 only comprises a water-based solvent or an alcohol-based solvent, or both (although the solvent may also include smaller amounts of additives, such as amine additives, for example secondary or tertiary amines) and does not include other harsher organic solvents such as polar aprotic solvents. The use of only water-based and alcohol-based solvents can allow for a safer and more environmentally friendly preparation of the precursor solution and the final polyetherimide matrix of the composite article.

In some examples, the ability of relatively gentle solvents, such as a water-based solvent or an alcohol-based solvent or a combination thereof, to dissolve the precursor reagents allows the precursor solution to be formed and remain stable at relatively low temperatures. A lower temperature requirement for dissolution of the precursor reagents in the solvent allows a temperature at which the precursor solution is coated onto or impregnated into the reinforcement structures to also be relatively low. Low operating temperatures during preparing the precursor 302 and coating or impregnation the precursor 304 (described in more detail below) can have several advantages, including, but not necessarily limited to reduced energy costs and less likelihood of a substantially cooler reinforcement structure causing the precursor reagents to come out of solution or for the polyetherimide that is being formed during polymerization of the precursor reagents 306 to solidify because the precursor solution is cooled by the reinforcement structures. The relatively low temperature necessary to form the precursor solution as well as the relatively low operating temperature during coating or impregnation of the reinforcement structures 304 and polymerization of the precursor reagents 306, is in contrast to polyetherimide solutions formed by dissolving fully-polymerized polyetherimides, which typically requires very high temperatures for dissolution of the polyetherimide, even in aggressive polar aprotic solvents. The precursor solutions described herein can also have substantially lower viscosities compared to solutions of fully-polymerized polyetherimides, which can be more easily coated onto or impregnated into the reinforcement structures during step 304.

In an example, preparing the precursor 302 is performed, and a precursor solution is maintained, at a temperature of no more than about 100° C. In an example, preparing the precursor 302 is performed, and the precursor solution is maintained, at a temperature of no more than about 75° C. In an example, preparing the precursor 302 is performed, and the precursor solution is maintained, at a temperature of no more than about 50° C. In an example, preparing the precursor 302 is performed, and the precursor solution is maintained, at a temperature of no more than about 25° C.

Although the precursor reagents described herein can be dissolved at relatively low temperatures with gentle solvents such as one or both of a water-based solvent or an alcohol-based solvent, the solvent or solvents used to prepare the precursor solution is not necessarily limited to only water-based or alcohol-based solvents. Therefore, in some examples, the solvent includes one or more stronger solvents, such as one or more polar aprotic solvents, for example at least one of tetrahydrofuran (THF), N-Methyl-2-pyrrolidone (NMP), or dimethylacetamide (DMAC). The use of a polar aprotic solvent in preparing the precursor 302 can aid in the dissolution of the precursor reagents or maintain a relatively low viscosity for the precursor solution.

The concentration of the precursor reagents in the precursor solution can be relatively high compared to solvents of fully-polymerized polyetherimides. This is so because of the readily dissolvable nature of the precursor reagents. e.g., one or both of anhydride reagents or amine reagents or a reaction product thereof. This is advantageous because the higher the precursor reagent concentration in the precursor solution, the higher the molecular weight that can be reached when the precursor reagents are polymerized (described below). The substantially higher concentration of the precursor reagents in the precursor solutions described herein is in contrast to polyetherimide solutions formed by dissolving polymerized polyetherimides, which typically has a relatively low solubility, even in aggressive polar aprotic solvents.

In an example, preparing the precursor 302 results in the precursor solution having a dissolved solids concentration of the precursor reagents (referred to hereinafter simply as “dissolved solids concentration”) of at least 10%. In an example, preparing the precursor 302 results in the precursor solution having a dissolved solids concentration of at least 30%. In an example, preparing the precursor 302 results in the precursor solution having a dissolved solids concentration of at least 50%.

As noted above, the ability of the precursor solution or molten precursor powder to wet out onto reinforcement structures in order to provide a low-porosity, and high-quality final polymerized polyetherimide can depend on the viscosity of the precursor solution or the molten precursor powder. A lower viscosity allows the precursor solution or the molten precursor powder to better and more fully wet surfaces of the reinforcement structures. This can be particularly true with fibrous reinforce structures, such as the reinforcing fibers 102 in the example composite article 100, which can be densely packed, particularly within a preformed fiber structure. Impregnation of a densely-packed fiber web, fabric, or other structure requires the impregnating material to readily flow in small, highly-porous structures, which is difficult to accomplish without leaving unintended void spaces if the viscosity is too high. The relatively low viscosities of the precursor solution and the molten precursor powder described herein is in contrast to polyetherimide solutions formed by dissolving fully-polymerized polyetherimide or melts formed by melting fully-polymerized polyetherimide, which typically have relatively high viscosities due to the relatively high molecular weights of the polymerized polyetherimide chains.

In an example, preparing the precursor 302 results in a precursor solution having a viscosity of no more than about 500 cP at 25° C. In an example, preparing the precursor 302 results in a precursor solution having a viscosity of no more than about 400 cP at 25° C. In an example, preparing the precursor 302 results in a precursor solution having a viscosity of no more than about 300 cP at 25° C. In an example, preparing the precursor 302 results in a precursor solution having a viscosity of no more than about 250 cP at 25° C. In an example, preparing the precursor 302 results in a precursor solution having a viscosity of no more than about 200 cP at 25° C. In an example, preparing the precursor 302 results in a precursor solution having a viscosity of about 500 cP at 25° C. or less, such as about 550 cP at 25° C. or less.

After preparing the precursor in step 302, the method 300 includes, at step 304, coating or impregnating one or more reinforcement structures with the precursor prepared in step 302. In an example, step 304 can include coating the fibers of a fibrous reinforcement structure, such as by impregnating a preformed fibrous structure with the precursor solution. In another example, step 304 can include applying a coating or layer of the precursor solution onto the reinforcement structure, such as by casting a precursor layer on a support like the substrate 202, wherein the precursor layer can then form the polyetherimide layer 204 after polymerization of the precursor reagents is initiated. Coating or impregnating the precursor 304 can include any method capable of sufficiently coating surfaces of the reinforcement structures with a precursor solution or a precursor powder or of sufficiently impregnating the precursor solution or molten precursor into the reinforcement structure, e.g., into void spaces within the reinforcement structure. Examples of methods used for coating or impregnating the precursor 304 include, but are not limited to, methods that are similar to those used for infusion of thermosetting resins in the preparation of prepreg laminates for thermoset-based composites, such as dip-coating or spray coating and the like.

For a precursor powder, coating or impregnating the precursor 304 can include powder coating at least a portion of the reinforcement structures with the powder. In an example, one or more layers of reinforcement structures, such as one or more layers of fiber or fabric reinforcement, can be coated with precursor powder by uniformly or substantially uniformly spreading the powder onto a top surface of each reinforcement layer. In examples with multiple layers, such as multiple fabric layers, each reinforcement layer can have a corresponding layer of precursor powder uniformly applied thereto.

Coating or impregnating the precursor 304 with a powder precursor can also include heating the precursor powder so that at least a portion of the powder melts into a molten form that flows onto or into at least a portion of the reinforcement structures. In some examples, the heating that melts at least a portion of the precursor powder to form a molten precursor also at least partially polymerizes the precursor reagents from the precursor powder, so that, to a certain extent, coating or impregnating the precursor 304 is at least partially combined with the polymerization of the precursor reagents (described below). In the example described above with multiple reinforcement layers with precursor powder uniformly distributed on each reinforcement layer in an alternating manner, the powder can be heated and melted by compressing the reinforcement layers and the powder layers together and heating to the powder's melting point. In some examples, the melting and compression can be further assisted by vacuum to remove air voids. In some examples, the melting and compression can be carried out in an inert environment, such as in the presence of an inert gas, (e.g., nitrogen gas) to reduce or prevent the polyetherimide melt from oxidizing via reaction with oxygen in the air.

After coating or impregnating the precursor 304, the method 300 can include, at step 306, polymerizing the one or more precursor reagents, such as by polymerizing one or more anhydride reagents and one or more amine reagents, to form the polyetherimide matrix of the composite article. As a result of the polymerization 306, the reinforcement structures are at least partially embedded in the polyetherimide matrix formed by the polymerization 306.

In some examples, the polymerization 306 includes heating the precursor that is coated on or impregnated in the reinforcement structures. In some examples, heating the precursor reagents of the precursor above a reaction polymerization temperature initiates a polymerization reaction of the precursor reagents. In examples with a precursor solution, the heating also causes evaporation of at least a portion of the solvent that forms the precursor solution. In examples with a precursor powder, the heating can melt at least a portion of the powder so that the precursor reagents are brought into contact with one another in the liquid of the melt in addition to initiating polymerization of the one or more precursor reagents.

The actual temperature to which the one or more precursor reagents are heated in order to initiate the polymerization 306 depends on a number of factors, including, but not necessarily limited to, the relative concentrations of the precursor reagents in the precursor or a desired reaction rate during the polymerization 306. In some examples, the desired reaction rate is fast enough so that the growing polyetherimide polymer chains will be substantially structurally sound for at least temporary manipulation of the coated or impregnated reinforcement structures.

In some examples, the desired reaction rate is slow enough so that final polymerization does not occur immediately, which can allow for some additional flow and diffusion of molecules of the precursor reagents and of the intermediate polyetherimide polymer chains before full polymerization and solidification of the polyetherimide matrix. As described in more detail below, this diffusion and flow of the precursor reagents and intermediate polymer chains can provide for advantages in the final composite article. For example, the diffusion and flow can allow for better contact and wetting between the precursor reagents and/or the intermediate polymer chains and surfaces of the reinforcement structures, which in turn leads to better contact and wetting of the final polyetherimide matrix and a lower porosity of the final composite article. The diffusion and flow can provide for crosslinking within and between the polyetherimide polymer chains that form the polyetherimide matrix, resulting in a more uniform and monolithic polyetherimide matrix. The diffusion and flow can also provide for a stronger interaction between the precursor reagents and/or the intermediate polymer chains and reinforcement structures, which in turn can provide for stronger interaction between the final polyetherimide matrix and the reinforcement structures.

In some examples, the temperature to which the precursor is heated dictates the level of polymerization of the precursor reagents, e.g., by dictating a final weight-average molecular weight (M_{w}), or another molecular weight distribution, for the polyetherimide produced via the polymerization of the precursor reagents. In an example, the precursor is heated to a first relatively low temperature, such as about 120° C., which results in an intermediate oligomeric or moderately polymerized polyetherimide, such as one having a M_{w} of about 2000 grams per mole (g/mol). In the same example, the precursor can be subsequently heated to a second higher temperature, such as about 180° C., which allows the resulting polyetherimide to react to a greater extent and form larger polymer chains, such as a polymer network with a M_{w} of around 20,000 g/mol. In the same example, the precursor can then be heated to a final polymerization temperature, such as about 250° C. or about 300° C., and the final resulting polymer matrix can comprise a substantially fully polymerized polyetherimide, such as one having a M_{w} of at least about 50.000 g/mol, for example at least about 100,000 g/mol. In other words, in some examples the polymerization 306 includes heating the precursor to a first temperature to provide an intermediate polyetherimide coated on or impregnated in the reinforcement structures with a first M_{w}. In some examples, the polymerization 306 can further include, at a later time, further heating the intermediate polyetherimide to a second temperature that is higher than the first temperature, which further polymerizes the intermediate polyetherimide to form a final polyetherimide having a second M_{w} that is higher than the first M_{w}. The polymerization 306 can include additional intermediate heating steps at various intermediate temperatures between the first temperature and the second temperature to achieve various levels of polymerization (e.g., various values of M_{w}) between the intermediate polyetherimide and the final polyetherimide.

The precursor reagents in the precursor coated on or impregnated in the reinforcement structure can be partially polymerized to an intermediate molecular weight to partially set the precursor. The partially-polymerized precursor reagents can remain chemically reactive, e.g., in a “B-stage,” until a later time, when the reagents are polymerized to a larger molecular weight by further heating the B-stage polyetherimide to a higher temperature.

Intermediate polymerization of the precursor reagents, e.g., to an intermediate polyetherimide having an intermediate M_{w}, is also referred to as “B-staging” or “B-stage polymerization” and the intermediate polyetherimide can be referred to as a B-stage polyetherimide. In some examples where the polymerization 306 includes B-stage polymerization of the precursor reagents, the resulting B-stage polyetherimide can have an intermediate M_{w} of from about 2,000 g/mol to about 20.000 g/mol. In some examples, the polymerization 306 includes heating the precursor reagents to an intermediate temperature of from about 100° C. to about 150° C. to achieve a B-stage polyetherimide that is coated on or impregnated in the reinforcement structures. After the precursor reagents have been polymerized to a B-stage polyetherimide, then the polymerization 306 can include heating the B-stage polyetherimide to a second temperature that is higher than the first temperature to achieve a final polymerization and imidization that is greater than the B-stage polymerization. In an example, the polymerization 306 includes polymerizing the B-stage polyetherimide to form a final polyetherimide having a final M_{w} of at least about 50,000 g/mol, for example at least about 100,000, such as 150,000 g/mol or more. In some examples, the polymerization 306 includes heating the B-stage polyetherimide to a final polymerization temperature of at least about 250° C., such as from about 250° C. to about 380° C. to achieve a specified polymerization level and imidization to form the polyetherimide matrix of the composite article. In other examples, the intermediate B-stage polymerization step can be skipped, and the initial precursor can be heated directly to the final polymerization temperature in order to form the final polyetherimide having the desired final M_{w}.

Examples where the polymerization 306 includes heating the precursor to a first intermediate temperature to form a B-stage polyetherimide, followed by heating the B-stage polyetherimide to a second final temperature for final polymerization can allow for crosslinking within the final polyetherimide matrix. In some examples, the intermediate heating to a B-stage polyetherimide followed by final heating for final polymerization can allow for at least some molecular diffusion into the reinforcement structures. For example, molecules of the precursor reagents can diffuse from the bulk of the precursor solution or molten precursor powder onto surfaces of the reinforcement structures at the molecular level. The molecules of the precursor reagents can also, in some examples, diffuse into interior portions of the reinforcement structures. In part, this molecular diffusion can take place because of the lower viscosity of the precursor solution, the molten precursor powder, or the B-stage polymer.

In some examples, as the precursor is heated to polymerize the precursor reagents to form polyetherimide polymer chains, for example by heating to the intermediate temperature and polymerizing to form the B-stage polyetherimide, the polymer chains can grow down to the contacted surfaces of the reinforcement structures on a molecular level. In some examples, the polyetherimide polymer chains bond to one or more surfaces of a reinforcement structure by physical absorption or chemical covalent bonds, or both. In some examples, both the formation of polymer chains down to reinforcement structure surfaces on the molecular level and the formation of polymer chains across the matrix-reinforcement boundary could not have been achieved without molecular diffusion, which was not previously possible without a precursor comprising smaller molecular weight precursor reagents. In such examples, the resulting polyetherimide matrix can more fully contact and wet the surfaces of the reinforcement structures and, in some examples, can provide for a stronger chemical covalent bond and interaction between the reinforcement structure and the resulting polyetherimide matrix. In some examples, the B-stage polyetherimide matrix continues to partially flow onto or into the reinforcement structures because B-stage polymers can still allow for some fluid flow or diffusion, or both, which results in even more contact and interaction between the final polyetherimide matrix and the reinforcement structures.

In some examples, when the B-stage polyetherimide is further heated to the final polymerization temperature, the diffusion of molecules onto surfaces or into interiors of the reinforcement structures results in the formation of polymer chains down to the surfaces or across boundaries between the bulk polyetherimide matrix and the reinforcement structures. The formation of the polymer chains down to the reinforcement structure or diffusion, or both, across the layer boundaries can result in one or more of stronger interlayer strength for the part, and better overall part strength due to partially reduced void space around and in the reinforcement structures.

This advantage of improved contact and wetting of the reinforcement structures by the precursor solution or the molten polyetherimide powder, and in some examples of the molecular diffusion of the precursor reagents onto surfaces of or into interior portions of the reinforcement structures, is particularly pronounced when comparing polyetherimide composite articles prepared by the methods described herein with those prepared with solutions or melts of fully-polymerized or mostly fully polymerized polyetherimide. The considerably higher viscosities of fully-polymerized polyetherimide in a solution or the molten state, rather than precursor reagents in solution or in the molten state, mean that flow or diffusion of the polyetherimide polymer chain molecules to surfaces of reinforcement structures and diffusion of the long-chain polymer molecules into interiors of the reinforcement structures will be extremely unlikely if not impossible at operating temperatures that are practical for the purposes of preparing composite articles.

The heating of the precursor as part of the polymerization 306 can be performed by any heater or heating method that can be reasonably applied to the composite structure of the precursor coated on or impregnated into the reinforcement structures. Examples of heating methods used for the polymerization 306 include, but are not limited to, induction heating (such as electrical high-frequency induction heating), microwave heating, infrared (IR) heating, laser heating, or flow of a hot gas. In some examples, the heating includes preheating the reinforcement structures, at least to temperatures that the reinforcement structures can withstand without deformation or degradation. In some examples, at least a portion of the heating for the polymerization 306 includes heating the precursor directly while or immediately before coating or impregnating the reinforcement structure with the precursor. For example, the precursor can be heated with an in-line heater before the precursor is applied to the reinforcement structures. In an example where the precursor is preheated, the temperature to which the precursor is preheated can be below a temperature at which polymerization of the precursor reagents occurs, such that the precursor is still at an elevated temperature, but also so that the precursor reagents do not start forming intermediate polymer chains with increased viscosity compared to the precursor solution or the molten precursor powder. As noted above, higher viscosity can impede wetting and/or impregnation of the reinforcement structures by the precursor solution or the molten polyetherimide precursor powder.

In some examples, the polymerization 306 includes controlling one or more of the temperature, the pressure, or the environment experienced by the precursor. For example, a temperature control system (e.g., with one or more temperature sensors, one or more heaters or coolers, and one or more controllers), a pressure control system (e.g., with one or more pressure sensors, one or more pressure control devices such as a pressure pump or a vacuum, and one or more controllers), and an environmental control system (e.g., one or more devices to control the components of the environment, that is the air, around the precursor).

In an example, at least a portion of the polymerization 306 is performed under vacuum conditions. Application of a vacuum can allow volatilized solvent and gases to escape more easily and rapidly away from the polyetherimide matrix as it forms during the polymerization 306. In some examples, at least a portion of the polymerization 306 is performed in an inert or substantially inert environment to reduce, minimize, or prevent unwanted reaction by the precursor reagents, the polyetherimide matrix, the reinforcement structures, or any other structures of the composite article. In particular, an inert or substantially inert environment can reduce, minimize, or prevent oxidation of one or more components of the composite article due to oxygen present in the air around the composite article. In some examples, at least a portion of the polymerization 306 is performed under vacuum conditions and in an inert or substantially inert environment. In some examples, the inert or substantially inert environment comprises a nitrogen-rich environment, e.g., an environment comprising a high concentration of nitrogen. In some examples, the inert or substantially inert environment comprises an all-nitrogen or substantially all-nitrogen environment. In an example, it was found that performing the polymerization 306 in a nitrogen environment and under a low to mid degree of vacuum (e.g., a vacuum of from about 25 Torr to about 0.5 Torr) resulted in a higher M_{w} of the polyetherimide produced (in one example, an improvement of about 28%, from 70,000 grams/mole for the polymer produced under atmospheric pressure and composition to about 90,000 grams/mole for a polymer produced in the N₂ environment under vacuum) and a narrower molecular weight distribution (e.g., a polydispersity index of about 2.5 for the N₂ environment under vacuum versus about 3.0 for atmospheric pressure and air composition).

In an example, the method 300 includes forming the reinforcement structures into a specified, predetermined shape before coating or impregnating the reinforcement structures with the precursor, referred to as “preshaping the reinforcement structures 308” or simply “preshaping 308” for brevity. In some examples, the preshaping 308 can include arranging or shaping the reinforcement structures into a preformed shape. In examples where the reinforcement structures comprise fibrous reinforcement structures, the preshaping 308 can include arranging or shaping the fibrous reinforcement structures into a fiber preform. In some examples, as used herein, the term “fiber preform” refers to the fibrous reinforcement structures being arranged in a specified configuration prior to coating or impregnating the fibrous reinforcement structures with the precursor. In some examples, the preshaping 308 can include, but is not limited to, arranging or shaping the fibrous reinforcement structures into one or more of: a woven fabric, a unidirectional tape, a tailored fiber preform, a fiber layup structure, one or more wound filaments, an automatic tape laying structure, or a shaped fiber structure member.

FIGS. 4-8 show various examples of systems or composite structures demonstrating uses or advantages of the methods of forming a composite article using a precursor comprising precursor reagents, as described with respect to FIGS. 1-3.

FIG. 4 shows a schematic diagram of a system 400 for forming a polyetherimide sheet 402 from a precursor 404. Like the precursors described above with respect to the composite article 100, the composite sheet 200, and the method 300, the precursor 404 can comprise precursor reagents that can react in a polymerization reaction to form a polyetherimide in the form of the polyetherimide sheet 402. Like the examples described above, the precursor 404 can include a precursor solution or a precursor powder that includes the precursor reagents. In an example, the precursor reagents of the precursor 404 include at least one of anhydride reagents, amine reagents, or a reaction product of anhydride reagents and amine reagents.

General examples of anhydride reagents and amine reagents that can be used in the precursor 404, as well as methods of preparing the precursor 404 are described above with respect to the formation of the reaction product of the polyetherimide matrix 104 in the composite article 100 and in the description of the method 300. Specific details of some example anhydride reagents and amine reagents that can be used in the precursor 404 are described in more detail below.

In the example shown, the precursor 404 is applied as a relatively thin layer onto a support substrate 406. In an example, the precursor 404 is applied by casting a thin film of a precursor solution onto the support substrate 406. In an example, the precursor 404 is applied by dispensing a layer of a precursor powder onto the support substrate 406. In the example system 400, the precursor 404 is applied onto the support substrate 406 from a feed hopper 408. The precursor 404 is applied from the feed hopper 408 onto the support substrate 406 via gravity from a discharge port 410 of the feed hopper 408. In an example, a doctor blade 412 or other shaping structure is provided at the discharge port 410 to shape the precursor 404, for example by flattening out a precursor solution into a film or applying a layer of a precursor powder having substantially uniform thickness on the top surface of the support substrate 406.

Although the system 400 is shown and described in particular as applying a precursor solution onto the support substrate 406 by casting the precursor solution as a film on the support substrate 406, those of skill in the art will appreciate that other methods of applying the precursor 404 to the support substrate 406 can be used, including, but not limited to, spray coating, spin coating, spin casting, dip casting, or painting of a precursor solution or powder coating of a precursor powder.

After the precursor 404 has been applied to the support substrate 406, the system 400 polymerizes the precursor reagents present in the precursor 404 to form a polyetherimide shaped as a relatively thin, sheet-like polyetherimide matrix in the form of the polyetherimide sheet 402. As described above, for example with respect to the method 300, polymerization of the precursor reagents can be initiated by heating the precursor reagents, which can drive off at least a portion of the solvent used to form a precursor solution or can melt a precursor powder and can trigger a polymerization reaction for the precursor reagents. In the example system 400 shown, the precursor 404 is heated by passing the film or layer of the precursor 404 and the support substrate 406 through an oven 414. The oven 414 heats the precursor 404 in order to polymerize and imidize the precursor reagents. In some examples, after exiting the oven 414, the precursor reagents can be fully or substantially fully polymerized and imidized so that exiting the oven 414 is the polyetherimide sheet 402. In an example, the oven 414 includes a heating source, such as the heat lamps 416 that directs heating energy, such as infrared light, onto the precursor 404 in order to polymerize and imidize the precursor reagents in the precursor 404 to form the polyetherimide sheet 402. Subsequently, the polyetherimide sheet 402 can be further consolidated to provide for one or more of: improved strength, thickness dimensional control, surface aesthetics, or decoration. Examples of methods that can be used for further consolidation of the polyetherimide sheet 402 include, but are not limited to, calendaring or pressing, such as with a double-belt press.

In an example, the support substrate 406 can include a release layer or release liner so that the polyetherimide sheet 402 can be separated from the support substrate 406. In another example, the polyetherimide sheet 402 and the support substrate 406 that exit the system 400 can be the polyetherimide layer 204 and the substrate 202 of the composite sheet 200 described above with respect to FIG. 2. In other words, the system 400 can be one embodiment of a system that can form the composite sheet 200.

In some examples, the system 400 forms a polyetherimide sheet 402 that includes not only a polyetherimide, but also reinforcement structures that are at least partially embedded in the polyetherimide sheet 402 to provide the polyetherimide sheet 402 with enhanced properties, such as improved mechanical strength. In an example, the reinforcement structures comprise reinforcing fibers, such as discontinuous reinforcing fibers, referred to as chopped reinforcing fibers 418 with respect to system 400. In an example, the chopped reinforcing fibers 418 are incorporated into the polyetherimide sheet 402 by mixing the chopped reinforcing fibers 418 into the precursor 404 before the precursor 404 is applied onto the support substrate 406. In an example, the chopped reinforcing fibers 418 are fed directly into the feed hopper 408 where the chopped reinforcing fibers 418 are mixed with the precursor 404, e.g., by mixing the chopped reinforcing fibers 418 into a precursor solution or with a precursor powder, before the precursor 404 is applied onto the support substrate 406.

The system 400 provides for the preparation of a polyetherimide composite comprising a polyetherimide sheet 402 with chopped reinforcing fibers 418 at least partially embedded in the polyetherimide sheet 402. Prior systems have attempted to prepare composite films or sheets with embedded fibers by extrusion of a fully or nearly fully polymerized polymer in a molten form with reinforcing fiber mixed therein. However, extrusion with fibers intermixed with molten polymers were known to accelerate wear on nip rolls or other shaping structures in the system. This was problematic because nip rolls tend to be very expensive, particularly with high-molecular weight polymers like polyetherimides. In order to melt fully-polymerized, high-melting temperature polyetherimide and mix reinforcement fibers homogeneously within the polyetherimide melt, a twin-screw extrusion was typically required. However, this type of extrusion leads to extensive shearing of the materials during extrusion. This shearing during the extrusion tends to break the fibers down to short lengths, reducing their reinforcement benefits. High shearing within the extruder also tends to wear on the extruder screw elements and die. In short, previous attempts to make fiber-filled polyetherimide sheets were uneconomical and rare, if they occurred at all. Similar issues exist when attempting to use fully polymerized polyetherimide with fibrous reinforcement structures comprising long fibers, which are shaped by pultrusion methods, unidirectional tape placement, or filament winding because high temperatures are required to melt the polymer and maintain it in liquid form, and even when the polyetherimide was successfully melted, impregnation and fiber wetting was often insufficient due to high viscosity of the melt.

The present system 400 allows for the formation of a fiber-reinforced polyetherimide composite because the chopped reinforcing fibers 418 need not extruded through an extrusion die along with a molten fully-polymerized polyetherimide. The chopped reinforcing fibers 418 also need not be passed over nip rolls and other structures under high pressure so that wear will be increased. Rather, the chopped reinforcing fibers 418 are applied along with a precursor 404 by application methods such as casting, spray coating, dip coating, dry blending and the like. In examples where the precursor 404 comprises a solution, the precursor solution into which the chopped reinforcing fibers 418 is mixed has a much lower viscosity than a corresponding melt of a polymerized polyetherimide extruded from an extrusion die. The precursor material 404 can also applied at much lower temperatures compared to typical extrusion temperatures because the precursor 404 is ether already a liquid (if in solution form) or can be melted at relatively lower temperatures to flow easily (if in powder form). This allows the precursor 404, along with the chopped reinforcing fibers 418 mixed therein, to be applied and spread into a thin film, layer, or sheet much easier and with less force than with extrusion, so that wear on parts of the system 400 is less likely and will take place over a longer period of time than has been the case with extrusion of fiber-filled polymer sheets.

The system 400 also allows for the formation of a multilayer structure, e.g., a polyetherimide sheet 402 applied on a support substrate 406, regardless of the type of material that makes up the support substrate 406. This solves a problem associated with extrusion of multi-material sheets, which requires that the different materials that form the multi-material sheet have similar rheological properties in order to coextrude the different materials together. The system 400 does not require the material of the support substrate 406 to have rheological properties that are similar to those of the precursor 404 or the polymerized polyetherimide sheet 402. Rather, the support substrate 406 can be a pre-formed structure onto which the precursor 404 is applied, e.g., cast or otherwise dispensed, and then polymerized, e.g., in the oven 414 to form the polyetherimide sheet 402 on the support substrate 406, whether the material of the support substrate 406 would be extrusion-compatible with the polyetherimide material of the polyetherimide sheet 402 or not.

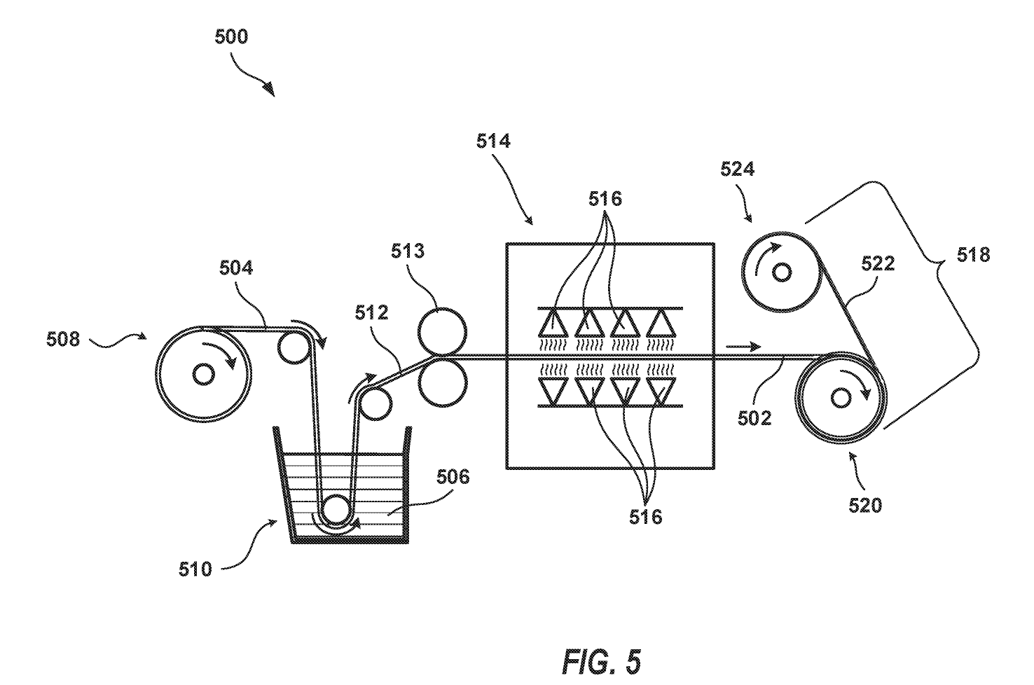

FIG. 5 shows a schematic diagram of an example system 500 for forming a preimpregnated polyetherimide composite intermediate, also referred to herein as a “polyetherimide prepreg 502” or simply as “prepreg 502.” The polyetherimide prepreg 502 includes a preformed support structure 504, which will be referred to herein as the “preform 504.” In an example, the preform 504 comprises one or more fibrous reinforcement structures arranged in a predetermined configuration or shape, and as such will also be referred to herein as a “fiber prefrom 504.” In an example, the fiber preform 504 comprises an elongated structure, such as a woven or non-woven fabric or a unidirectional tape, which can be continuously or semi-continuously fed through the system 500.

The fiber preform 504 is at least partially impregnated with a precursor 506. The precursor 506 can be identical or substantially identical to the precursor solutions described above. For example, the precursor 506 can comprise a precursor with one or more precursor reagents in a solvent, or the precursor 506 can comprise a molten precursor such as one formed by melting a precursor powder of the one or more precursor reagents. As described above, when formed as a precursor solution, the one or more precursor reagents of the precursor 506 can comprise one or more anhydride reagents in the solvent, one or more amine reagents in the solvent, or a reaction product of one or more anhydride reagents and one or more amine reagents in the solvent, or any combination thereof. When formed as a molten precursor, the precursor 506 can include a molten form of one or more anhydride reagents, one or more amine reagents, or a reaction product of one or more anhydride reagents and one or more amine reagents, or any combination thereof. Further details regarding anhydride reagents, amine reagents, and the solvent are described with respect to the example composite article 100 and the example method 300.

In an example, the fiber preform 504 is fed from a preform feed apparatus, such as a preform feed spool 508, which feeds the fiber preform 504 to a precursor bath 510 that is holding the precursor 506. The fiber preform 504 is routed through the precursor bath 510 so that the fiber preform 504 is partially or completely submerged in the precursor bath 510. This allows the precursor 506 to at least partially diffuse or otherwise transfer into the fiber preform 504 such that the fiber preform 504 is at least partially impregnated with the precursor 506 so that a precursor impregnated preform 512 exits the solution bath 510.

The precursor impregnated preform 512 is then fed through an oven 514 that heats the precursor impregnated preform 512 and initiate polymerization of the precursor reagents in the precursor 506 impregnated in the precursor impregnated preform 512. In an example, the precursor impregnated preform is fed through a pair of nip rolls 513 that can further squeeze the precursor 506 into the precursor impregnated preform 512. The nip rolls 513 can also separate excess precursor 506 from the precursor impregnated preform 512, which can be fed back into the precursor bath 510. Structures other than nip rolls can be used for one or both of these functions, such as, but not necessarily limited to, doctor blades or press that receives and periodically clamps onto the precursor impregnated preform 512.

The oven 514 heats the precursor impregnated preform 512 to an intermediate temperature that will partially polymerize the precursor reagents impregnated in the precursor impregnated preform 512, but not fully polymerize the precursor reagents. As used herein. “partially polymerize,” when referring to the extent of polymerization of the precursor reagents in the precursor impregnated preform 512 when in the oven 514, can refer to only a portion of the molecules of precursor reagents having been fully converted to polyetherimide polymer chains of a substantially length. Reaction of the molecules of the precursor reagents to an oligomeric intermediate reaction product, also referred to as a B-stage intermediate, will still be considered only partially polymerized for the purpose of the system 500. In an example, the oven 514 includes a heating source, such as heat lamps 516 that direct heating energy, such as infrared light, onto the precursor impregnated preform 512. The heating energy heats the precursor impregnated preform 512 to a temperature that will at least partially polymerize the precursor reagents to form an oligomeric intermediate reaction product of the precursor reagents impregnated or partially impregnated in the fiber preform 504, e.g., an oligomeric intermediate reaction product of anhydride reagents and amine reagents.

The formation of the oligomeric intermediate reaction product that is impregnated or partially impregnated in the fiber preform 504 results in the formation of the prepreg 502 that exits the oven 514. The prepreg 502 can be sent to a prepreg finishing apparatus 518, which can include rolling the prepreg 502 up onto a prepreg product spool 520. The prepreg finishing apparatus 518 can also supply a release liner 522 to the prepreg product spool 520, such as from a liner feed spool 524, so that the prepreg 502 can be rolled up with the release liner 522. The release liner 522 can allow the prepreg 502 to be stored and deployed when needed during fabrication of a structure, such as a layup structure or some other structure where the prepreg 502 will be used. After being placed in its final location, perhaps after additional modification or conditioning, the prepreg 502 can be heated to a final polymerization temperature to complete the polymerization of the precursor reagents to form a fully polymerized or substantially fully polymerized polyetherimide impregnated or partially impregnated in the fiber preform 504.

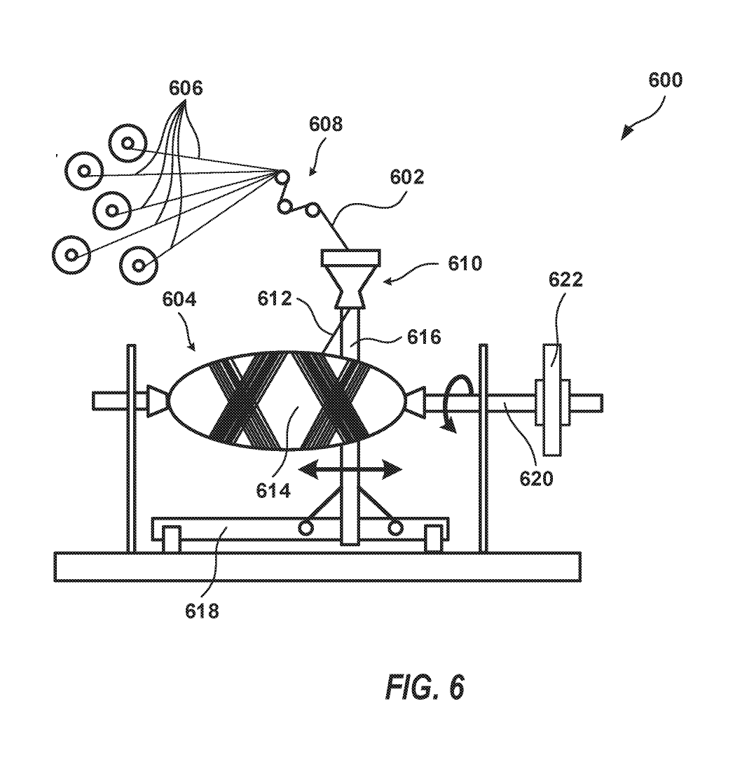

FIG. 6 shows a schematic diagram of a system 600 for winding a filament 602 around a molding or shaping structure, such as a mandrel 604. The system feeds one or more fiber rovings 606 that are wound or woven together by a tensioner 608 to form the filament 602. The filament 602 is then fed through a precursor bath 610 (i.e., a bath 602 of a precursor solution or a molten precursor, such as melted precursor powder). The precursor at least partially coats or impregnates the filament 602 to provide an impregnated filament 612.

The impregnated filament 612 is continuously fed to the mandrel 604 where the impregnated filament 612 is wound around an outer surface 614 of the mandrel 604. In an example, a shuttle 616 moves the impregnated filament 612 back and forth (e.g., left to right in FIG. 6) so that the impregnated filament 612 will be uniformly or substantially uniformly wound around the mandrel 604 so that the final part made by the system 600 will have a substantially uniform thickness. The shuttle 616 can be configured to move in a specified patterns so that the impregnated filament 612 will be wound onto the mandrel 604 in a specified pattern. The shuttle 616 can be moved along a track 618, and the movement of the shuttle 616 can be controlled, for example, by a computer control system. The shuttle 616 and the track 618 can also be configured to move the impregnated filament 612 in other directions relative to the mandrel 604, such as up and down in or forward and backward (e.g., into and out of the page in FIG. 6).

The mandrel 604 is continuously or substantially continuously rotated to wind the impregnated filament 612 up onto the outer surface 614 of the mandrel 604. In an example, the mandrel 604 is mounted to an axle 620 that is driven by a motor 622. After a specified amount of the impregnated filament 612 has been wound onto the mandrel 604 in a specified pattern, the mandrel 604 can be heated, for example to an intermediate polymerization temperature, e.g., a B-stage, or the mandrel 604 can be heated to a temperature that will for complete or substantially complete polymerization of precursor reagents impregnated on the precursor impregnated preform 512, forming a completed composite part. The composite part can then be removed from the mandrel 604 and the system 600 can be used again with a new filament 602.

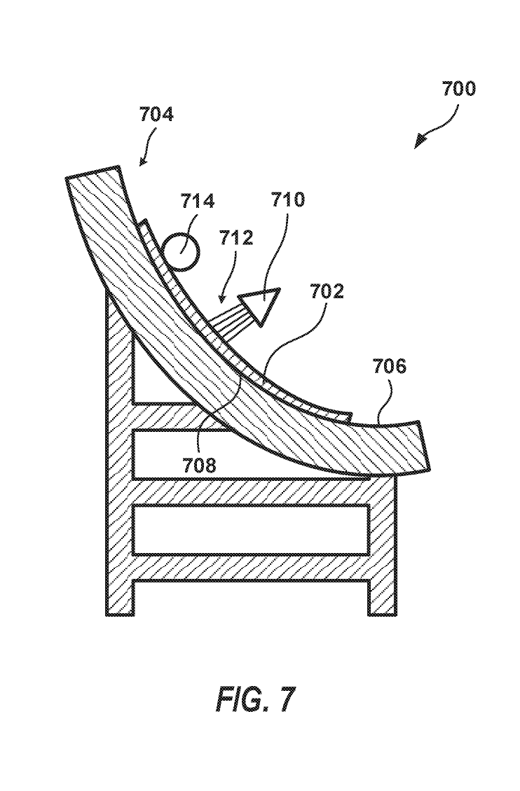

FIG. 7 shows a cross-sectional view of a system 700 for applying a polyetherimide composite intermediate 702 to a non-uniform and non-flat surface or surfaces in a process that is usually referred to as “layup” of the prepreg. In an example, the polyetherimide composite intermediate 702 is a preimpregnated composite intermediate, referred to as the “polyetherimide prepreg 702” or simply “prepreg 702” which can be the same or substantially the same as the prepreg 502 fabricated by the prepreg system 500 described above.

The prepreg 702 is applied to a mold 704. In an example, the prepreg 702 is applied to a non-uniform surface 706. e.g., a surface that is non-rectangular, non-planar, or both. The partially polymerized form of the precursor reagents in the prepreg 702 allows the prepreg 702 to be shaped to the non-uniform surface 706 so that a corresponding mating surface 708 on the prepreg 702 will have substantially the same profile as the non-uniform surface 706, although in reverse (e.g., if some features of the non-uniform surface 706 are concave, as in the example mold 704 shown, the corresponding mating surface 708 will be convex).

In an example where the prepreg 702 is used for tape placement, in order to soften and adhere the tape to the substrate surface and continuous complete the polymerization, a heating source can be used, such as an electrical heater assisted with laser heating, an infrared heater, an ultrasonication heater, or similar devices. The heat can be applied to the mating surface 708 of the prepreg 702 imminently before laying the mating surface 708 on the non-uniform surface 706.

In some examples, rather than a preimpregnated fiber preform structure like the prepreg 702, a non-impregnated or only partially impregnated fiber preform can be applied in place of the prepreg 702, and a precursor applicator 710 (shown as a sprayer in FIG. 7) can pass over the non-impregnated or partially impregnated fiber preform and apply a precursor 712 (e.g., a precursor solution or molten precursor, as described above) so that the precursor 712 will at least partially coat or impregnate the fiber preform. In other words, the precursor applicator 710 will turn the non-impregnated fiber preform into an at least partially coated or impregnated prepreg, e.g., into the prepreg 702.

A shaping or compressing structure, such as a roller 714, can be used to press or otherwise shape the prepreg 702 to the mold 704 so that the mating surface 708 of the prepreg 702 will match or substantially match the non-uniform profile of the non-uniform surface 706.

In some examples, the system 700 can be a manually operated system, also referred to as a “hand layup” system, where the prepreg 702 is applied to the non-uniform surface 706 of the mold 704, the precursor solution 712 is applied with the precursor solution applicator 710, and the roller 714 are operated by hand. In other examples, the system 700 can be an automated system, also referred to as an “automatic fiber placement” (AFP) or an “automatic tape laying” (ATL) system.

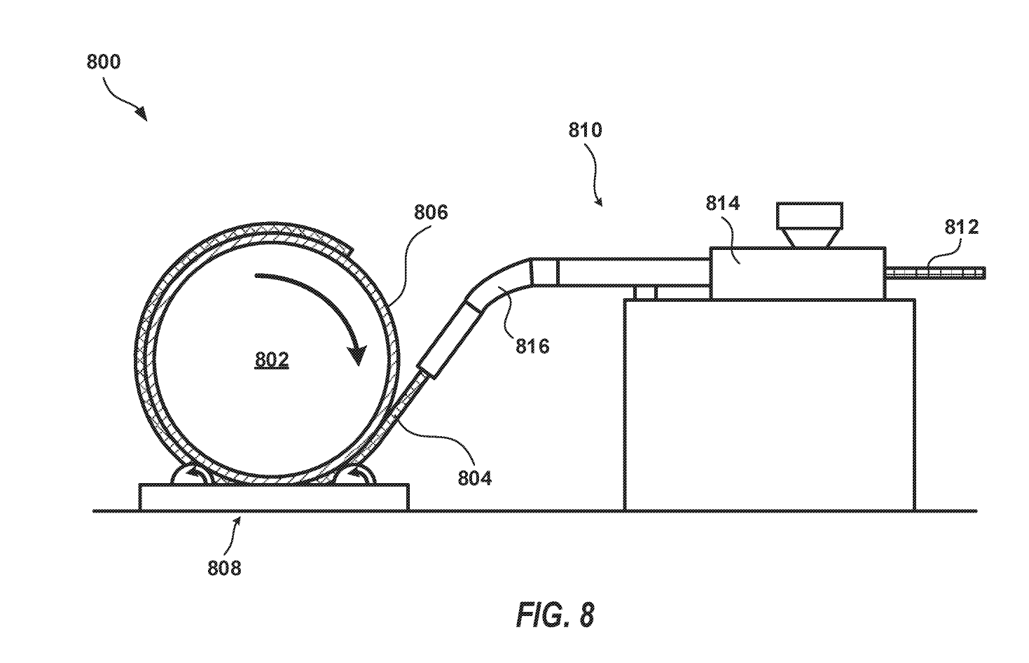

FIG. 8 is a schematic diagram of an example system 800 for applying a polyetherimide composite onto a pipe 802, such as a large-scale pipe 802 for the oil and gas industry. The polyetherimide composite applied to the pipe 802 can act to reinforce, strengthen, or otherwise protect the pipe 802 during use.

The system 800 feeds and applies a prepreg reinforcement 804 to an outer surface 806 of the pipe 802. The prepreg reinforcement 804 can be similar or identical to the prepreg 502 fabricated by the system 500. As the prepreg reinforcement 804 is fed to the outer surface 806 of the pipe 802, a turning mechanism 808 rotates the pipe 802 so that the prepreg reinforcement 804 will be wrapped around the outer surface 806. Once the prepreg reinforcement 804 has been wrapped around the desired portion of the pipe 802, the prepreg reinforcement 804 can be cut and the prepreg reinforcement 804 on the pipe 802 can be heated to polymerize the precursor reagents to form a fully polymerized polyetherimide reinforcement.

In an example, the system 800 includes a reinforcement feed system 810 that receives a fiber preform 812, converts it into the prepreg reinforcement 804, and delivers the prepreg reinforcement 804 to the pipe 802 for application to the outer surface 806. In an example the fiber preform 812 enters a precursor reservoir 814. The fiber preform 812 is at least partially impregnated with a precursor (e.g., a precursor solution or a molten precursor as described above) in the precursor reservoir 814 to form the prepreg reinforcement 804. A prepreg feed channel 816 delivers the prepreg reinforcement 804 to the outer surface 806 of the pipe 802.

### Materials for Polyetherimide Composite Articles

In some examples, the systems and methods described above with respect to the figures are performed using at least some the following materials. As described above, the systems and methods described herein provide for composite structures including a polyetherimide comprising one or more polyetherimide precursor reagents. In some examples, the one or more precursor reagents include one or more anhydride precursor reagents, one or more amine precursor reagents, or a reaction product of one or more anhydride precursor reagents and one or more amine precursor reagents, or a combination therefore.

In some examples, the polyetherimide precursor comprises a solution of the precursor reagents in one or more solvents (or simply “solvent”), also referred to herein as a precursor solution. In some examples, a precursor solution is formed with a solvent other than harsh organic solvents to solubilize the one or more precursor reagents. For example, the systems and methods described herein can form high-quality polyetherimide matrices in composite articles without or substantially without aprotic solvents or solvents having a boiling point greater than 150° C., such as tetrahydrofuran, halogenated solvents, such as methylene chloride, chloroform, dichlorobenzene and hexafluoro-2-propanol (HFIP), or solvents having a boiling point greater than 150° C., such as N-methyl pyrrolidone, dimethyl sulfoxide, dimethyl acetamide, dimethyl formamide, sulfolane, anisole, cyclopentanone, or cyclohexanone. Solvents such as water and aliphatic alcohols (e.g., methanol and ethanol) are preferred. One or more amine additives can also be added to the precursor solution, which can allow for effective dissolution of the precursor compounds in mild solvents, such as a C₁₋₆ alcohol, a mixture of a C₁₋₆ alcohol and water, or in water. Other additives can also be included, such as a nonionic aprotic surfactant such as triethylamine (TEA) or the like can be used to increase solubility of the one or more precursor reagents and to stabilize the precursor solution for a longer shelf-life, e.g., up to six months at room temperature.

Polyetherimides formed from the precursor solution can be formed in the absence of a chain-stopping agent, allowing high-M_{w} polyetherimides to be obtained. However, in some examples, a chain-stopping agent may be used. Other components, such as crosslinkers, particulate fillers, and the like can be present.

Anhydride Precursor Reagent

In an example, the one or more anhydride reagents comprise a substituted or unsubstituted C₄₋₁₀ anhydride. In some examples, the one or more anhydride reagents comprise a bisanhydride reagent having the general formula (1)

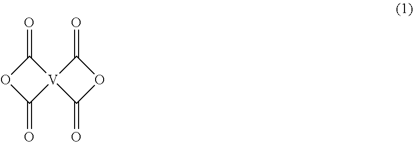

wherein V is a substituted or unsubstituted tetravalent C₄₋₄₀ hydrocarbon group, for example a substituted or unsubstituted C₆₋₂₀ aromatic hydrocarbon group, a substituted or unsubstituted, straight or branched chain, saturated or unsaturated C₂₋₂₀ aliphatic group, or a substituted or unsubstituted
C₄₋₈ cycloalkylene group or a halogenated derivative thereof, in particular a substituted or unsubstituted C₆₋₂₀ aromatic hydrocarbon group. Exemplary aromatic hydrocarbon groups include, but are not limited to, any of the following structures

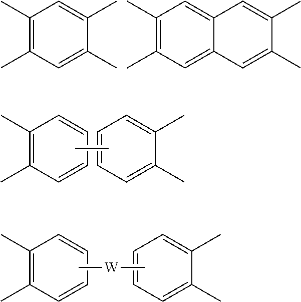

wherein W is —O—, —S—, —C(O)—, —SO₂—, —SO—, —C_{y}H_{2y}—, wherein y is an integer from 1 to 5 a halogenated derivative thereof (which includes perfluoroalkylene groups), or a group of the formula T as described in formula (2) below.

In some examples, the one or more anhydride reagents comprise an aromatic bis(ether anhydride) of formula (2)

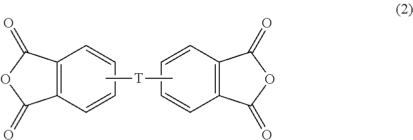

wherein T is —O— or a group of the formula —O—Z—O— wherein the divalent bonds of the —O— or the —O—Z—O— group are in the 3,3′, 3,4′, 4,3′, or the 4,4′ positions. The group Z in —O—Z—O— of formula (2) can also be a substituted or unsubstituted divalent organic group, and can be an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded. Exemplary groups Z include groups derived from a dihydroxy molecule having the general formula (3)

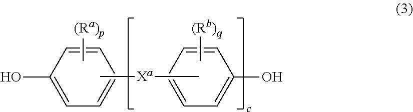

wherein R^{a} and R^{b} can be the same or different and are a halogen atom or a monovalent C₁₋₆ alkyl group, for example; p and q are independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —SO₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ is organic bridging group. A specific example of a group Z is a divalent group of formula (3a)

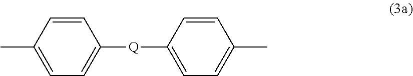

wherein Q is —O—, —S—, —C(O)—, —SO₂—, —SO—, or —C_{y}H_{2y}— wherein y is an integer from 1 to 5 or a halogenated derivative thereof (including a perfluoroalkylene group). In a specific embodiment Z is derived from bisphenol A, such that Q in formula (3a) is 2,2-isopropylidene.

Specific examples of anhydride reagents include, but are not limited to, 3,3-bis[4-(3,4-dicarboxyphenoxy)phenyl]propane bisanhydride; 4,4′-bis(3,4-dicarboxyphenoxy)diphenyl ether bisanhydride; 4,4′-bis(3,4-dicarboxyphenoxy)diphenyl sulfide bisanhydride; 4,4′-bis(3,4-dicarboxyphenoxy)benzophenone bisanhydride; 4,4′-bis(3,4-dicarboxyphenoxy)diphenyl sulfone bisanhydride; 2,2-bis[4-(2,3-dicarboxyphenoxy)phenyl]propane bisanhydride; 4,4′-bis(2,3-dicarboxyphenoxy)diphenyl ether bisanhydride; 4,4′-bis(2,3-dicarboxyphenoxy)diphenyl sulfide bisanhydride; 4,4′-bis(2,3-dicarboxyphenoxy)benzophenone bisanhydride; 4,4′-bis(2,3-dicarboxyphenoxy)diphenyl sulfone bisanhydride; 4-(2,3-dicarboxyphenoxy)-4′-(3,4-dicarboxyphenoxy)diphenyl-2,2-propane bisanhydride; 4-(2,3-dicarboxyphenoxy)-4′-(3,4-dicarboxyphenoxy)diphenyl ether bisanhydride; 4-(2,3-dicarboxyphenoxy)-4′-(3,4-dicarboxyphenoxy)diphenyl sulfide bisanhydride; 4-(2,3-dicarboxyphenoxy)-4′-(3,4-dicarboxyphenoxy)benzophenone bisanhydride; and, 4-(2,3-dicarboxyphenoxy)-4′-(3,4-dicarboxyphenoxy)diphenyl sulfone bisanhydride, pyromellitic dianhdride, hydrogenated pyromellitic dianhydride, oxydianhydride, cyclobutane tetracarboxylic dianhydride, and combinations thereof.

The one or more anhydride reagents can be in particulate (e.g., powder) form. In an example, a powder of the one or more anhydride reagents can have D100 of 100 μm or less, such as 75 μm or less, for example 45 μm or less. As used herein “D100” means that 100% of the particles have a size distribution less than or equal to the named value. In some examples, the particles have can have a particle size of 0.01 to 100 μm, 0.01 to 75 μm, or 0.01 to 45 μm. A bimodal, trimodal, or higher particle size distribution can be used.

Amine Precursor Reagent

In some examples, the one or more amine reagents comprise a diamine molecule having the general formula (4)

H₂N—R—NH₂ (4)

wherein R is a substituted or unsubstituted divalent C₁₋₂₀ hydrocarbon group, e.g., a substituted or unsubstituted C₆₋₂₀ aromatic hydrocarbon group or a halogenated derivative thereof, a substituted or unsubstituted, straight or branched chain, saturated or unsaturated C₂₋₂₀ alkylene group or a halogenated derivative thereof, or a substituted or unsubstituted C₃₋₈ cycloalkylene group or halogenated derivative thereof. In an example, R is one of the divalent groups of formula (5)

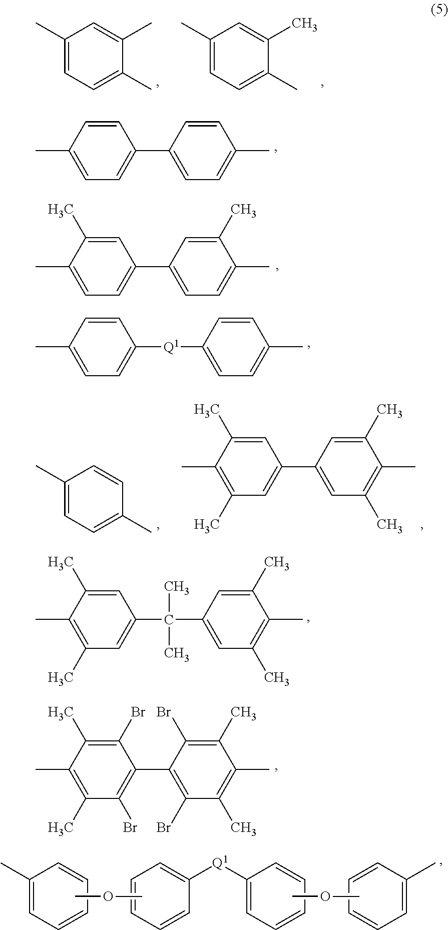

wherein Q¹ is —O—, —S—, —C(O)—, —SO₂—, —SO—, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In some examples, R is meta-phenylene, para-phenylene, or 4,4′-diphenylene sulfone. In some examples, no R groups contain sulfone groups. In another embodiment, at least 10 mol. % of the R groups contain sulfone groups, for example 10 to 80 wt % of the R groups contain sulfone groups, in particular 4,4′-diphenylene sulfone groups.

Specific examples of organic diamines that can be used as an amine reagent include, but are not limited to, ethylenediamine, propylenediamine, trimethylenediamine, diethylenetriamine, triethylene tetramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis(3-aminopropyl)amine, 3-methoxyhexamethylenediamine, 1,2-bis(3-aminopropoxy)ethane, bis(3-aminopropyl)sulfide, 1,4-cyclohexanediamine, bis-(4-aminocyclohexyl)methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylenediamine, 5-methyl-4,6-diethyl-1,3-phenylenediamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1,3-diamino-4-isopropylbenzene, bis(4-aminophenyl) sulfide, and bis(4-aminophenyl) ether, adamantine diamine, oxydianiline, and combinations thereof. The organic diamine can comprise m-phenylenediamine, p-phenylenediamine, 4,4′-sulfonyl dianiline, or combinations thereof.

In an example, the one or more aromatic bisanhydride reagents of formula (1) or (2) are reacted with one or more diamine reagents comprising one or more organic diamines of formula (4) as described above, and a polysiloxane diamine of formula (6)

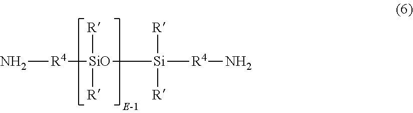

wherein each R′ is independently a C₁₋₁₃ monovalent hydrocarbyl group. For example, each R′ can independently be a C₁₋₁₃ alkyl group, C₁₋₁₃ alkoxy group, C₂₋₁₃ alkenyl group, C₂₋₁₃ alkenyloxy group, C₃₋₆, cycloalkyl group, C₃₋₆ cycloalkoxy group. C₆₋₁₄ aryl group, C₆₋₁₀ aryloxy group, C₇₋₁₃ arylalkyl group, C₇₋₁₃ arylalkoxy group, C₇₋₁₃ alkylaryl group, or C₇₋₁₃ alkylaryloxy group. The foregoing groups can be fully or partially halogenated with fluorine, chlorine, bromine, or iodine, or a combination comprising at least one of the foregoing. In some examples, no halogens are present. Combinations of the foregoing R′ groups can be used in the same copolymer. In some examples, the polysiloxane diamine comprises R′ groups that have minimal hydrocarbon content, e.g., methyl groups.

In an example, E in formula (6) has an average value of 5 to 100, and each R⁴ is independently a C₂₋₂₀ hydrocarbon, in particular a C₂₋₂₀ arylene, alkylene, or arylenealkylene group. In some examples, R⁴ is a C₂₋₂₀ alkyl group, specifically a C₂₋₂₀ alkyl group such as propylene, and E has an average value of 5 to 100, 5 to 75, 5 to 60, 5 to 15, or 15 to 40. Procedures for making the polysiloxane diamines of formula (6) are well known in the art.

In an example, the one or more amine reagents include 10 to 90 mole percent (mol %), or 20 to 50 mol %, or 25 to 40 mol % of polysiloxane diamine (5) and 10 to 90 mol %, or 50 to 80 mol %, or 60 to 75 mol % of diamine (4). The diamine reagents can be physically mixed prior to reaction with the bisanhydride reagents, thus forming a substantially random copolymer. Block or alternating copolymers can be formed by selective reaction of (4) and (6) with aromatic bis(ether anhydride)s (1) or (2), to make polyetherimide blocks that are subsequently reacted together. Thus, the polyetherimide-siloxane copolymer can be a block, random, or graft copolymer.

The precursor reagents (e.g., the one or more anhydride precursor reagents or the one or more amine reagents, or both) can be in particulate (e.g., powder) form. In some examples, a precursor reagent powder can have D100 of 100 μm or less, 75 μm or less, or 45 μm or less. As used herein “D100” means that 100% of the particles have a size distribution less than or equal to the named value. In some examples, the particles can have a particle size of 0.01 to 100 μm, 0.01 to 75 μm, or 0.01 to 45 μm. The precursor reagent powder can have a bimodal, trimodal, or higher particle size distribution. The one or more precursor reagents can be present in the particulates separately (e.g., first particles comprising anhydride reagents and second particles comprising amine reagents) or as a mixture (e.g., particles comprising a combination of anhydride and amine reagents). The one or more precursor reagents can be reduced to the specified particle size by methods known in the art, for example grinding and sieving. Other milling techniques are known, for example jet milling, which subjects the particles to a pressurized stream of gas and particle size is reduced by interparticle collisions.

The relative ratios of the one or more anhydride reagents relative to the one or more amine reagents (either the relative ratio of the precursor reagent powders, or the relative ratio of the precursor regents in the prepolymer powder) can be varied depending on specified properties of the polyetherimides. Use of an excess of either precursor reagent can result in a polymer having functionalized end groups. For example, a mole ratio of the anhydride reagents to the amine reagents can be from about 2:1 to about 1:2, for example from about 1.3:1 to about 1:1.3, preferably from about 0.95:1 to about 1:0.95. In some examples, a mole ratio of the anhydride reagents to the amine reagents can be from about 1:1 to about 1:1.3, preferably from about 1:1 to about 1:1.2 or from about 1:1 to about 1:1.1. In another embodiment, a mole ratio of the amine reagents to the anhydride reagents is from about 1:1 to about 1:1.3, preferably from about 1:1 to about 1:1.2 or from about 1:1 to about 1:1.1.

Polyetherimide Prepolymer

In some examples, a polyetherimide prepolymer can be a reaction product of the anhydride reagents and the amine reagents as described above, such as a reaction product between a substituted or unsubstituted C₄₋₄₀ anhydride and a substituted or unsubstituted C₁₋₂₀ amine. The polyetherimide prepolymer can be put into a particulate form, e.g., to form a precursor powder, or can be used to form a precursor solution or gel.

The prepolymer can be formed by reacting one or more anhydride reagents, such as one or more of the bisanhydride reagents described above, with one or more amine reagents, such as one or more of the diamine reagents described above. In some examples, the precursor comprises more than 1, for example 10 to 1000, or 10 to 500, structural units of formula (7)

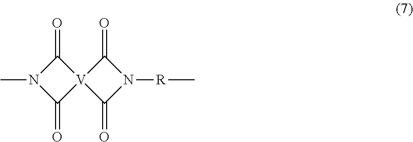

wherein each V is the same or different, and is as defined as in formula (1), and each R is the same or different, and is defined as in formula (4). The resulting polyetherimide can comprise more than 1, for example 10 to 1000, or 10 to 500, structural units of formula (8)

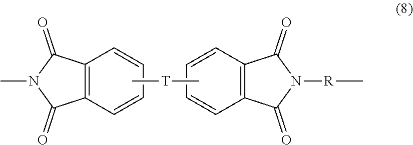

wherein each T is the same or different, and is as described in formula (2), and each R is the same or different, and is as described in formula (4), preferably m-phenylene or p-phenylene.

The polyetherimides can optionally further comprises up to 10 mole %, up to 5 mole %, or up to 2 mole % of units of formula (8) wherein T is a linker of the formula (9)

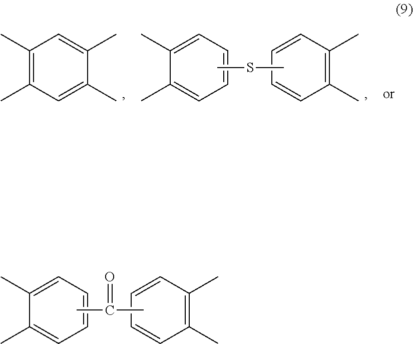

In some examples no units are present wherein R is of these formulas.

In some examples in formula (7) or (8), R is m-phenylene or p-phenylene and T is —O—Z—O— wherein Z is a divalent group of formula (3a). Alternatively, R can be m-phenylene or p-phenylene and T is —O—Z—O wherein Z is a divalent group of formula (3a) and Q is 2,2-isopropylidene.

In some examples, the polyetherimide can be a polyetherimide sulfone. For example, the polyetherimide can comprise the etherimide units wherein at least 10 mole percent, for example 10 to 90 mole percent, 10 to 80 mole percent, 20 to 70 mole percent, or 20 to 60 mole percent of the R groups comprise a sulfone group. For example, R can be 4,4′-diphenylene sulfone, and Z can be 4,4′-diphenylene isopropylidene, providing units of formula (10).

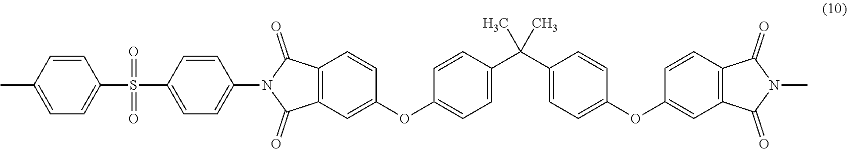

In another embodiment, the polyetherimide can be a polyetherimide-siloxane block or graft copolymer. Polyetherimide-siloxane block copolymers comprise etherimide units and siloxane blocks in the polymer backbone. Polyetherimide-siloxane block copolymers comprise etherimide units and siloxane blocks in the polymer backbone. The imide or etherimide units and the siloxane blocks can be present in random order, as blocks (i.e., AABB), alternating (i.e., ABAB), or a combination thereof. Graft copolymers are non-linear copolymers comprising the siloxane blocks connected to a linear or branched polymer backbone comprising imide or etherimide blocks.

In some examples, a polyetherimide-siloxane copolymer has units of the formula

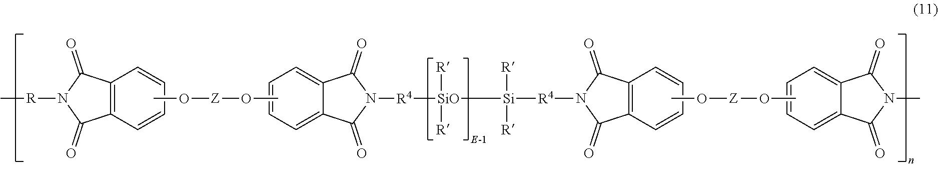

wherein R′, R⁴, and E of the siloxane are as in formula (6), R is as in formula (4), Z is as in formula (2), and n is an integer from 5 to 100. In a specific embodiment, the R of the etherimide is a phenylene, Z is a residue of bisphenol A, R⁴ is n-propylene, E is 2 to 50, 5 to 30, or 10 to 40, n is 5 to 100, and each R′ of the siloxane is methyl. In some examples the polyetherimide-siloxane comprises 10 to 50 weight %, 10 to 40 weight %, or 20 to 35 weight % polysiloxane units, based on the total weight of the polyetherimide-siloxane.

The polyetherimide prepolymer can comprise partially reacted units of formulas (q) and (r) or fully reacted units of formula (s).

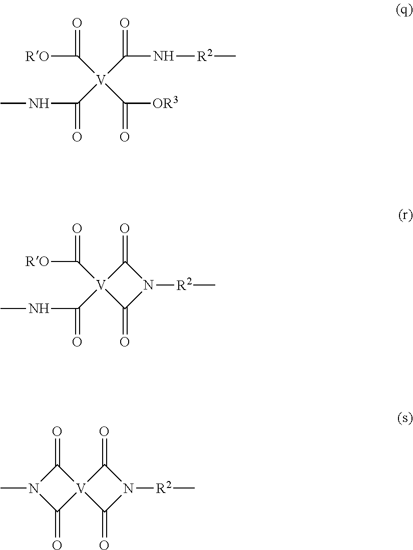

wherein V in the formulas (q), (r), and (s) is as defined above for formula (1). Each of R¹, R², and R³ in the formulas (q), (r), and (s) are defined the same as R in formula (4), and each of R¹, R², and R³ can be the same group as one or both of the other two or a different group from one or both of the other two. The polyetherimide prepolymer contains at least one unit (q), 0 or 1 or more units (r), and 0 or 1 or more units (s), for example 1 to 200 or 1 to 100 units q, 0 to 200 or 0 to 100 units (r), or 0 to 200 or 0 to 100 units (s). An imidization value for the polyetherimide prepolymer can be determined using the relationship (2s+r)/(2q+2r+2s), wherein q, r, and s stand for the number of units (q), (r), and (s), respectively. In some examples, the imidization value of the polyetherimide prepolymer is less than or equal to 0.2, less than or equal to 0.15, or less than or equal to 0.1. In some examples, the polyetherimide prepolymer has an imidization value of greater than 0.2, for example greater than 0.25, greater than 0.3, or greater than 0.5, provided that the specified solubility of the polyetherimide prepolymer is maintained. The number of units if each type can be determined by spectroscopic methods, for example FT-IR.

Solvent

In examples where the polyetherimide precursor comprises a solution, the precursor solution can include one or more solvent compounds (or simply “solvent”), e.g., to dissolve the one or more anhydride reagents, the one or more amine reagents, or the polyetherimide prepolymer, or combinations thereof. In some examples, the solvent includes a protic organic solvent. Examples of protic organic solvents include, but are not limited to, a C₁₋₆ alcohol, wherein the C₁₋₆ alkyl group can be linear or branched. The C₁₋₆ alcohol can include methanol, ethanol, n-propanol, isopropanol, n-butanol, t-butanol, sec-butanol, 1-pentanol, 2-pentanol, 3-pentanol, 1-hexanol, 2-hexanol, 3-hexanol, 2-ethyl-1-butanol, 3-methyl-1-butanol, 3-methyl-2-butanol, 2-methyl-2-butanol, 2,2-dimethyl-1-propanol, ethylene glycol, diethylene glycol, or a combination comprising at least one of the foregoing. In some examples, the C₁₋₆ alcohol is substantially miscible with water. For example the C₁₋₆ alcohol can comprise methanol, ethanol, n-propanol, isopropanol, or a combination comprising at least one of the foregoing. In some examples, the solvent comprises methanol, ethanol, or a combination comprising at least one of the foregoing.

In some examples, the solvent comprises water, for example deionized water. The solvent can include water in a weight ratio of C₁₋₆ alcohol:water of about 1:100 to about 100:1, such as about 1:10 to about 10:1, for example about 1:2 to about 2:1, such as 1:1.3 to about 1.3:1, for example about 1:1.1 to about 1.1:1. In other embodiments, however, no water is present. For example, the solvent can comprise less than 1 wt %, or is devoid of water.

In some examples, the solvent comprises no more than a small percentage of harsher organic solvents, such as a chlorobenzene, a dichlorobenzene, cresol, dimethyl acetamide, veratrole, pyridine, nitrobenzene, methyl benzoate, benzonitrile, acetophenone, n-butyl acetate, 2-ethoxyethanol, 2-n-butoxyethanol, dimethyl sulfoxide, anisole, sulfolane, cyclopentanone, cyclohexanone, gamma-butyrolactone, N,N-dimethyl formamide, N-methyl pyrrolidone, tetrahydrofuran, a solvent with a boiling point above 150° C., or a combination comprising at least one of the foregoing. In an example, the solvent comprises 15 wt % or less, in total, of any combination of one or more of these solvents. In an example, the solvent comprises 10 wt % or less, in total, of any combination of one or more of these solvents. In an example, the solvent comprises 5 wt % or less, in total, of any combination of one or more of these solvents. In an example, the solvent comprises 1 wt % or less, in total, of any combination of one or more of these solvents. In an example, the solvent comprises 0.5 wt % or less, in total, of any combination of one or more of these solvents. In an example, the solvent comprises 0.1 wt % or less, in total, of any combination of one or more of these solvents. In an example, the solvent is devoid or substantially devoid of each of these solvents. In another embodiment, the solvent comprises less than 1 wt %, or less than 0.1 wt % of an aprotic organic solvent, and in some examples the solvent is devoid of an aprotic organic solvent. In another embodiment, the solvent comprises less than 1 wt %, or less than 0.1 wt %, of a halogenated solvent, and preferably the solvent is devoid of a halogenated solvent.

The precursor solution can comprise, based on the total weight of the compositions: from about 1 to about 60 wt % of the polyetherimide prepolymer, such as from about 5 to about 50 wt %, for example from about 10 to about 40 wt %, such as from about 10 to about 30 wt % of the polyetherimide prepolymer; and from about 10 to 99 wt % of the solvent, such as from about 20 to about 95 wt %, for example from about 30 to about 90 wt % of the solvent.

Amine Additive

The precursor solution can further include an amine additive. The amine additive can comprise a secondary amine, a tertiary amine, or a combination comprising at least one of the foregoing. In some examples, the amine additive preferably comprises a tertiary amine.

In an example, the amount of amine additive included in the solution can depend on the amount of the precursor reagent (i.e., one or more anhydride reagents, one or more amine reagents, or a reaction product thereof) dissolved in the solution. In an example, the amount of amine additive is at least (i.e., more than or equal to) 1.5 moles of the amine additive per mole of the one or more anhydride monomer reagents that are added to the solution (i.e., per mole of the one or more anhydride monomers that react to form the polyetherimide prepolymer in the solution) or 1.5 moles of the amine additive per mole of the one or more amine monomer reagents (i.e., per mole of the one or more amine monomers that react to form the polyetherimide prepolymer in the solution) to fully solubilize and dissociate the resulting polyetherimide prepolymer in the solution.

In some examples, the amine is a secondary or a tertiary amine of the formula (12):

R^{A}R^{B}R^{C}N (12)

wherein each R^{A}, R^{B}, and R^{C} can be the same or different and are a substituted or unsubstituted C₁₋₁₈ hydrocarbyl or hydrogen, provided that no more than one of R^{A}, R^{B}, and R^{C} are hydrogen. In some examples, each R^{A}, R^{B}, and R^{C} are the same or different and are a substituted or unsubstituted C₁₋₁₂ alkyl, a substituted or unsubstituted C₁₋₁₂ aryl, or hydrogen, provided that no more than one of R^{A}, R^{B}, and R^{C} are hydrogen. In some examples, each R^{A}, R^{B}, and R^{C} are the same or different and are an unsubstituted C₁₋₆ alkyl or a C₁₋₆ alkyl substituted with 1, 2, or 3 hydroxyl, halogen, nitrile, nitro, cyano, C₁₋₆ alkoxy, or amino groups of the formula —NR^{D}R^{E} wherein each R^{D} and R^{E} are the same or different and are a C₁₋₆ alkyl or C₁₋₆ alkoxy. In some examples, each R^{A}, R^{B}, and R^{C} are the same or different and are an unsubstituted C₁₋₄ alkyl or a C₁₋₄ alkyl substituted with one hydroxyl, halogen, nitrile, nitro, cyano, or C₁₋₃ alkoxy.

In some examples, the amine additive comprises triethylamine, trimethylamine, dimethylethanolamine, diethanolamine, triethanolamine, tetrabutylammonium hydroxide, tetramethylammonium hydroxide, teraethylammonium hydroxide, tetrapropylammonium hydroxide, 1,8-Diazabicyclo(5.4.0)undec-7-ene, 1,4-Diazabicyclo[2.2.2]octane, or a combination comprising at least one of the foregoing. In an example, the amine additive comprise triethylamine. In an example, the amine additive comprises dimethylethanolamine. In an example, the amine additive comprises diethanolamine.

The amine additive can be added to the precursor solution in an amount effective to solubilize the polyetherimide prepolymer in a C₁₋₆ alcohol, in a solution of the C₁₋₆ alcohol and deionized water, or in deionized water. For example, the amine additive can be present in the precursor solution in an amount of 5 to 50 wt %, or 8 to 40 wt %, or 9 to 35 wt %, based on the combined weight of the amine additive and the dry weight of the polyetherimide prepolymer.

The amine additive can be added in an amount effective to solubilize the polyetherimide prepolymer in an alcohol, a mixture of an alcohol and water, or in water. In some examples, the solution can be heated at a temperature equal to the boiling point of the C₁₋₆ alcohol at atmospheric pressure, or at a temperature greater than 100° C. at a pressure greater than atmospheric pressure.

Other Additives

The precursor solution can further comprise additional components to modify the solution, for example to modify the reactivity or processability of the compositions, or properties of the polyetherimides and articles formed from the polyetherimides. Examples of other additives that can optionally be included in the precursor solution include, but are not limited to, one or more of: an aqueous carrier for a particulate precursor composition; one or more surfactants to promote dissolution of precursor reagents or prepolymers or to maintain a particulate precursor composition as a suspension in the aqueous carrier; one or more chain-stopping agents to adjust the molecular weight of the polyetherimide; one or more cross-linking agents; one or more branching agents; one or more particulates dispersed in the solution, such as a particulate polymer, which can result in a polyetherimide with an intimate blend of the polyetherimide and the particulate material; or other additives for polyetherimide compositions known in the art (such as particulate filler, antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, flame retardant, anti-drip agent, or a combination comprising one or more of the foregoing) with the proviso that the other additive(s) are selected so as to not significantly adversely affect specified properties of the compositions, in particular formation of the polyetherimide. Further details of each of these additives can be found in U.S. Provisional Patent Application No. 62/170,413, filed on Jun. 3, 2015, entitled “3D INK-JET PRINTING OF POLYIMIDE PRECURSOR,” U.S. Provisional Patent Application No. 62/170,418, filed on Jun. 3, 2015, entitled “LASER-INITIATED ADDITIVE MANUFACTURING OF POLYMER PRECURSOR,” and U.S. Provisional Patent Application No. 62/170,423, filed on Jun. 3, 2015, entitled “MATERIAL EXTRUSION ADDITIVE MANUFACTURING OF POLYIMIDE PRECURSOR,” the disclosures of each of which are incorporated by references as if reproduced herein in their entireties. Further details and subject matter described in those patent applications may also be relevant to other aspects of the present disclosure, and are incorporated herein by reference for these details and subject matter as well.

Conversion to Polyetherimide

The precursor can be converted to a polyetherimide, for example by heating the precursor to a reaction temperature and for a period of time that is effective to imidize and polymerize the prepolymer and form the polyetherimide. Suitable reaction temperatures include, but are not necessarily limited to, a temperature of at least about 110° C., such as at least about 150° C., such as from about 200 to about 380° C., for example from about 250 to about 350° C. Suitable periods of time for heating the precursor solution at the reaction temperature can depend on the particular reaction temperature that is used. In some examples, this period of time can include, but is not necessarily limited to, from about 1 minutes to about 3 hours, such as from about 10 minutes to about 1 hour.

The imidization and polymerization can be conducted under an inert gas during the heating. Examples of inert gasses that can be used include, but are not limited to, dry nitrogen, helium, argon, and the like. Dry nitrogen is generally preferred. In an advantageous feature, such blanketing is not required. The imidization and polymerization can be conducted at atmospheric pressure, or in a vacuum.

If present, the solvent can, in some examples, be removed from the precursor solution during the imidization, e.g., such that the heating of the precursor acts to drive off the solution and to imidize the precursor or precursor reagents. In some examples, the solvent can be removed from the precursor solution before the imidization, for example by heating the precursor solution to a temperature that is below the imidization temperature in order to at least partially, or fully, remove the solvent from the precursor, followed by further heating of the now solvent-removed or solvent-reduced precursor to the imidization temperature. The solvent can be partially removed, or can be fully removed.

If a crosslinker is present in the precursor solution, crosslinking can occur before the imidization, during the imidization, or after the imidization. In an example, a crosslinker comprises multifunctional (more than two) groups, such as amino, anhydride, epoxy, carbodiimide, aziridine, isocyanate, carboxylic acid or benzoic acid, alcohol, thiol, ethylenically unsaturated and other crosslinkable functional groups. In an example, the precursor is crosslinked by exposure to heat, ultraviolet (UV) light, electron beam radiation, ultrasonication or the like, to stabilize the precursor. Alternatively, the polyetherimide can be post-crosslinked to provide for one or more of additional strength, thermal stability, creep resistance, heat and chemical resistance, or other properties to the polyetherimide, or for greater process flexibility.

Depending on the precursor reagents and other materials used, the resulting final polyetherimide can have a melt index of 0.1 to 100 grams per minute (g/min), as measured by American Society for Testing Materials (ASTM) D1238 at 340 to 370° C., using a 6.7 kilogram (kg) weight. In some examples, the final polyetherimide has a weight average molecular weight (M_{w}) of greater than 1,000 g/mol, or greater than 5,000 g/mol, or greater than 10,000 g/mol, or greater than 50,000 g/mol, or greater than 100,000 g/mol as measured by gel permeation chromatography, using polystyrene standards. For example, the final polyetherimide can have a M_{w} of from about 1,000 to about 150,000 g/mol, or more. In some examples, the final polyetherimide has a M_{w} of greater than about 10,000 g/mol, such as from about 10,000 to about 80,000 g/mol In an example, the final polyetherimide has a M_{w} of greater than about 60,000 g/mol. In some examples, the final polyetherimide has a M_{w} of up to about 100,000, or up to about 150,000 g/mol. In some examples, the final polyetherimide has a polydispersity index from about 2.0 to about 4.0, such as from about 2.3 to about 3.0.

The final polyetherimide can further be characterized by the presence of less than 1 wt %, or less than 0.1 wt % of an aprotic organic solvent. In some examples, it is preferred that the final polyetherimide is devoid or substantially devoid of an aprotic organic solvent. Similarly, the final polyetherimide can, in some examples, have less than about 1 wt %, or less than about 0.1 wt % of a halogenated solvent, and preferably the final polyetherimide is devoid or substantially devoid of a halogenated solvent. Such properties are particularly useful in layers or conformal coatings having a thickness from about 0.1 to about 1500 μm, such as from about 1 to about 500 μm, for example from about 5 to about 100 μm, such as from about 10 to about 50 μm.

The final polyetherimide and composite articles comprising the final polyetherimide described herein do not rely on organic solvents. The precursors described herein allow for thin layers of the polyetherimide to be formed. The precursors and polyetherimides are useful not only for layers and coatings, but also for forming composites. Therefore, a substantial improvement in methods of manufacturing polyetherimides and articles prepared therefrom is provided.

### EXAMPLES

Various embodiments of the present invention can be better understood by reference to the following Examples which are offered by way of illustration. The present invention is not limited to the Examples given herein.

### Example 1

A ground powder of bisphenol A dianhydride of the formula (13) (“BPA-DA”) and para-phenylene diamine of the formula (14) (“PPD”) were reacted in an equimolar ratio in a methanol solvent (CH₃OH) at a temperature of 23° C. to form a precursor suspension.

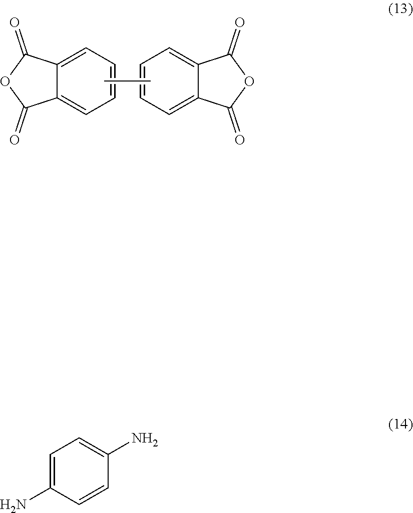

While in suspension, at least a portion of the BPA-DA was found to react with at least a portion of the PPD to form a reaction product comprising a polyamic acid with reactive end groups, as in formula (15), which remained in suspension with the methanol solvent.

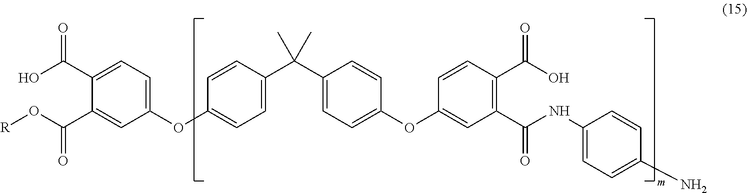

An amine additive comprising a secondary or tertiary amine, such as triethylamine (“TEA”) was also added to the suspension. The amine additive provided for neutralization of at least a portion of the carboxylic groups within the polyamic acid reaction product of formula (15), which resulted in the formation of a reactive polyetherimide prepolymer of the formula (16):

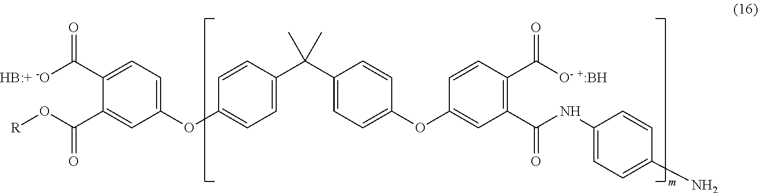

where m is a non-zero integer, and “HB⁺” or “⁺BH” refers to a conjugate base of the amine additive in the solvent in the complex of the homogenous reactive polyetherimide prepolymer. For example, when TEA was used as the amine additive. BH⁺ was NH(CH₂CH₃)₃⁺. The amine additive (i.e., TEA) allowed the reactive polyetherimide precursor of formula (16) to fully or substantially fully dissociate in the solvent and form a homogenous or substantially homogenous prepolymer solution in the methanol solvent.

It was estimated m in formula (16) was between about 5 and about 50, such that the resulting reactive polyetherimide prepolymer chains in the solution had a M_{w} of from about 2,000 g/mol to about 20,000 g/mol. The polyetherimide precursor solution was found to have a dissolved solids content of 29 wt % with a viscosity of about 18.5 cP when measured at 23° C. with a Brookfield viscometer model DV-II+ pro, sold by Brookfield Ametek Inc. (formerly Brookfield Engineering Laboratories, Inc.), Middleboro, Mass., USA. A spindle number SC5-21 was used at 100 rpm during the viscosity measurements (which was also used for viscosity measurements indicated in any other EXAMPLE).

### Example 2

An equimolar ratio of the BPA-DA of formula (13) and the PPD of formula (14), as in EXAMPLE 1, was reacted in deionized water in the presence of an amine additive comprising a secondary or tertiary amine (such as triethylamine (“TEA”)) at a temperature of 60° C. or less. This resulted in the formation of a reactive polyetherimide prepolymer of the formula (16) dissolved in the water-based solvent, forming a reactive prepolymer solution that was homogenous or substantially homogenous.

The reactive prepolymer solution of EXAMPLE 2 is similar to the reactive prepolymer solution of EXAMPLE 1, except that the prepolymer solution was formed with a water-based solvent rather than a methanol-based solvent.

### Example 3

BPA-DA having the same formula (13) as in EXAMPLE 1 and meta-phenylene diamine of the formula (17) (“MPD”), both in powder form, were reacted in an equimolar ratio in deionized water as a solvent in the presence of an amine additive comprising a secondary or tertiary amine (i.e., TEA) at a temperature 60° C. or less to form a precursor solution.

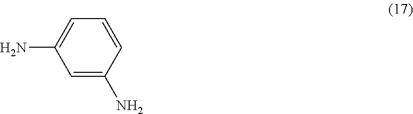

The amine additive (i.e., TEA) neutralized the polyamic acid reaction product, resulting in the formation of a reactive polyetherimide precursor comprising a polyamic acid salt of formula (18).

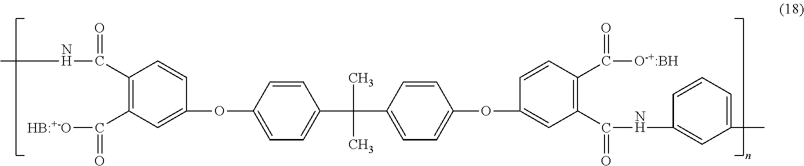

wherein n is a non-zero integer, and “HB⁺” or “BH⁺” refers to a conjugate base of the amine additive in the solvent. As described above, when TEA was used as the amine additive, BH⁺ was NH(CH₂CH₃)₃⁺.

The polyamic acid salt of formula (18) was at least partially dissolved in the deionized water-based solvent, which formed a homogenous or substantially homogenous polyetherimide prepolymer solution. The polyetherimide prepolymer solution comprising the polyetherimide precursor of formula (18) is similar to the prepolymer solution comprising the polyetherime precursor of formula (16) prepared in EXAMPLE 2, except that the reactive preopolymer compound (i.e., the polyamic acid salt of formula (18)) was formed using the meta form of the diamine (i.e., MPD of formula (17)) rather than the para form (i.e., PPD of formula (14) that was used in EXAMPLES 1 and 2).

The polyetherimide prepolymer solution comprising the polyamic acid salt of formula (18) had a solids concentration of about 28 wt % solids and a viscosity of about 510 cP when measured at 23° C.

### Example 4

A sample was taken from the reactive prepolymer solution produced in EXAMPLE 1 (Sample 4), which comprised the reactive polyetherimide prepolymer of formula (16) formed by dissolving the BPA-DA of formula (13) with the PPD of formula (14) in a methanol-based solvent. Sample 4 was heated at a temperature and for a period of time sufficient so that at least a portion of the solvent evaporated from the prepolymer solution. The solvent can be removed from the solution without heating, such as with forced air at room temperature to evaporate the solvent without heating the solution.

When the heating reached a point that the temperature of the prepolymer was sufficiently high, such as at least about 120° C. or higher, the heating initiated imidization of the reactive prepolymer of formula (16) to provide the final polyetherimide polymer of formula (19)

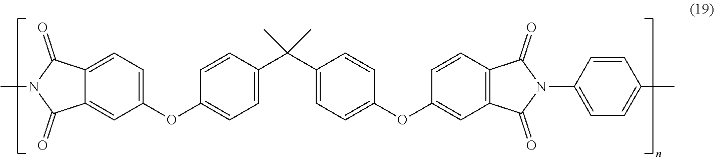

where n is a positive integer that is greater than m in formula (16) and BH⁺ is the same as in formula (16).

Although the prepolymer solution that was used to form the polyetherimide polymer of formula (19) is the prepolymer solution in a methanol based solvent prepared in EXAMPLE 1, the inventors believe that a similar or identical chemical pathway would occur if a prepolymer solution formed in a water-based solution (e.g., as prepared in EXAMPLE 2). Namely, the inventors believe that the reactive prepolymer of formula (16) in the water-based prepolymer solution would polymerize and imidize by a similar pathway to the final polyetherimide polymer of formula (19).

The value of n in formula (19) will depend on the temperature at which the reactive prepolymer solution from EXAMPLE 1 is heated and the period of time that the solution is exposed to that temperature, with higher temperatures resulting in a higher amount of polymerization (higher value for n) for the same exposure time and longer exposure times resulting in a higher amount of polymerization for the same temperature.

The environment in which the heating was performed can also effect the value of n in formula (19). The inventors have found if the reactive prepolymer solution is exposed to an inert environment during heating, such as a nitrogen gas (N₂) environment, the polymerization and imidization will tend to proceed faster than when it is heated in an air environment. Therefore, polyetherimides of formula (19) that are formed by heating in a N₂ environment tend to have a higher M_{w} when compared to a polyetherimide formed by heating the same solution in air, as described below in more detail in EXAMPLES 5, 6, and 7.

### Example 5

Two samples were taken from the reactive prepolymer solution produced in EXAMPLE 1 (Sample 5A and Sample 5B). Each Sample was stored for a different period of time in order to investigate the potential shelf life of a polyetherimide prepolymer solution made according to EXAMPLE 1 for the purposes of producing a polyetherimide polymer.

Sample 5A was stored for one (1) day at room temperature in a vessel that had been blanked with N₂ to minimize oxidation of the compounds in the solution, and then was split into a first portion (“Sample 5A(i)”) and a second portion (“Sample 5A(ii)”). Both Sample 5A(i) and Sample 5A(ii) were heated in an oven to a temperature of 385° C. for fifteen (15) minutes to initiate imidization and polymerization of the reactive prepolymer of formula (16). During this heating step, the same process and reactions as in EXAMPLE 4 were believed to occur, i.e., solvent evaporation, followed by polymerization and imidization to produce the final polyetherimide of formula (19).

Sample 5B of the reactive polyetherimide prepolymer was stored for 116 days at room temperature in the same type of vessel as with Sample 5A that had been blanked with N₂ to minimize oxidation before being polymerized. Sample 5B was also split into a first portion (“Sample 5B(i)”) and a second portion (“Sample 5B(ii)”). Samples 5B(i) and Sample 5B(ii) were then heated in exactly the same manner as for Sample 5A(i) and Sample 5A(ii), respectively. Namely, both were heated to 385° C. for 15 minutes.

The only difference between the heating of the first portions of each sample (i.e., Samples 5A(i) and 5B(i)) and that of the second portions (i.e., Samples 5A(ii) and 5B(ii)) is that when Samples 5A(i) and 5B(i) were heated in a (N₂) environment, while Samples 5A(ii) and 5B(ii) were exposed to air during heating.

Table 1 summarizes properties of the polyetherimide prepolymer solutions of Samples 5A and 5B and the resulting polyetherimide polymers that were formed for each sample portion Sample 5A(i), 5A(ii), 5B(i), and 5B(ii).

TABLE 1
Comparison of Polyetherimide Prepolymer Solution
after Short-Term and Long-Term Storage

| | Storage | | | | | | |
|---|---|---|---|---|---|---|---|
| | Time | Residual | Viscosity | Solids % | PEI M_{w} | PEI Mₙ | PEI |
| Sample # | (Days) | PPD^{a} | (cP)^{b} | (wt %)^{c} | (g/mol) | (g/mol) | PDI |
| 5A(i) (N₂) | 1 | 168 | 18.5 | 29% | 77,975 | 40,058 | 1.95 |
| 5A(ii) (air) | | | | | 74,315 | 29,956 | 2.48 |
| 5B(i) (N₂) | 116 | 173 | 16 | 32% | 73,772 | 30,905 | 2.39 |
| 5B(ii) (air) | | | | | 79,730 | 23,246 | 3.43 |

^{a}Residual para-phenylene diamine present in the sample, as measured by ultra-high pressure liquid chromatography analysis of the prepolymer solution sample
^{b}Measured at 23° C. with a Brookfield viscometer model DV-II+ pro at 100 rpm.
^{c}Solids content of the prepolymer solution sample.

As can be seen in Table 1, there was not an appreciable increase in residual PPD in the prepolymer solution stored for 1 day (Sample 5A) and that which was stored for 116 days (Sample 5B). There also does not appear to have been a significant change in the viscosity or the solids content (wt % solids) that occurs after long-term storage of the polyetherimide prepolymer.

Table 1 also shows that there does not appear to be a significant effect on the weight-average molecular weight (M_{w}), the number-average molecular weight (Mₙ), or the polydispersity index (PDI) for the final polyetherimide polymer due to long-term storage of the polyetherimide prepolymer solution formed in EXAMPLE 1. The prepolymer solutions of both Sample 5A (short-term storage) and Sample 5B (long-term storage) were comparably active in their ability to build high-molecular weight polyetherimides. For example, both Samples were able to produce a polyetherimide with a M_{w} of at least 70,000 g/mol when heated in N₂ or air, both Samples were able to produce a polyetherimide with a Mₙ of at least 20,000 g/mol when heated in air and at least 30,000 g/mol when heated in N₂, and both prepolymer solution Samples had comparably low residual PPD. Both Samples were also able to have comparably low PDIs indicating that the polyetherimide precursor is able to produce polyetherimide polymer chains of relatively homogeneous size even after relatively long-term storage, although there does appear to have been a slight increase in PDI over time.

### Example 6

Seven samples were taken from the reactive prepolymer solution produced in EXAMPLE 1 (Samples 6A, 6B, 6C, 6D, 6E, 6F, and 6G). Each sample was heated in a nitrogen gas (N₂) environment to initiate imidization and polymerization of the reactive prepolymer of formula (16) present in the prepolymer solution, similar to the heating described in EXAMPLES 4 and 5. The first six samples (i.e., Samples 6A-6F) were heated at the same temperature of 250° C. and for successively longer periods of time: Sample 6A for 2.5 minutes (“min”), 6B for 15 min, 6C for 30 min, 6D for 45 min, 6E for 60 min, and 6F for 120 min. The final sample (Sample 6G) was a control sample that was heated the same as Sample 5(A)(i) in EXAMPLE 5, i.e., in nitrogen at 385° C. for 15 minutes.

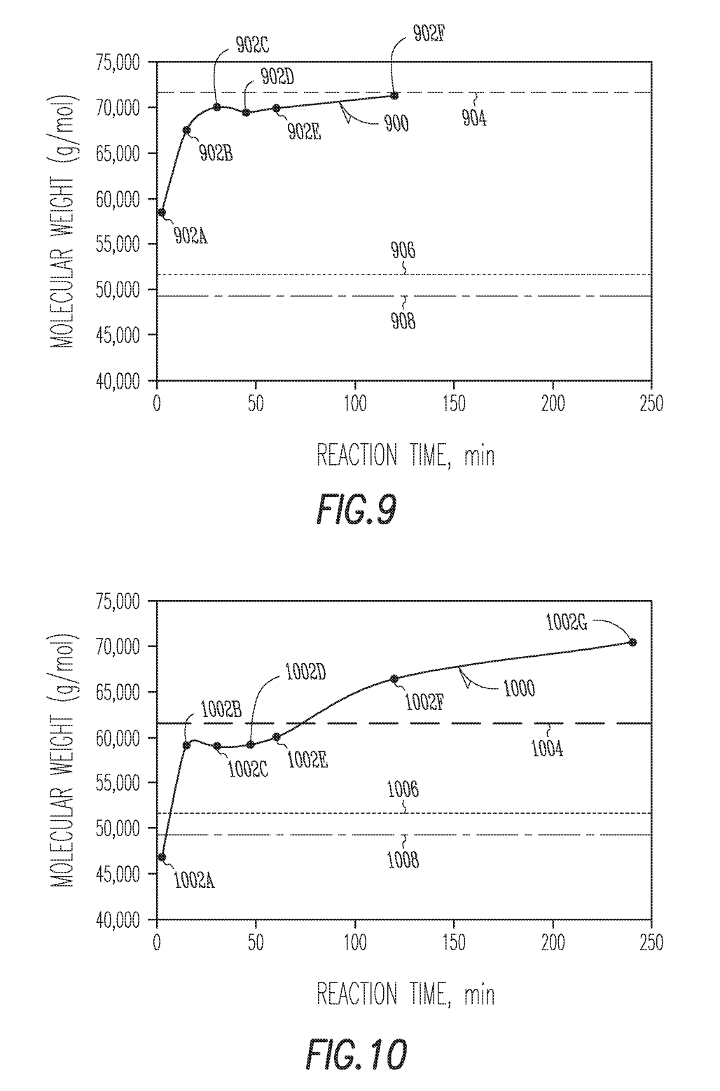

FIG. 9 is a graph showing the progress of weight-average molecular weight (M_{w}) of the polyetherimide polymer that resulted from the heating described above for Samples 6A, 6B, 6C, 6D, 6E, 6F, and 6G. Data series 900 includes data points for the samples heated at 250° C., with data point 902A corresponding to Sample 6A, data point 902B to Sample 6B, and so on until data point 902F for Sample 6F. The horizontal axis in FIG. 9 represents the amount of time that a sample was heated at 250° C., and the vertical axis represents the M_{w} reached for a sample. Sample 6G is represented by the horizontal line 904 at the M_{w} that was reached by Sample 6G after being heated for 15 minutes at 385° C. The data series 900 represents the evolution of a polyetherimide polymer over time as the polymer chains grow in a nitrogen environment during polymerization of imidization of the reactive polyetherimide prepolymer of formula (16).

For comparison, FIG. 9 also includes lines 906 and 908, which show the M_{w} of two widely-available commercial polyetherimide polymers. The commercial polymer that corresponds to line 906 is the polyetherimide product sold under the trade name ULTEM 1000 by Saudi Basic Industries Corp. (SABIC), Pittsfield, Mass., USA, which as can be seen by line 906 has a M_{w} of about 52,000 g/mol. The commercial polymer that corresponds to line 908 is the polyetherimide product sold under the trade name ULTEM CRS5001K by SABIC, which has a M_{w} of about 49,000 g/mol. Also, the ULTEM CRS5001K product of line 908 is chemically identical or nearly chemically identical to the polyetherimides that resulted from the polymerization of Samples 6A-6G in that they have a chemical structure that is identical or nearly identical to that of the final polyetherimide of formula (19). The ULTEM 1000 product of line 906 is chemically very similar to the polyetherimides that resulted from the polymerization of Samples 6A-6G with a chemical structure that is very similar to formula (19), except that the ULTEM product 1000 is formed with a different amine reagent monomer (meta-phenylene diamine rather that the para-phenylene diamine that formed the polyetherimide of formula (19).

### Example 7

Eight samples were taken from the reactive prepolymer solution produced in EXAMPLE 1 (Samples 7A, 7B, 7C, 7D, 7E, 7F, 7G, and 7H). Each sample was heated in air to initiate imidization and polymerization of the reactive prepolymer of formula (16) present in the prepolymer solution, similar to the heating described in EXAMPLE 4 and 5. The first seven samples (i.e., Samples 7A-7G) were heated at the same temperature of 250° C. and for successively longer periods of time: Sample 7A for 2.5 min, 7B for 15 min, 7C for 30 min, 7D for 45 min, 7E for 60 min, 7F for 120 min, and 7G for 240 min. The final sample (Sample 7H) was a control sample that was heated the same as Sample 5(A)(li) in EXAMPLE 5, i.e., in air at 385° C. for 15 minutes.

FIG. 10 is a graph showing the progress of weight-average molecular weight (M_{w}) of the polyetherimide polymer that resulted from the heating described above for Samples 7A, 7B, 7C, 7D, 7E, 7F, 7G, and 7H. Data series 1000 includes data points for the samples heated at 250° C., with data point 1002A corresponding to Sample 7A, data point 1002B to Sample 7B, and so on until data point 1002G for Sample 7G. The horizontal axis of FIG. 10 represents the amount of time that a sample was heated at 250° C., and the vertical axis represents the M_{w} reached for a sample. Sample 7H is represented by the horizontal line 1004 at the M_{w} that was reached by Sample 7H after being heated for 15 minutes at 385° C. The data series 1000 represents the evolution of a polyetherimide polymer over time in air as the polymer chains grow during polymerization and imidization of the reactive polyetherimide prepolymer of formula (16). FIG. 10 also includes lines 1006 and 1008, which represent the M_{w} of the same ULTEM 1000 and ULTEM CRS5001K commercial polyetherimides described above with respect to lines 906 and 908, respectively, for FIG. 9.

### Discussion of Examples 6 and 7

As can be seen in FIGS. 9 and 10, when using a prepolymer solution, such as the solution produced in EXAMPLE 1, the resulting polyetherimide polymer was able to reach the M_{w} of the ULTEM 1000 commercial polyetherimide (lines 906 and 1006) and of the ULTEM CRS5001K commercial polyetherimide (lines 908 and 1008) very rapidly. Polymerized in both air and nitrogen at the relatively low temperature of 250° C. achieved the M_{w} of both commercial polyetherimides in 15 minutes or less, with the nitrogen environment achieving this M_{w} in 2.5 minutes or less. Moreover, polymerization of the prepolymer in both the nitrogen environment and the air environment was able to achieve a substantially higher M_{w}. For example, the air environment was able to achieve a measured M_{w} of 60,084 g/mol after 60 minutes (Sample 7E) of reaction time at a reaction temperature as low as 250° C., which is higher than the M_{w} for both commercial polyetherimides. The air environment was able to reach a measured M_{w} of 70,352 g/mol after 240 minutes (Sample 7G) when heated to 250° C. The nitrogen environment was found to be even more rapid, achieving a M_{w} of 58,564 in only 2.5 minutes (Sample 6A) when heated at 250° C., which is higher than the M_{w} of both commercial polyetherimides. The nitrogen environment was also able to achieve a M_{w} greater than 60,000 g/mol in 15 minutes at 250° C. (67,443 g/mol for Sample 6B) and a M_{w} of around 70,000 g/mol in an hour or less at 250° C. For example, Sample 6C reached a measured M_{w} of 70,001 g/mol at 30 minutes, but both Sample 6D at 45 minutes and Sample 6E at 60 minutes were lower than the Sample 6C value (69,521 g/mol for Sample 6D (45 min) and 69,812 g/mol for Sample 6E (60 min)), so it is believed that the measured value for Sample 6C may be the result of some experimental error. Regardless, the nitrogen environment was still able to achieve a M_{w} that was greater than 70,000 g/mol within 120 minutes (two hours) of heating at 250° C. (Sample 6F at 120 minutes was measured at 71,372 g/mol) and the control Sample 6G (heated at 385° C. for 15 minutes) was also able to achieve a M_{w} higher than 70,000 (measured at 71,897 g/mol).

Moreover, because the prepolymer solutions of Samples 6A-6G and 7A-7H are formed from a prepolymer compound (i.e., that of formula (16)) with a much lower M_{w} than the both of the commercial polyetherimides, it is much easier to make composites therefrom. In particular, because the prepolymer solution has a low viscosity (e.g., at or below 200 cP even with a solids concentration as high as 30%, and in some cases much lower than 200 cP) that is much easier to impregnate into a fibrous preform than solutions made from high-M commercial polyetherimides like ULTEM 1000 and ULTEM CRS5001K, which are fully polymerized polyetherimides that are made by industrial processes in an industrial reactor.

### Example 8

A sample was taken from the polyetherimide prepolymer solution produced in EXAMPLE 3 (Sample 8). Sample 8 was heated in an oven to a temperature of 385° C. for fifteen (15) minutes to initiate imidization and polymerization of the reactive prepolymer of formula (18). During this heating step, a similar process and set of reactions as in EXAMPLE 4 were believed to occur, i.e., solvent evaporation, followed by polymerization and imidization, which produced a final polyetherimide of formula (20).

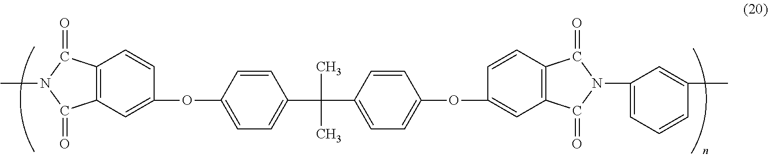

The resulting polyetherimide polymer of formula (20) was found to have a weight average molecular weight (M_{w}) of 81,735 g/mol, a number average molecular weight (Mₙ) of 32,894, a polydispersity index (PDI) of 2.48, and a ratio of the average molar mass (M_{z}) to weight-average molecular weight (M_{w}), or M_{z}/M_{w}, of 1.66.

The polyetherimide polymer formed from the prepolymer solution produced in EXAMPLE 3 is similar to the polyetherimides produced in EXAMPLE 4 from the prepolymer solution produced in EXAMPLE 1, except that the polyetherimide polymer (i.e., the polyetherimide of formula (20)) was formed using the meta form of the diamine (i.e., MPD of formula (17) in EXAMPLE 3) rather than the para form (i.e., PPD of formula (14) that was used in EXAMPLE 1).

### Example 9

Eight samples were taken from the reactive prepolymer solution produced in EXAMPLE 3 (Samples 9A, 9B, 9C, 9D, 9E, 9F, 9G, and 9H). All of the samples were heated to initiate imidization and polymerization of the reactive prepolymer of formula (18) present in the prepolymer solution, similar to the heating described in EXAMPLE 8. The first seven samples (i.e., Samples 9A-9G) were heated in air, and each sample was heated for the same period of time of 60 minutes, but at increasingly higher temperatures: Sample 9A at 137° C., 9B at 150° C., 9C at 180° C. 9D at 200° C., 9E at 220° C., 9F at 250° C., and 9G at 280° C. The final sample (Sample 9H) was a control sample that was heated at 385° C. for 15 minutes in a nitrogen (N₂) environment.

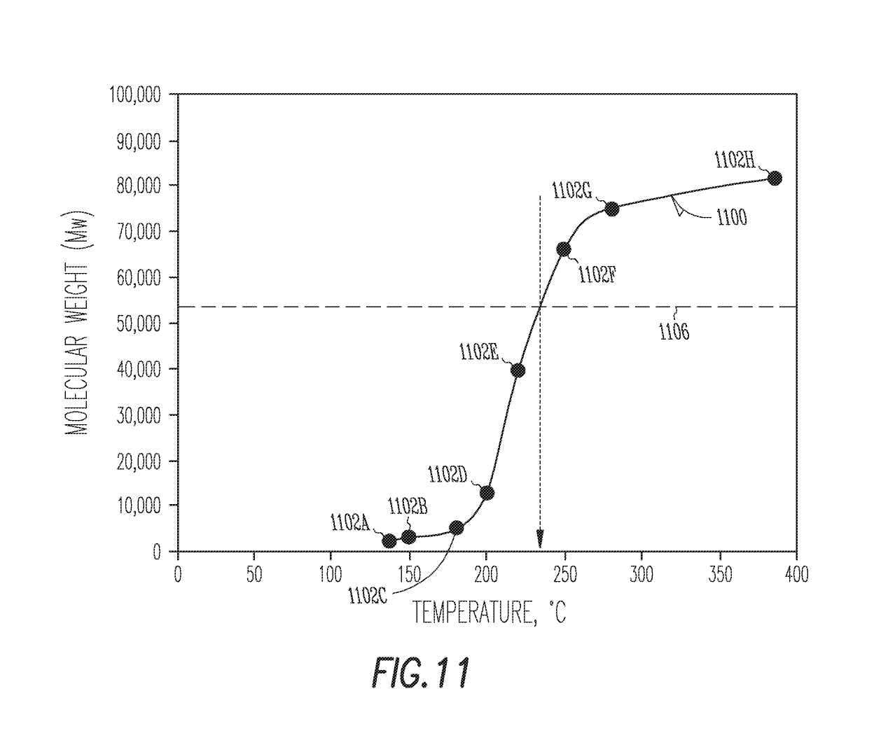

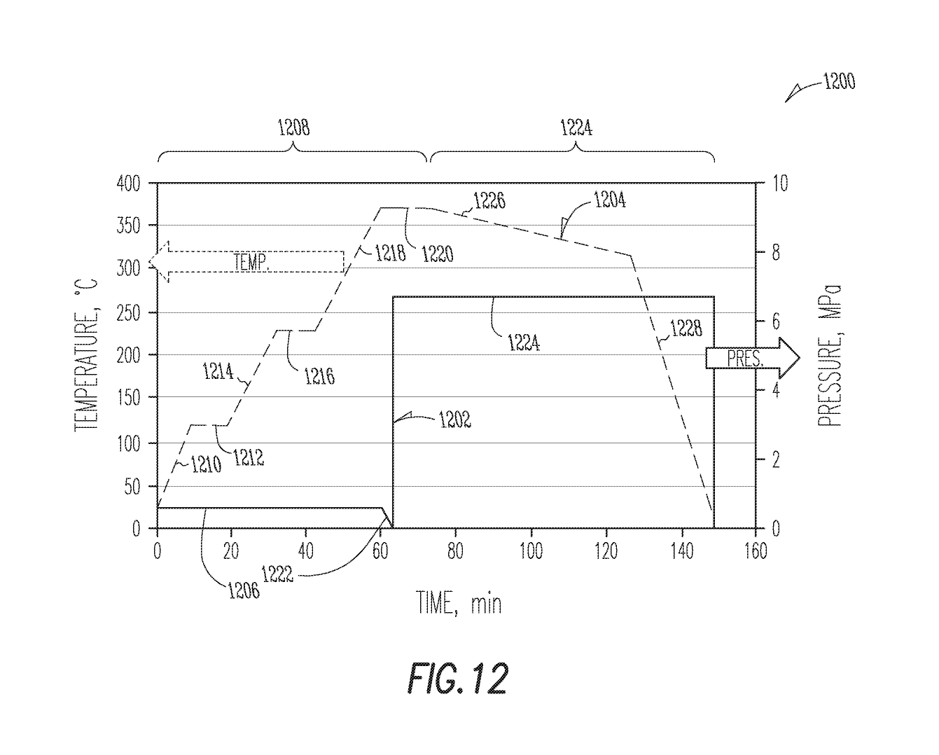

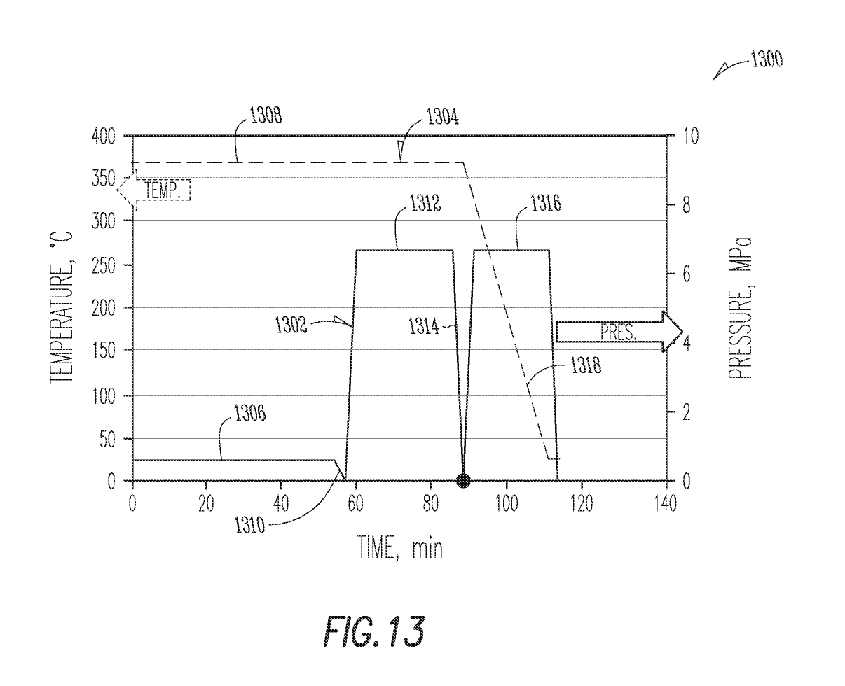

FIG. 11 is a graph showing a comparison of the weight-average molecular weight (M_{w}) of the polyetherimide polymers that resulted from the heating described above for Samples 9A, 9B, 9C, 9D, 9E, 9F, 9G, and 9H. Data series 1100 includes data points for the samples, with data point 1102A corresponding to Sample 9A, data point 1102B to Sample 9B, data point 1102C to Sample 9C, and so on until data point 1102H for Sample 9H. The horizontal axis in FIG. 11 represents the temperature at which the sample was heated in air for 60 minutes (except for data point 1102H for Sample 9H, which is the heating temperature in nitrogen for 15 minutes). The vertical axis represents the M_{w} reached for a sample. The data series 1000 represents the evolution of polyetherimides that are polymerized at successively increasing temperatures in air. FIG. 11 also includes line 1106, which represent the M_{w} of the same ULTEM 1000 commercial polyetherimide described above with respect to lines 906 and 1006 in FIGS. 8 and 10. The ULTEM 1000 polyetherimide product of line 1106 is chemically identical or nearly chemically identical to the polyetherimides formed by the polymerization of Samples 9A-9H in that in has a chemical structure that is identical or nearly identical to formula (20).

FIG. 11 shows that even when polymerizing in air (which, as noted above was found to be slower than when reacting in an inert nitrogen environment), a prepolymer solution formed with a water-based solvent is able to reach the commercially-available M_{w} of line 1106 (about 52,000 g/mol) within an hour at a polymerization reaction temperature as low as about 235° C. (the point on the x axis where a fitted curve of data series 1000 crosses line 1106). FIG. 11 also shows that forming a polyetherimide from the precursor solution formed from a water-based solvent can achieve a much higher M_{w} at higher temperatures. For example, when heated at as low as 250° C. for 60 minutes, a M_{w} of over 60,000 g/mol was achieved (Sample 9F with a measured M_{w} of 66,303 for 250° C.), while a moderately higher heating temperature of 280° C. was able to reach almost 75,000 g/mol (Sample 9G, 74,995 g/mol). The water-based solvent prepolymer solution was even able to achieve a M_{w} that was greater than 80,000 g/mol when heated in a nitrogen environment at 385° C. (Sample 9H, 81,735 g/mol), which is more than 50% higher than the M_{w} of the commercial polyetherimide of line 1106.

### Example 10

In order to investigate the use of prepolymer solutions in the preparation of composite structures, a first composite laminate was prepared. Glass fiber preform sheets were provided for impregnation with a polyetherimide prepolymer solution in order to form a composite comprising preforms at least partially embedded in a polyetherimide formed by polymerizing one or more prepolymer compounds in the solution. Each fiber preform comprised a sheet of woven glass fibers of a GF 7781 style (8-harness satin weave style, areal density of about 299 g/m2, fabric thickness of 0.22 mm, a warp count of about 22.44 warp threads per cm, and a fill count of about 21.25 fill threads per cm) with no sizing or essentially no sizing on the glass fibers. An example of a similar fiber preform are the GF 7781 fabric sheets sold under the trade name HEXFORCE 7781 by Hexcell Corp., Stamford, Conn., USA.

Each fiber preform sheet was soaked in a bath formed from a sample of the prepolymer solution produced in EXAMPLE 1 (Sample 10) to provide a preimpregnated fiber preform sheet, also called a “prepolymer prepreg” or simply “prepreg.” Each fiber preform sheet was soaked in the prepolymer bath to ensure substantially complete of impregnation of the prepolymer solution into the fiber preform sheet.

After soaking the fiber preform sheets to form the prepolymer prepreg sheet, four (4) prepolymer prepreg sheets having identical or substantially identical size (in both the length and width directions) were stacked to form a multi-layered structure that was four sheets thick. Each of the prepreg sheets in the multi-layered structure were oriented in the same direction, i.e., with the warp threads of each of the four fiber preform sheets aligned in substantially the same direction and with the fill threads of each of the four fiber preform sheets aligned in substantially the same direction.

The multiple impregnated plies or sheets or plies of the multi-layered structure were placed in a hydraulic heating press model HVP sold by the TMP Division of French Oil Mill Machinery Co. of Piqua, Ohio, USA (formerly Technical Machine Products Inc. of Cleveland, Ohio, USA) to consolidate the prepreg sheets of the multi-layered structure together into a single composite laminate. The prepreg sheets or plies was heated and compressed in the heating press according to the heating and compression cycle 1200 shown. The heating and compression cycle 1200 comprised a relatively long total cycle time of about 150 minutes, and is therefore referred to hereinafter as the “long cycle 1200.” The long cycle 1200 included a single-cycle pressure profile 1202 that was concurrent with a heating and cooling profile 1204 (also referred to as “temperature profile 1204”).

The pressure profile 1202 included an initial stage 1206 that lasted for 60 minutes where the pressure was only slightly increased to about 0.2 MPa. During the initial stage 1206 of the pressing profile 1202, the temperature profile 1204 included a concurrent step-wise heating stage 1208 that gradually heated the multi-layered structure up to a final temperature of 370° C. As shown, the stepwise heating stage 1208 included a first heating period 1210 lasting 10 minutes (i.e., from Minute 0 until Minute 10 of the cycle 1200) when the temperature was generally linearly increased to 120° C., followed by a first holding period 1212 for 10 minutes (i.e., until Minute 20) when the temperature was kept at 120° C. The 120° C. and the time of the first holding period 1212 were selected to drive off the solvent. After the first holding period 1212, the multi-layered structure was heated for a second heating period 1214 of 15 minutes (i.e., until Minute 35) where the temperature was generally linearly increased to 235° C. followed by a second holding period 1216 lasting 10 minutes (i.e., until Minute 45) when the temperature was kept at 235° C. The 235° C. temperature and the period of time for the second holding period 1216 were selected to polymerize and imidize the prepolymer compounds in the prepolymer solution. After the second holding period 1216, the heating stage 1208 included a third and final heating period 1218 of 15 minutes (i.e., until Minute 60) when the temperature is generally linearly increased to 370° C., followed by a third and final holding phase 1220 that lasts for 15 minutes (i.e., until Minute 75 of the cycle 1200) when the temperature was held at 370° C.

At the end of the initial stage 1206, the pressure profile 1202 included a period 1222 when the heating press was opened for a short period of time of a minute or less to quickly release the pressure within the heating press followed by a compression stage 1224 when the pressure in the heating press was increased up to 7 MPa. The pressure release of the press opening period 1222 allowed a majority of the solvent that had been volatized by the heating stage 1208 to be vented from the heating press so that it would not be driven back into the forming polyetherimide polymer by the increased pressure into a compression stage 1224. The increased pressure of the compression stage 1224 was held for about 90 minutes until the end of the entire cycle 1200 (i.e., until Minute 150 of the cycle 1200).

The final holding phase 1220 of the heating stage 1208 overlapped the compression stage 1224 so that the multi-layered structure was kept at the 370° C. temperature for 15 minutes (i.e., until Minute 75) while also being exposed to the high pressure of the compression stage 1224. By keeping the multi-layered structure at the elevated temperature of 370° C. and the elevated pressure of 7 MPa, polymerization and imidization of the prepolymer compounds to the final polyetherimide was completed at the same time that the four prepreg sheets were being compressed together, providing for a strongly laminated and bonded composite laminate. The polymerization and imidization of the prepolymer compounds to form the bonded composite laminate is believed to follow a process similar to that which is described in EXAMPLE 4, i.e., with the solvent being evaporated from the prepolymer solution, and when the temperature of the prepolymer is sufficiently high, polymerization and imidization to form the polyetherimide polymer of formula (19).

After the final holding phase 1220, the temperature profile 1204 entered a cooling stage 1224 when the temperature of the multi-layered structure was gradually reduced back down to room temperature. As shown, the cooling stage 1224 included a first cooling phase 1226 where the consolidated composite laminate was slowly cooled down to a temperature of about 300° C. The reason for this is because the active mechanism that is used by the hydraulic press used for the cycle 1200, which uses water-cooling in cooling coils, cannot be operated at a temperature above about 315° C. (600° F.). Therefore, the first cooling phase 1226 cooled the composite laminate using air cooling. Air cooling was found to cool at a relatively slow rate, only cooling the composite laminate down about 70° C., from 370° C. to 300° C., in about 50 minutes (i.e., until Minute 130 of the cycle 1200), or at an average cooling rate of about 1.4° C./minute.

After the first cooling phase 1226, the composite laminate was cooled during a second cooling phase 1228. Because the composite laminate was at or below 300° C., the second cooling phase 1228 could be more rapid than the first cooling phase 1226. During the second cooling phase 1228, the temperature of the composite laminate was cooled from 300° C. down to room temperature (i.e., about 25° C.) during a period of about 20 minutes (i.e., from Minute 130 to Minute 150), or at a cooling rate of about 13.75° C./minute. At the end of the long cycle 1200, the heating press was opened and the first composite laminate was removed from the cooled heating press. The first composite laminate comprised sheets of fiber preforms embedded in and laminated by a matrix of a polyetherimide of formula (19) formed by polymerizing the methanol-based prepolymer solution of Sample 10.

### Example 11

A second prepreg multi-layered structure was prepared by the same procedure or substantially the same procedure as in EXAMPLE 10. i.e., by soaking a second set of four of the same fiber preforms described in EXAMPLE 10 in a sample of the prepolymer solution prepared in EXAMPLE 1 (Sample 11) to form prepolymer prepregs and stacking the second set prepregs to form the second prepreg multi-layered structure. Like the prepreg multi-layered structure of EXAMPLE 10, the second multi-layered structure was consolidated to form a second composite laminate. However, the second multi-layered structure was consolidated by the heating and compression cycle 1300 rather than the long cycle 1200 that was used in EXAMPLE 10.

The heating and compression cycle 1300 had a total cycle time that was substantially shorter than that of the long cycle 1200. i.e., only 40 minutes compared to the 150 minutes of the long cycle 1200, and is therefore referred to hereinafter as the “short cycle 1300.” Similar to the long cycle 1200 of EXAMPLE 10, the short cycle 1300 includes a pressure profile 1302 and a concurrent temperature profile 1304. The pressure profile 1302 includes an initial phase 1306 when the pressure in the heating press is increased slightly to about 0.2 MPa. However, before the short cycle 1300 even began, the heating press was preheated to the final heating temperature of 370° C. before the second prepreg multi-layered structure was placed in the heating press in order to shorten the time needed to drive the solvent from the second multi-layered structure and polymerize and imidize the prepolymer compound. As such, during the initial phase 1306 of the pressure profile 1302, the temperature profile 1304 included a heating stage 1308 with only a single phase during which the heating press was kept at a constant temperature of 370° C.

The initial phase 1306 of the pressure profile 1302 was maintained for only 20 minutes (i.e., from Minute 0 to Minute 20 of the cycle 1300), at which point the heating press was opened for a short period 1310 of a minute or less to quickly release the pressure within the heating press and vent solvent that had been driven off during the initial phase 1306 of the pressure profile 1302. After the venting period 1310, the pressure profile 1302 included a compression stage 1312 wherein the pressure in the heating press was increased to 7 MPa. The increased pressure of the compression stage 1312 was held for about 10 minutes (i.e., until Minute 30 of the cycle 1300), which coincided with the end of the heating stage 1308. Therefore, the final portion of the heating stage 1308 overlapped the initial portion of the compression stage 1312, which provided for polymerization and imidization of the prepolymer compounds to the final polyetherimide. The second composite laminate formed during this overlapping period is a strongly laminated and bonded composite laminate. The polymerization and imidization of the prepolymer compounds to form the bonded composite laminate is believed to follow a process similar to that which is described in EXAMPLE 4, i.e., with the solvent being evaporated from the prepolymer solution and, if the temperature of the prepolymer is sufficiently high, polymerization and imidization to form the polyetherimide polymer of formula (19).

After the heating stage 1308 (i.e., at Minute 30 of the cycle 1300), the heating press was opened (resulting in the abrupt dip 1314 in the pressure profile 1302) and the hot composite laminate, which was at about 370° C., was removed from the heating press and placed in a cold press. The cold press was then pressurized to the same high pressure of 7 MPa (resulting in the repressurization 1316 in the pressure profile 1302) to continue consolidation of the separate sheets in the composite laminate during a cooling stage 1318. During the cooling stage 1318, the temperature is rapidly reduced from 370° C. to room temperature (e.g., about 25° C.) in 10 minutes (i.e., from Minute 30 to Minute 40, which is the end of the entire cycle 1300), or at a cooling rate of about 34.5° C./minute. At the end of the cooling stage 1318, the cold press was opened and the cooled second composite laminate was removed from the cold press. The second composite laminate comprised sheets of fiber preforms embedded in and laminated by a matrix of a polyetherimide of formula (19) formed by polymerizing the methanol-based prepolymer solution of Sample 11.

### Example 12

A third prepreg multi-layered structure was prepared by a procedure that was similar to the procedure of EXAMPLE 11, i.e., by soaking a third set of four of the same fiber preforms described in EXAMPLE 10 in a sample of the prepolymer solution prepared in EXAMPLE 1 (Sample 12) to form prepolymer prepregs and stacking the third set of prepregs into a multi-layered structure. However, before this multi-layered structure was consolidated to form a third composite laminate, the prepolymer solution in the third set of prepregs was subjected to a “pre-imidization” procedure that included heating the third set of prepregs to a pre-imidization temperature of 100° C. for 60 minutes, resulting in a pre-imidized prepreg multi-layered structure.

After the pre-imidization procedure, the pre-imidized prepreg multi-layered structure was subjected to a process substantially identical to that of EXAMPLE 11, i.e., consolidating the pre-imidized prepreg multi-layered structure by the same short cycle 1300 shown and described above to form the third composite laminate. After the short cycle 1300 was completed to consolidate the pre-imidized prepreg multi-layered structure, the resulting third composite laminate formed from the pre-imidized Sample 12 was removed from the cold press. The third composite laminate comprised sheets of fiber preforms embedded in and laminated by a matrix of a polyetherimide of formula (19) formed by pre-imidizing and polymerizing the methanol-based prepolymer solution of Sample 12.

### Example 13

A fourth prepreg multi-layered structure was prepared by a procedure that was similar to the procedure of EXAMPLE 12, i.e., by soaking a fourth set of four of the same fiber preforms described in EXAMPLE 10 in a prepolymer solution to form prepolymer prepregs and stacking the fourth set of prepregs into a multi-layered structure, pre-imidizing the multi-layered structure by heating the fourth set of prepregs to a pre-imidizaton temperature of 100° C. for 60 minutes. However, rather than using the methanol-based prepolymer solution prepared in EXAMPLE 1, the fourth set of fiber preforms were soaked in a sample of the prepolymer solution prepared in EXAMPLE 2 that was formed using deionized water and TEA (as an amine additive) as the solvent (Sample 13).

After the pre-imidization process, the pre-imidized prepreg multi-layered structure was subjected to a process substantially identical to the short cycle 1300 as in EXAMPLE 11. After the short cycle 1300 was completed to consolidate the pre-imidized prepreg multi-layered structure, the resulting fourth composite laminate formed from the pre-imidized Sample 13 was removed from the cold press. The fourth composite laminate comprised sheets of fiber preforms embedded in and laminated by a matrix of a polyetherimide of formula (18) formed by pre-imidizing and polymerizing the water-based prepolymer solution of Sample 13.

### Example 14

A fifth prepreg multi-layered structure was prepared by a procedure that was similar to the procedure of EXAMPLE 13, i.e., by soaking a fifth set of four of the same fiber preforms described in EXAMPLE 10 in a prepolymer solution to form prepolymer prepregs and stacking the fifth set of prepregs into a multi-layered structure, pre-imidizing the multi-layered structure by heating the fifth set of prepregs to a pre-imidizaton temperature of 100° C. for 60 minutes. However, rather than using the prepolymer solution prepared in EXAMPLE 2 (which was prepared with the BPA-DA of formula (13) and the PPD of formula (14)), the fifth set of fiber preforms were soaked in a sample of the prepolymer solution prepared in EXAMPLE 3 that was formed from BPA-DA of formula (13) and MPD of formula (17) in a solvent of deionized water and TEA as an amine additive (Sample 14).

After the pre-imidization process, the pre-imidized prepreg multi-layered structure was subjected to a process substantially identical to the short cycle 1300 as in EXAMPLE 11. After the short cycle 1300 was completed to consolidate the pre-imidized prepreg multi-layered structure, the resulting fifth composite laminate formed from the pre-imidized Sample 14 was removed from the cold press. The fifth composite laminate comprised sheets of fiber preforms embedded in and laminated by a matrix of a polyetherimide of formula (20) formed by polymerizing the preimidized water-based prepolymer solution of Sample 14.

### Comparative Example 15

A commercially-available composite laminate was obtained to be tested comparatively to one or more of the composite laminates prepared in EXAMPLES 10-14, referred to as the “first comparative laminate.” The first comparative laminate is formed from two (2) plies of a 7581 style woven glass fiber fabric (8-harness satin weave style, areal density of about 296 g/m2, a fabric thickness of 0.24 mm, a warp count of about 22.44 warp threads per cm, and a fill count of about 21.25 fill threads per cm). Therefore, the fiber support structure of the first comparative laminate is substantially similar to and comparable with the fiber preform sheets used to form the composite laminates of each of EXAMPLES 10-14. As described above, the fiber preform sheets are also a glass fiber fabric of 8-harness satin weave style, with a comparable areal density of about 299 g/m², a comparable fabric thickness of 0.24 mm, and identical warp and fill fiber counts of 22.44 and 21.25 threads per cm, respectively.

The woven fabric support structures of the first comparative laminate were embedded and laminated in a polyetherimide polymer matrix. The polyetherimide polymer matrix comprises a similar chemical structure to the polyetherimide of formula (20), wherein the main monomers used to form the polyetherimide are BPA-DA of formula (13) and MPD of formula (17). The polymer matrix was a fully polymerized polyetherimide polymer having a molecular weight of about 42,000 before the polyetherimide was impregnated into the woven fabric support structures of the comparative laminate. As such, the polyetherimide could not have been impregnated into the woven fabric support to form the first comparative laminate without first dissolving the polyetherimide polymer into a strong solvent, most likely one that includes methylene chloride (CH₂Cl₂) or N-Methyl-2-pyrrolidone (C₅H₉NO, “NMP”).

In short, the first comparative laminate of COMPARATIVE EXAMPLE 15 is comparable to the composite laminate of EXAMPLE 14, in that both are made from very similar fibrous support structures with chemically similar polyetherimide polymers, except that the first comparative laminate of this COMPARATIVE EXAMPLE comprised a total of two plies of the fibrous support structure, while the composite laminate of EXAMPLE 14 was formed from a stack of four of the fiber preforms impregnated with the prepolymer solution prepared in EXAMPLE 3.

### Comparative Example 16

A second commercially-available composite laminate was obtained from the same manufacturer that produced the first comparative laminate of COMPARATIVE EXAMPLE 15. The second commercially-available composite laminate, referred to as the “second comparative laminate,” was similar to the first comparative laminate of COMPARATIVE EXAMPLE 15 in that it was made from the same woven fabric support structure and is laminated with the same polyetherimide polymer matrix used in the first comparative laminate. However, the second comparative laminate was made with eight (8) laminated plies of the woven fabric support structure, rather than with two (2) as in the first comparative laminate.

In short, the second comparative laminate is comparable to the composite laminate of EXAMPLE 14, in that both are made from substantially similar fibrous support structures with chemically substantially similar polyetherimide polymers, except that the second comparative laminate comprised a total of eight plies of the fibrous support structure, while the composite laminate of EXAMPLE 14 was formed from a stack of four (4) fiber preforms impregnated with the prepolymer solution prepared in EXAMPLE 3.

### Comparative Example 17

The first and second comparative laminates of COMPARATIVE EXAMPLES 15 and 16 are very similar with respect to the fibrous support and the material of the polyetherimide matrix, but were formed from different numbers fibrous support structures (e.g., two (2) plies and eight (8) plies, respectively, compared to four (4) in the composite laminate of EXAMPLE 14). Therefore, individual commercial composite plies were obtained from the same manufacturer that produced the first and second comparative laminates. Each individual ply was made from the same woven fabric support structure and the same polyetherimide polymer used in the first and second comparative laminates.

Four (4) of the commercial plies were stacked together and were consolidated into a third comparative laminate made from four (4) commercially-prepared composite sheets in order to provide a more direct comparison to the composite laminate made from four (4) fiber preform sheets as in EXAMPLE 14. The four commercial plies were subjected to a heating and compression process that was substantially identical to the long cycle 1200 shown as in EXAMPLE 10 in order to consolidate the plies. After the long cycle 1200 was completed, the resulting third comparative laminate was removed from the cooled heating press.

### Comparative Example 18

A fourth comparative laminate was made that was similar to the comparative composite laminate of COMPARATIVE EXAMPLE 17, i.e., with four (4) individual commercial composite plies consolidated in a heating press. However, the fourth comparative laminate of this COMPARATIVE EXAMPLE was consolidated by the short heating and compression cycle 1300 and described in EXAMPLE 11 rather than the long heating and compression cycle 1200 that was used in COMPARATIVE EXAMPLE 17. After the short cycle 1300 was completed, the resulting fourth comparative laminate was removed from the cold press.

### Comparative Example 19

In order to compare the composite laminates of EXAMPLES 10-13 with composites made with a chemically similar polyetherimide polymer (i.e., with a polymer that is formed from the BPA-DA monomer of formula (13) and the PPD monomer of formula (14)), a fifth comparative laminate was prepared. A powder of a commercially available polyetherimide polymer resin sold under the trade name ULTEM CRS5001K by SABIC was obtained. The commercial polyetherimide powder comprised particles of a fully-polymerized polyetherimide polymer having a chemical composition that is substantially similar to the polyetherimide of formula (19). The polymer of the powder had a molecular weight of about 49,000 g/mol. The polyetherimide polymer of the powder was the same as the commercial polymer associated with line 908 in FIG. 9 (described in EXAMPLE 6) and line 1008 in FIG. 10 (described in EXAMPLE 7).

Four (4) of the same fiber preform sheets described in EXAMPLE 10 were placed into the heating press along with five (5) layers of the commercial powder. The fiber preforms and powder layers were arranged in an alternating layer arrangement with layers of the commercial powder being arranged as outside layers in the alternating layer arrangement. The alternative layer arrangement was then subjected to a heating and compression process that was substantially identical to the long cycle 1200 as in EXAMPLE 10. After the long cycle 1200 was completed, the resulting fifth comparative laminate was removed from the cooled heating press.

### Comparative Example 20

A sixth comparative laminate was prepared by first preparing a second alternating layer arrangement that is substantially identical to that described in COMPARATIVE EXAMPLE 19, i.e., with four (4) of the same fiber preform sheets described in EXAMPLE 10 and five (5) layers of the commercial powder described in COMPARATIVE EXAMPLE 19 arranged in an alternating fashion with layers of the commercial powder being arranged as outside layers in the second alternating layer arrangement. The second alternating layer arrangement was then subjected to a heating and compression process that was substantially identical to the short cycle 1300 as in EXAMPLE 11. After the short cycle 1300 was completed, the resulting sixth comparative laminate was removed from the cold press.

### Comparative Example 21

A seventh comparative laminate was prepared to further investigate the composite laminate prepared in EXAMPLE 14 (i.e., made from a prepolymer solution formed with the BPD-DA monomer of formula (13) and the MPD monomer of formula (17)). A commercially-available polyetherimide polymer resin sold under the trade name ULTEM 1000 by SABIC was obtained. The polyetherimide polymer of the resin is a fully polymerized polyetherimide that is substantially similar to the polyetherimide of formula (20). The polymer of the resin had a molecular weight of about 52,000 g/mol. The polyetherimide of the resin is the same as the commercial polymer associated with line 906 in FIG. 9 (described in EXAMPLE 6), line 1006 in FIG. 10 (described in EXAMPLE 7), and line 1106 in FIG. 11 (described in EXAMPLE 9).

The resin was dissolved in methylene chloride (CH₂Cl₂) to form a polyetherimide solution. The resulting polyetherimide solution was about 10%, by weight, of the dissolved polyetherimide polymer before the solvent became essentially saturated with the polyetherimide. Four (4) sheets of the same fiber preform described in EXAMPLE 10 were soaked in the polyetherimide solution to provide four (4) polyetherimide pre-impregnated sheets or “polyetherimide prepregs,” which were stacked and consolidated to form the seventh comparative laminate. For the consolidation, the stacked polyetherimide prepregs were subjected to a heating and compression process that was substantially identical to the long cycle 1200 described in EXAMPLE 10. After the long cycle was competed, the resulting seventh comparative laminate was removed from the cooled heating press.

### Mechanical Testing of Examples 10-14 and Comparative Examples 15-21

Multiple samples of each composite laminate of EXAMPLES 10-14 and of each comparative laminate of COMPARATIVES EXAMPLES 15-21 were prepared and subjected to tests for the following properties.

Tensile Strength Test

A tensile strength test was conducted on several samples of each composite laminate and comparative composite laminate. The tensile strength test was conducted according to ASTM D3039 with each sample being tested as a small strip of the composite material with a length of 63.5 mm and a width of 12.7 mm, and a thickness of about 1 mm. Tensile strength was measured in the direction of the warp fibers of the composite's fibrous reinforcing structure. This direction is also referred to as the “zero-degree direction” or “0° direction” because the direction of the warp fibers was used as an arbitrary reference within the plane of the composite such that the warp fibers themselves are defined as being oriented at 0°.

The glass fiber loading (in weight %) was also tested so that it could be analyzed whether differences in tensile strength was based on differences due to the use of the prepolymers described herein versus being due to differences in glass fiber content. The glass fiber weight % was determined either from the specific gravity of the composite sample, or using an ashing test, such as the one specified in ASTM D5630.

Table 2 shows the results of the tensile strength test.

TABLE 2
Tensile Strength of Composite Laminate Samples

| | 0° Tensile | | | |
|---|---|---|---|---|
| Composite | Strength (MPa) | | Glass Fiber wt % | |
| Laminate ID | Average | Std. Dev. | Average | Std. Dev. |
| EXAMPLE 10 | 364 | 6 | 65.97 | 2.32 |
| EXAMPLE 11 | 370 | 4 | 71.20 | 0.98 |
| EXAMPLE 12 | 372 | 5 | 67.83 | 1.69 |
| EXAMPLE 13 | 356 | 20 | 66.33 | 0.90 |
| EXAMPLE 14 | 421 | 19 | 70.10 | 1.73 |
| COMP. EXAMPLE 15 | 399 | 18 | 66.72 | 0.48 |
| COMP. EXAMPLE 16 | 330 | 17 | 68.26 | 0.29 |
| COMP. EXAMPLE 17 | 422 | 36 | 75.08 | 0.77 |
| COMP. EXAMPLE 18 | 340 | 46 | 77.14 | 0.97 |
| COMP. EXAMPLE 19 | 180 | 19 | 50.08 | 0.54 |
| COMP. EXAMPLE 20 | 207 | 22 | 60.13 | 4.84 |
| COMP. EXAMPLE 21 | 334 | 28 | 59.62 | 0.32 |

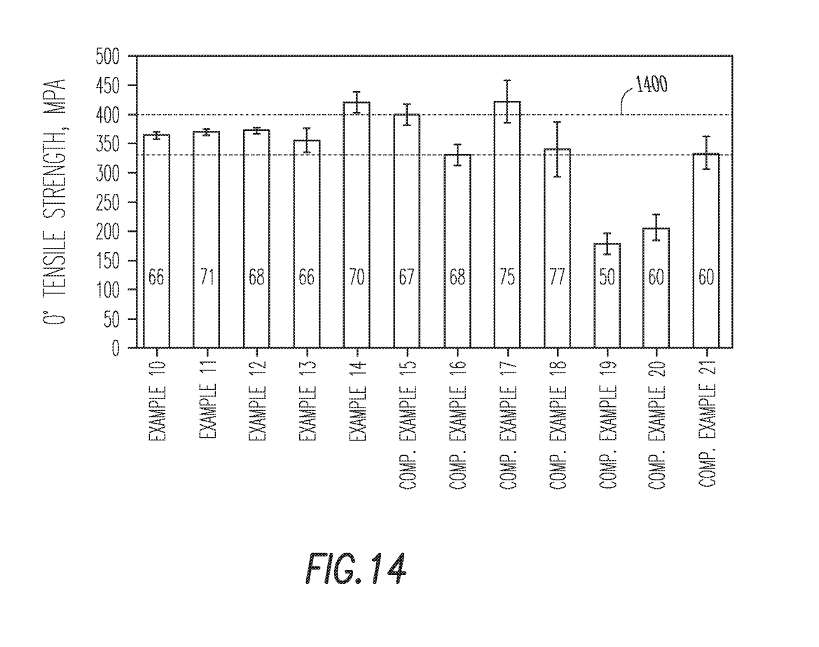

The data in Table 2 is also shown graphically in FIG. 14. FIG. 14 includes a bar for each example composite laminate being tested, with the upper end of the bar representing the average tensile strength in the 0° direction for the composite laminate. The error bars extending from the upper end of each bar represents a range of one standard deviation in either direction from the average, and the number in the interior of each bar corresponds to the weight percentage of glass fiber in that particular example composite laminate.

A range of tensile strengths represented by the band 1400 corresponds to what the inventors believe is the likely range of tensile strengths that can be expected with commercially-available composite laminates available from the manufacturer of the comparative composite laminates and laminate plies in COMPARATIVE EXAMPLES 15-18. In other words, the range represented by the band 1400 corresponds to the values of tensile strength that can reasonably be expected by composite laminates currently on the market that are comparable to the composite laminates prepared from prepolymer solutions in EXAMPLES 10-14.

Flexural Modulus

A four-point bending flexural modulus test was conducted on several samples of each composite laminate or comparative composite laminate. The flexural modulus testing was conducted according to ASTM D6272, Procedure A, with each sample being tested as a strip of composite material with a length of 63.5 mm, a width of 12.7 mm, and a thickness of about 1 mm. Like the tensile strength test, the flexural modulus test was also conducted in the 0° direction (i.e., the direction of the warp threads) of each composite laminate being tested. Table 3 shows the results of the flexural modulus test.

TABLE 3
Flexural Modulus of Composite Laminate Samples

Flexural Modulus
(MPa)

| Sample ID | Average | Std. Dev. |
|---|---|---|
| EXAMPLE 10 | 21,049.7 | 964.6 |
| EXAMPLE 11 | 31,598.7 | 2715.8 |
| EXAMPLE 12 | 29,931.3 | 1846.3 |
| EXAMPLE 13 | 29,413.0 | 1006.9 |
| EXAMPLE 14 | 22,239.3 | 2830.8 |
| COMP. EXAMPLE 15 | 21,145.0 | 1206 |
| COMP. EXAMPLE 16 | 16,272.3 | 124.9 |
| COMP. EXAMPLE 17 | 21,439.3 | 2180 |
| COMP. EXAMPLE 18 | 23,714.0 | 3678.4 |
| COMP. EXAMPLE 19 | 15,594.0 | 1822.9 |
| COMP. EXAMPLE 20 | 16,402.0 | 1558.5 |
| COMP. EXAMPLE 21 | 14,513.7 | 893.5 |

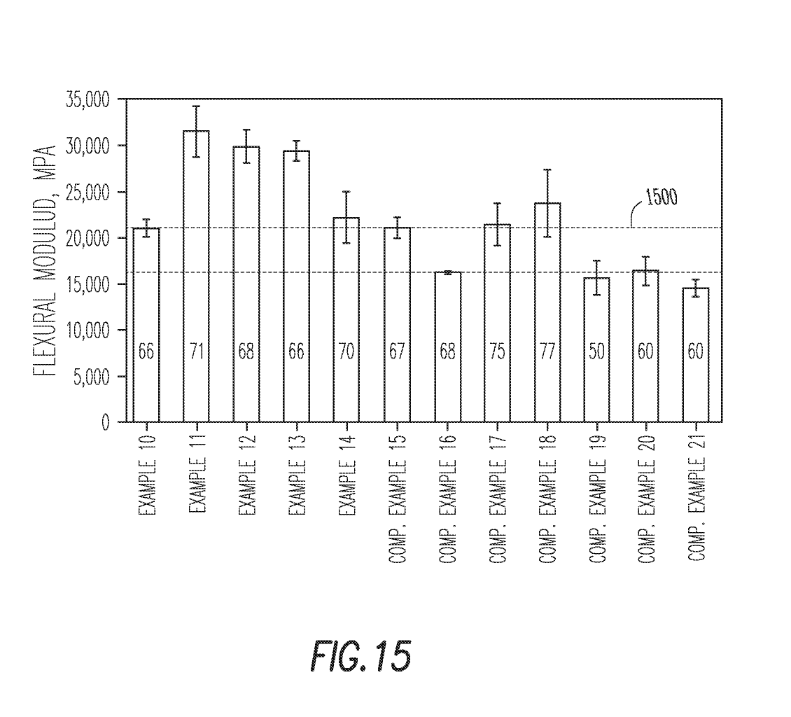

The data in Table 3 is also shown graphically in FIG. 15. FIG. 15 includes a bar for each example composite laminate being tested, with the upper end of the bar representing the average flexural modulus in the 0° direction for the composite laminate. The error bars extending from the upper end of each bar represents a range of one standard deviation in either direction from the average flexural modulus.

A range of tensile strengths represented by the band 1500 corresponds to what the inventors believe is the likely range of flexural moduli that can be expected with commercially-available composite laminates available from the manufacturer of the comparative composite laminates and laminate plies in COMPARATIVE EXAMPLES 15-18, similar to band 1400 for the tensile strengths in FIG. 14. In other words, the range represented by the band 1500 corresponds to the flexural moduli that can reasonably be expected by composite laminates currently on the market that are comparable to the composite laminates prepared from prepolymer solutions in EXAMPLES 10-14.

Dynamic Mechanical Analysis

A dynamic mechanical analysis (“DMA”) test was conducted on several composite laminates as described above. The DMA test was conducted according to ASTM D7078, with each sample being tested as an Izod bar (6.5 mm by 12.7 mm by 1 mm). Like the tensile strength and the flexural modulus tests, the DMA test was conducted in the 0° direction of the composite laminates.

The DMA test was conducted to determine the highest practical usage temperature for each composite laminate being tested. The first two (2) of the samples tested were similar to those prepared in EXAMPLE 10 (with the first being consolidated at a final temperature of 400° C. in a vacuum or nitrogen environment, and the second being consolidated at a final temperature of 370° C. in air). The third sample tested was similar to the composite laminate prepared in EXAMPLE 12 that was consolidated at a final temperature of 400° C. in a vacuum environment. The fourth and final sample was the comparative composite laminate of COMPARATIVE EXAMPLE 17 (consolidated at a final temperature of 370° C. in air).

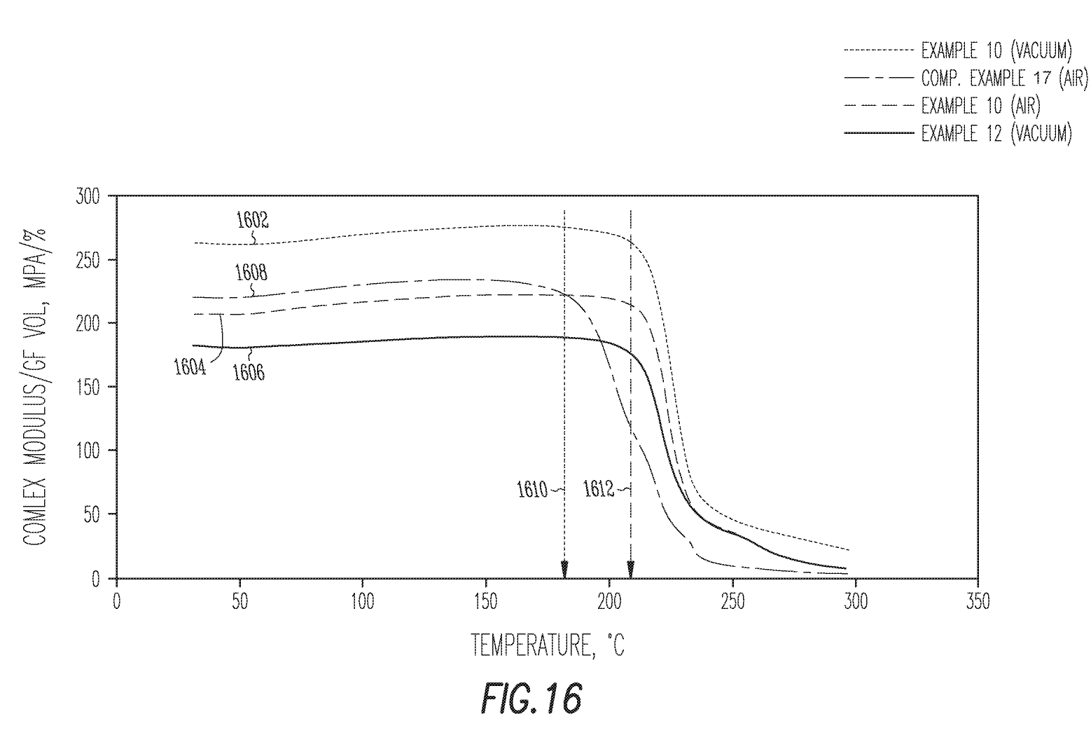

FIG. 16 is a graph showing results of the DMA tests on these samples. FIG. 16 plots the complex modulus of each sample at various temperatures, with the modulus data being normalized per the glass fiber volume in each composite for comparison. Data series 1602 corresponds to the results for the composite laminate of EXAMPLE 10 consolidated in a vacuum environment. Data series 1604 corresponds to the results for the composite laminate of EXAMPLE 10 consolidated in air. Data series 1606 corresponds to the results for the composite laminate of EXAMPLE 12 (consolidated in a vacuum environment). Data series 1608 corresponds to the results for the comparative composite laminate of COMPARATIVE EXAMPLE 17 (consolidated in air). The plot line of each data series was used to determine the temperature at which the complex modulus begins to drop, which is an indication of the highest practical usage temperature for the composite being tested. This highest usage temperature was found to be substantially similar for each composite laminate formed from a prepolymer solution—i.e., the laminates associated with data series 1602 and 1604 (from EXAMPLE 10) and with data series 1606 (from EXAMPLE 12) resulted in highest usage temperature of about 210° C., represented by the line 1610. In contrast, the highest usage temperature that was determined for the comparative composite from COMPARATIVE EXAMPLE 17 was substantially lower, about 180° C., represented by line 1612.

### Discussion of Mechanical Testing Results

The mechanical testing described above shows that composite laminates made from a polyetherimide prepolymer solution that is impregnated into fiber preform support structures which are then consolidated in a laboratory setting have mechanical properties that are either similar to, and in some cases superior to, the corresponding mechanical property in a commercial composite laminate that is made from fully-polymerized polyetherimide that is either melted in order to attempt impregnation of the molten polyetherimide, or is dissolved in strong solvents and impregnated as a polyetherimide solution.

For example, as shown in Table 2 and FIG. 14, the tensile strength of composite laminates formed from a polyetherimide prepolymer solution from each of EXAMPLES 10-14 had a tensile strength that was within the expected range

The T_{g} values determined by the DMA testing indicates that, surprisingly, the composite laminates made from prepolymer solutions (i.e., those in EXAMPLES 10 and 12) can be used in higher temperature applications than those of the comparative composite laminate of COMPARATIVE EXAMPLE 17, including applications that operate at temperatures that are as much as 30° C. higher than what the comparative composite laminate can withstand.

The above Detailed Description is intended to be illustrative, and not restrictive. For example, the above-described examples (or one or more elements thereof) can be used in combination with each other. Other embodiments can be used, such as by one of ordinary skill in the art upon reviewing the above description. Also, various features or elements can be grouped together to streamline the disclosure. This should not be interpreted as intending that an unclaimed disclosed feature is essential to any claim. Inventive subject matter can lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a molding system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects or a requirement of order.

Method examples described herein can be machine or computer-implemented, at least in part, such as with a computer or machine-readable medium encoded with instructions to configure an electronic device to perform method steps as described in the above examples. An implementation of such methods can include code, e.g., microcode, assembly language code, a higher-level language code. Such code can include computer-readable instructions to perform method steps. The code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The Abstract is provided to comply with 37 C.F.R. § 1.72(b), to allow the reader to quickly ascertain the nature of the technical disclosure. It is submitted with the understanding that it will not be used to interpret or limit the scope or meaning of the claims.

Although the invention has been described with reference to exemplary embodiments, workers skilled in the art will recognize that changes may be made in form and detail without departing from the spirit and scope of the invention.

1. A method comprising:
(a) preparing or receiving a polyetherimide precursor solution including;
(i) a solvent comprising water, aliphatic alcohol, or a mixture thereof;
(ii) an amine additive comprising a secondary or tertiary amine; and
(iii) a polyetherimide precursor dissolved and dissociated in the solvent;
(b) at least partially coating or impregnating one or more reinforcement structures with the polyetherimide precursor solution; and
(c) polymerizing the one or more polyetherimide precursor reagents to form a polyetherimide matrix such that the one or more reinforcement structures are at least partially embedded in the polyetherimide matrix to provide a composite article.

2. The method according to claim 1, wherein the solvent of the polyetherimide precursor solution comprises at least 85 wt % water, aliphatic alcohol, or the mixture thereof.

3. The method according to claim 1, wherein the polyetherimide precursor solution comprises less than 15 wt % total of one or any combination of: one or more halogenated solvents, N-methylpyrrolidone, dimethylsulfoxide, dimethylformamide, sulfolane, tetrahydrofuran, anisole, cyclopentanone, cyclohexanone, and a solvent with a boiling point above 150° C.

4. The method according to claim 1, wherein a dissolved concentration of the polyetherimide precursor is from 5 wt % to 80 wt % of the polyetherimide precursor solution and the polyetherimide precursor solution has a viscosity of from about 10 centipoise to about 3000 centipoise when measured at 23° C.

5. The method according to claim 4, wherein the dissolved concentration of the polyetherimide precursor is at least 10 wt % of the polyetherimide precursor solution and the viscosity of the polyetherimide precursor solution is no more than 550 centipoise when measured at 23° C.

6. The method according to claim 1, wherein the polyetherimide precursor is homogenously or substantially homogenously dissolved into the solvent to form the polyetherimide precursor solution.

7. The method according to claim 1, wherein the amine additive comprises at least one of: triethylamine, dimethylethanolamine, or triethanolamine.

8. The method according to claim 1, wherein the polyetherimide precursor comprises a reaction product of one or more anhydride precursor reagents and one or more amine precursor reagents.

9. The method according to claim 8, wherein the polyetherimide precursor solution comprises a residual content of the one or more amine precursor reagents that is below 2500 ppmw, optionally below 1000 ppmw.

10. The method according to claim 9, wherein the polyetherimide precursor solution includes:
at least 1.5 moles of the amine additive for each mole of the one or more anhydride precursor reagents used to form the reaction product; or
at least 1.5 moles of the amine additive for each mole of the one or more amine precursor reagents used to form the reaction product.

11. The method according to claim 8, wherein:
the one or more anhydride precursor reagents comprises at least one of: one or more monofunctional anhydride reagents, one or more difunctional anhydride reagents, or one or more multifunctional anhydride reagents; and
the one or more amine precursor reagents comprises at least one of: one or more monofunctional amine reagents, one or more difunctional amine reagents, or one or more multifunctional amine reagents.

12. The method according to claim 1, wherein the at least partially coating or impregnating the one or more reinforcement structures with the polyetherimide precursor solution comprises wet coating or impregnating the one or more reinforcement structures with the polyetherimide precursor solution.

13. The method according to claim 1, wherein coating the polyetherimide precursor solution onto the one or more reinforcement structures comprises at least one of: dip coating, spray coating, spin coating, film coating, casting, or painting.

14. The method according to claim 1, further comprising shaping the one or more reinforcement structures or the polyetherimide precursor precursor, or both, into a specified shape, wherein the shaping comprises at least one of:
coextruding or pultruding the polyetherimide precursor solution and the one or more reinforcement structures into the specified shape;
laying up the one or more reinforcement structures into a preliminary shape corresponding to the specified shape prior to the at least partially coating or impregnating of the one or more reinforcement structures with the polyetherimide precursor solution, wherein the at least partially coating or impregnating comprises applying the polyetherimide precursor to the preliminary shape of the layed-up one or more reinforcement structures to provide the specified shape;
laying up a pre-impregnated precursor into the specified shape, wherein the pre-impregnated precursor is formed by the at least partially coating or impregnating of the one or more reinforcement structures with the polyetherimide precursor solution;
forming a plurality of layers or sheets each comprising a reinforcement structure sheet or ply that is at least partially coated or impregnated with the polyetherimide precursor solution, followed by consolidating the plurality of layers or sheets to form the specified shape; or
shaping the one or more reinforcement structures into a preshaped support structure concurrent with or followed by coating or impregnating the one or more reinforcement structures with the polyetherimide precursor.

15. The method according to claim 14, wherein the consolidating of the plurality of the layers or sheets to form the specified shape comprises at least one of: static compression molding of the plurality of the layers or sheets, calendaring of the plurality of the layers or sheets, double-belt pressing of the plurality of the layers or sheets; or laminating the plurality of the layers or sheets.

16. The method according to claim 1, wherein the polyetherimide matrix has one or more of:
a mass-average molecular weight of at least 30,000 g/mol, optionally of at least 50,000 g/mol,
an imidization ratio of at least 90%, optionally at least 95%;
residual solvent in the polyetherimide matrix of below 2 wt %, optionally below 1 wt %; and
a residual amount of the amine additive of below 1 wt %, optionally below 0.1 wt %.

17. The method according to claim 16, wherein the polyetherimide precursor comprises a reaction product of one or more anhydride precursor reagents and one or more amine precursor reagents, and wherein the polyetherimide matrix comprises a residual amount of no more than 2500 ppmw, optionally no more than 1000 ppmw, of the one or more amine precursor reagents.

18. The method according to claim 1, wherein a porosity of polyetherimide and an embedded portion of the one or more reinforcement structures is no more than about 5 vol %, optional no more than about 2 vol %, optionally no more than about 1 vol %.

19. The method according to claim 1, wherein the one or more reinforcement structures comprises at least about 10 wt % of the composite article.

20. The method according to claim 1, wherein the one or more reinforcement structures comprises one or more fibrous reinforcement structures.
